(19) United States
(12) Patent Application Publication
(10) Pub. No.: US 2026/0221575 A1
(43) Pub. Date: Jul. 30, 2026

(54) BATTERY PACK

(71) Applicant: BLACK & DECKER INC., New Britain, CT (US)

(72) Inventors: Abhisheka MOTURU, Pikesville, MD (US); Elizabeth WINK, Baltimore, MD (US); Colin Jeffrey BOICE, Lutherville, MD (US); Jesse Ramon ESCOBEDO, Rockville, MD (US); Jason F. BUSSCHAERT, Bel Air, MD (US); Samuel B. ESHELMAN, Fallston, MD (US); Abraham LOZIER, Kingsville, MD (US); Albert WHITE, Phoenix, MD (US); Oliver XIE, Towson, MD (US); Marc W. MCKINLEY, York, PA (US)

(21) Appl. No.: 19/181,048

(22) Filed: Apr. 16, 2025

Related U.S. Application Data
(63) Continuation of application No. PCT/US2023/077026, filed on Oct. 16, 2023.
(60) Provisional application No. 63/379,780, filed on Oct. 17, 2022.

(51) Int. Cl. H01M 50/264; B60L 50/64; H01M 50/213; H01M 50/249; H01M 50/284

(52) U.S. Cl. CPC H01M 50/264; H01M 50/213; H01M 50/249; H01M 50/284; B60L 50/64; B60L 2200/40; H01M 2220/20

(57) ABSTRACT

A battery pack for powering a power tool. The battery pack includes a modular construction to enable improved manufacturability and scalability. The battery pack incorporates a set of modular battery cell holders. The battery pack incorporates a set of battery straps to electrically connect adjacent modular cell holders. The battery pack incorporates a set of connectors and the set of battery straps to electrically and mechanically connect the set of modular battery cell holders to a printed circuit board.

### RELATED APPLICATIONS

This patent application is a continuation of International Application No. PCT/US2023/077026, filed Oct. 16, 2023, entitled “Battery Pack,” which claims priority to Provisional Patent Application No. 63/379,780, filed Oct. 17, 2022, entitled “Electric Riding Lawn Mower and Battery Pack.” The entireties of these applications are incorporated herein by reference.

### TECHNICAL FIELD

This application relates to a battery pack to provide power to a power tool, for example, an electric lawn mower. In one implementation, the riding lawn mower includes at least one battery pack received in a battery pack compartment. The at least one battery pack provides power to a drive system and/or a lawn cutting system.

### SUMMARY

An aspect of the present invention may include a battery pack for powering an electric power tool.

An example embodiment of the aforementioned battery pack may include a housing, a plurality of modular cell holder assemblies, each cell holder assembly comprising (a) at least one cell holder, (b) a plurality of battery cells held physically fixed relative to each other by the cell holder, (c) a plurality of battery straps, each of the plurality of battery straps electrically connecting a subset of the plurality of battery cells, a battery strap extension extending from at least one of the plurality of battery straps; a printed circuit board (PCB) having a width; and a plurality of PCB-cell holder connectors fixedly connected to the PCB; each of the battery strap extensions connected to a corresponding one of the plurality of PCB-cell holder connectors.

The aforementioned example embodiment wherein the battery strap extension is at one end of the battery strap.

The aforementioned example embodiment wherein the battery strap extension comprises a PCB-strap screw hole.

The aforementioned example embodiment wherein the PCB and the cell holder assemblies in a final assembly position, each of the battery strap extensions abut and are aligned with corresponding PCB-cell holder connectors attached to the main PCB.

The aforementioned example embodiment wherein the battery strap extension configured to align with the PCB-cell holder connector, such that the PCB-strap screw hole aligns with a PCB-cell holder connector screw hole, a fastening screw received through both the PCB-strap screw hole and the PCB-cell holder connector screw hole mechanically and electrically coupling the battery strap to the PCB.

The aforementioned example embodiment wherein the PCB and the cell holder assemblies in a final assembly position, each of the battery strap extensions abut and are aligned with corresponding PCB-cell holder connectors attached to the main PCB.

The aforementioned example embodiment wherein the PCB-strap screw holes of the battery strap extensions are aligned with the screw holes of the corresponding PCB-cell holder connectors.

The aforementioned example embodiment wherein, upon alignment of the screw holes of the PCB-cell holder connectors and the screw holes of the battery strap extensions, PCB-cell holder fastening screws inserted into the aligned screw holes mechanically and electrically couple the battery straps to the main PCB.

The aforementioned example embodiment wherein each of the plurality of PCB-cell holder connectors has a screw hole and each battery strap extension has a screw hole and the screw hole of each battery strap extension and the screw hole of the corresponding one of the plurality of PCB-cell holder connectors are aligned and are fastened together by a screw.

The aforementioned example embodiment wherein the at least one cell holder comprises a first type of cell holder and a second type of cell holder, both the first type of cell holder and the second type of cell holder comprising a plurality of battery cell cavities, the plurality of battery cells housed in the plurality of battery cell cavities, a cell holder width, the cell holder width approximately equal to the PCB width.

The aforementioned example embodiment wherein the plurality of battery straps includes a first type of battery strap comprising an overlapping region and a second type of battery strap comprising an overlapped region, the overlapping region overlaps the overlapped region forming an overlap region.

The aforementioned example embodiment wherein the first type of battery strap is electrically connected to the second type of battery strap at the overlap region.

The aforementioned example embodiment wherein the overlapping region includes at least one strap-strap screw hole and the overlapped region includes at least one strap-strap screw hole.

The aforementioned example embodiment wherein the first type of battery strap is connected to the second type of battery strap at the overlap region.

The aforementioned example embodiment wherein the second type of cell holder includes a plurality of screw holes, the plurality of screw holes of the second type of cell holder align with and correspond to the strap-strap screw holes of the first type of battery strap and the strap-strap screw holes of the second type of battery strap.

The aforementioned example embodiment wherein the aligned screw holes of the first type of battery strap, the second type of battery strap and the second type of cell holder receive screws, mechanically fixing the first type of battery strap and the second type of battery strap to the second type of cell holder.

The aforementioned example embodiment wherein the electrically connected first type of battery strap and the second type of battery strap connect battery cells in the first type of cell holder to battery cells in an adjacent, second type of cell holder.

The aforementioned example embodiment wherein a battery strap connects a first set of the plurality of battery cells in the first type of cell holder in series with a second set of the plurality of battery cells in the first type of cell holder.

The aforementioned example embodiment wherein the at least one cell holder comprises a width dimension W3, a length dimension L3 and a height dimension H3.

The aforementioned example embodiment wherein the width dimension W3 is about 8.7 in. to about 9.1 in.

The aforementioned example embodiment wherein the width dimension W3 is approximately 8.9 in.

The aforementioned example embodiment wherein the length dimension L3 is about 2.8 in. to about 3.2 in.

The aforementioned example embodiment wherein the length dimension L3 is approximately 3.0 in.

The aforementioned example embodiment wherein the height dimension H3 of about 3.2 in. to about 3.7 in.

The aforementioned example embodiment wherein the height dimension H3 is approximately 3.5 in.

The aforementioned example embodiment wherein a volume V2 is about 77.95 in3 to about 107.74 in3.

The aforementioned example embodiment wherein the volume V2 is approximately 93.45 in3.

The aforementioned example embodiment wherein the first type of cell holder further comprises a top side defined by a width dimension W3 and a length dimension L3, a bottom side, opposed and generally parallel to the top side, defined by the width dimension W3 and the length dimension L3, a front side defined by the width dimension W3 and a height dimension H3 and a rear side, opposed and generally parallel to the front side, defined by the width dimension W3 and the height dimension H3, a first side defined by the length dimension L3 and the height dimension H3 and a second side, opposed and generally parallel to the first side, defined by length dimension L3 and the height dimension H3.

The aforementioned example embodiment, the at least one cell holder further comprising a plurality of battery cell cavities, each of the plurality of battery cell cavities generally shaped and configured to receive one of the plurality of battery cells in a friction fit manner.

The aforementioned example embodiment wherein the first type of cell holder further comprises a first pair of negative dovetails formed as part of the front side, the first pair of negative dovetails extending from the first side to the second side of the first type cell holder and a second pair of negative dovetails formed as part of the rear side, the second pair of negative dovetails extending from the first side to the second side of the first type cell holder.

The aforementioned example embodiment wherein the first pair of negative dovetails are separated by a dimension X1 along the height dimension H3 of the first type cell holder and wherein the second pair of negative dovetails are separated by a dimension X2 along the height dimension H3 of the first type cell holder.

The aforementioned example embodiment wherein the dimension X1 is greater than the dimension X2.

The aforementioned example embodiment wherein the X1 dimension is from about 142.0 mm to about 143.5 mm.

The aforementioned example embodiment wherein the X1 dimension is approximately 142.75 mm.

The aforementioned example embodiment wherein the X2 dimension is from about 118.25 mm to about 119.75 mm.

The aforementioned example embodiment wherein the X2 dimension is approximately 119.0 mm.

The aforementioned example embodiment wherein the first type of cell holder further comprises a first rib on the first side and a second rib on the second side, each of the first rib and the second rib extends away from the respective side in a direction away from a center of the first type of cell holder and snakes along the respective side between adjacent, offset battery cell cavities.

The aforementioned example embodiment wherein the second type of cell holder further comprises a top side defined by a width dimension W4 and a length dimension L4, a bottom side, opposed and generally parallel to the top side, defined by the width dimension W4 and the length dimension L4, a front side defined by the width dimension W4 and a height dimension H4, a rear side, opposed and generally parallel to the front side, defined by the width dimension W4 and the height dimension H4, a first side defined by the length dimension L4 and the height dimension H4 and a second side, opposed and generally parallel to the first side, defined by length dimension L4 and the height dimension H4.

The aforementioned example embodiment wherein the second type of cell holder further comprises a first pair of positive dovetails formed as part of the front side, the first pair of positive dovetails extending from the first side to the second side of the second type cell holder yet not extending all the way to the first side and the second side, and a second pair of positive dovetails formed on the rear side, the second pair of positive dovetails extending from the second side to the first side of the second type cell holder yet not extending all the way to the first side and the second side.

The aforementioned example embodiment wherein the first pair of positive dovetails formed as part of the front side of the second type cell holder are separated by a dimension Y2 along the height dimension H4 of the second type cell holder and the second pair of positive dovetails formed as part of the rear side of the second type cell holder are separated by a dimension Y1 along the height dimension H4 of the second type cell holder.

The aforementioned example embodiment wherein the dimension Y1 is greater than the dimension Y2.

The aforementioned example embodiment wherein the Y1 dimension is from about 142.0 mm to about 143.5 mm. 142.75 mm.

The aforementioned example embodiment wherein the Y2 dimension is from about 118.25 mm to about 119.75 mm.

The aforementioned example embodiment wherein the Y2 dimension of approximately 119.0 mm.

The aforementioned example embodiment wherein the second type of cell holder further comprises a first rib on the first side and a second rib on the second side, each of the first rib and the second rib extends away from the respective side in a direction away from a center of the first type of cell holder and snakes along the respective side between adjacent, offset battery cell cavities.

The aforementioned example embodiment wherein the at least one cell holder comprises (1) a top side defined by a width dimension and a length dimension, (2) a bottom side, opposed and generally parallel to the top side, defined by the width dimension and the length dimension L3, (3) a front side defined by the width dimension and a height dimension and (4) a rear side, opposed and generally parallel to the front side, defined by the width dimension and the height dimension, (5) a first side defined by the length dimension and the height dimension and (6) a second side, opposed and generally parallel to the first side, defined by length dimension and the height dimension; and a rib extending along the first side in the height dimension and from the first side in the width dimension of the at least one cell holder between a first battery strap and an adjacent, second battery strap.

The aforementioned example embodiment wherein the first battery strap has a first electric potential and the second battery strap has a second electric potential, the first electric potential being greater than the second electric potential.

The aforementioned example embodiment wherein the plurality of battery straps comprises (1) a first subset of battery straps, each battery strap of the first subset of battery straps including an overlapping region at a forward area of the battery strap, the overlapping region including a plurality of strap-strap screw holes and (2) a second subset of battery straps, each battery strap of the second subset of battery straps including an overlapped region at a rearward area of the battery strap, the overlapped region including a plurality of strap-strap screw holes, the overlapping region of a battery strap of the first subset of battery straps overlapping the overlapped region of an adjacent battery strap of the second subset battery straps, the strap-strap screw holes of the first subset battery strap aligned with the strap-strap screw holes of the second subset battery strap; and further comprising a strap-strap fastening screw received through each of the aligned strap-strap screw holes of the first subset battery strap and strap-strap screw holes of the adjacent, second subset battery strap mechanically and electrically coupling the first subset battery strap to the adjacent, second subset battery strap.

The aforementioned example embodiment wherein the at least one cell holder comprises a plurality of screw holes, the at least one cell holder screw holes aligned with the strap-strap screw holes of the first subset battery strap and the strap-strap screw holes of the second subset battery strap, the strap-strap fastening screws received in corresponding screw holes of the at least one cell holder affixing the first subset battery strap and the second subset battery strap to the at least one cell holder.

An aspect of the present invention may include a combination of an electric power tool and a battery pack for powering the electric power tool.

The aforementioned example embodiment may further include a combination wherein the handle guidance/latching element housing includes an opening associated with the groove that provides passage from an inner surface of the handle guidance/latching element and an outer surface of the handle guidance/latching element.

### BRIEF DESCRIPTION OF THE DRAWINGS

FIG. 1 is a front elevation view of an example riding lawn mower.

FIG. 2 is a rear elevation view of the lawn mower of FIG. 1.

FIG. 3 is a rear, right side isometric view of the lawn mower of FIG. 1.

FIG. 4 is a rear, left side isometric view of the lawn mower of FIG. 1.

FIG. 5 is a left side, elevation view of an example battery pack.

FIG. 6 is a right side, elevation view of the battery pack of FIG. 5.

FIG. 7 is a rear side, elevation view of the battery pack of FIG. 5.

FIG. 8 is a front side, elevation view of the battery pack of FIG. 5.

FIG. 9 is a top side, plan view of the battery pack of FIG. 5.

FIG. 10 is a bottom side, plan view of the battery pack of FIG. 5.

FIG. 11 is a top, rear, left side, isometric view of the battery pack of FIG. 5.

FIG. 12 is a top, rear, right side, isometric view of the battery pack of FIG. 5.

FIG. 13 is a top, front, left side, isometric view of the battery pack of FIG. 5.

FIG. 14 is a top, front, right side isometric view of the battery pack of FIG. 5.

FIG. 15 is a bottom, rear, right side isometric view of the battery pack of FIG. 5.

FIG. 16 is a bottom, rear, left side isometric view of the battery pack of FIG. 5.

FIG. 17 is a bottom, front, left side isometric view of the battery pack of FIG. 5.

FIG. 18 is a bottom, front, right side isometric view of the battery pack of FIG. 5.

FIG. 19 is a top, plan view of the lawn mower of FIG. 1 and the battery pack of FIG. 5 prior to insertion of the battery pack in the lawn mower.

FIG. 20 is a rear, elevation view the lawn mower and the battery pack of FIG. 29 prior to insertion of the battery pack in the lawn mower.

FIG. 21 is a top, rear, right side isometric view of the lawn mower and the battery pack of FIG. 20.

FIG. 22 is a rear, elevation view the lawn mower and the battery pack of FIG. 29 after insertion of the battery pack in the lawn mower.

FIG. 23 is a rear, elevation view the lawn mower of FIG. 22 and five battery packs after insertion of the battery packs in the lawn mower.

FIG. 25 is a bottom, rear, right side exploded isometric view of the battery pack of FIG. 5.

FIG. 26 is a left side elevation view of a top housing of the battery pack of FIG. 5.

FIG. 27 is a bottom, plan view of the top housing of FIG. 26.

FIG. 28 is a top, plan view of the top housing of FIG. 26.

FIG. 29 is a front, elevation view of the top housing of FIG. 26.

FIG. 30 is a section view of the top housing of FIG. 26 along section lines A-A.

FIG. 31 is a section view of the top housing of FIG. 27 along section lines B-B.

FIG. 32 is a detail view of the top housing of FIG. 27.

FIGS. 33-35 are various views of an example terminal block assembly of the battery pack of FIG. 5.

FIGS. 36-40 are various view of the terminal block assembly of FIGS. 33-35 mounted on an example printed circuit board (PCB).

FIG. 41 is a section view of the battery pack of FIG. 5 illustrating the terminal block assembly and PCB within the top housing of the battery pack.

FIG. 42 is another section view of the battery pack of FIG. 5 illustrating the terminal block assembly and PCB within the top housing of the battery pack.

FIG. 43 is a front, top, left side exploded view of an example core pack of FIG. 24.

FIG. 44 is a rear, bottom right side exploded view of the core pack of FIG. 25.

FIGS. 45A-45I are various views of an example of a first type of cell holder of the core pack of FIG. 43.

FIGS. 46A-45I are various views of an example of a second type of cell holder of the core pack of FIG. 43.

FIGS. 47A and 47B are side views of the first type of cell holder of FIGS. 45A-45I loaded with example battery cells.

FIG. 49 is an isometric section view of the cell holder of FIG. 47A.

FIGS. 50A and 50B are side views of the first type of cell holder of FIGS. 46A-46I loaded with example battery cells.

FIG. 51 is a section view of the cell holder of FIG. 50B.

FIG. 52 is an isometric section view of the cell holder of FIG. 50B.

FIGS. 53A-53C are various views of an example first type of end strap of the battery pack of FIG. 5.

FIGS. 54A-54C are various views of an example second type of end strap of the battery pack of FIG. 5.

FIGS. 55A, 55B, 56A and 56B are views of example connecting straps for the first type of cell holder of FIG. 45.

FIGS. 57A, 57B, 58A, and 58B are views of example connecting straps for the second type of cell holder of FIG. 46.

FIGS. 59A-59H are various views of the first type of cell holder of FIG. 45 and a first set of straps.

FIGS. 60A-60H are various views of the first type of cell holder of FIG. 45 and a second set of straps.

FIGS. 61A-61D are various views of the first type of cell holder of FIG. 45 and a third set of straps.

FIGS. 62A-62D are various views of the second type of cell holder of FIG. 46 and a fourth set of straps.

FIGS. 63A and 63B are various views of the cell holder of FIG. 61 and the cell holder of FIG. 62 prior to assembly.

FIGS. 64A and 64B are various views of the cell holder of FIG. 61 and the cell holder of FIG. 62 during assembly.

FIGS. 65A and 65B are various views of the cell holder of FIG. 61 and the cell holder of FIG. 62 after assembly.

FIGS. 66A-66C are isometric views of the cell holder of FIG. 62 and the assembled cell holders of FIG. 65 before, during and after assembly.

FIGS. 67-71 are top views of an example assembly process of the example cell holders of the core pack of FIG. 24.

FIGS. 72A and 72B are side views of the assembled cell holders of FIG. 71.

FIGS. 73 and 74 are detail views of the assembled cell holders of FIG. 72B during the screw insertion process.

FIGS. 75 and 76 are detail views of the assembled cell holders of FIG. 72B after the screw insertion process.

FIGS. 77A and 77B are various views of the assembled cell holders of FIG. 66C after the screw insertion process.

FIGS. 78A-78D are various views of the assembled cell holders of FIGS. 72A and 72B after the screw insertion process.

FIGS. 79A-79E are various views of an example PCB-cell holder connector.

FIGS. 80A and 80B are various views of the connector of FIG. 79 connected to the PCB.

FIGS. 81A-81D are various views of the PCB and connectors just prior to assembly with the assembled cell holders of FIG. 78.

FIGS. 82A-82C are various views of the PCB and connectors and cell holders of FIG. 81 after assembly.

FIGS. 83A-83D are various views of the PCB, connectors and cell holders of FIG. 81 after a screw insertion process.

FIG. 85 is detail, section view of a connector and a strap screwed together.

FIG. 86 is a basic circuit diagram of the example battery pack of FIG. 5.

FIG. 87 is an isometric view of an example core pack of the example battery pack of FIG. 5.

FIG. 88 is an exploded, isometric view of the example core pack of FIG. 87.

FIG. 89 is a top view of another example battery pack of the instant application.

FIG. 90 is an isometric view of the example battery pack of FIG. 89.

### DETAILED DESCRIPTION

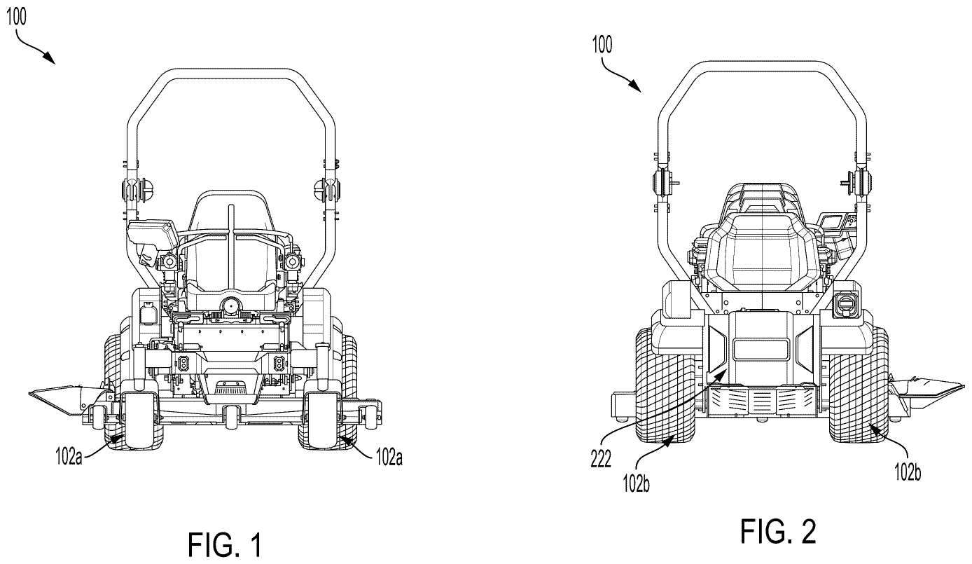

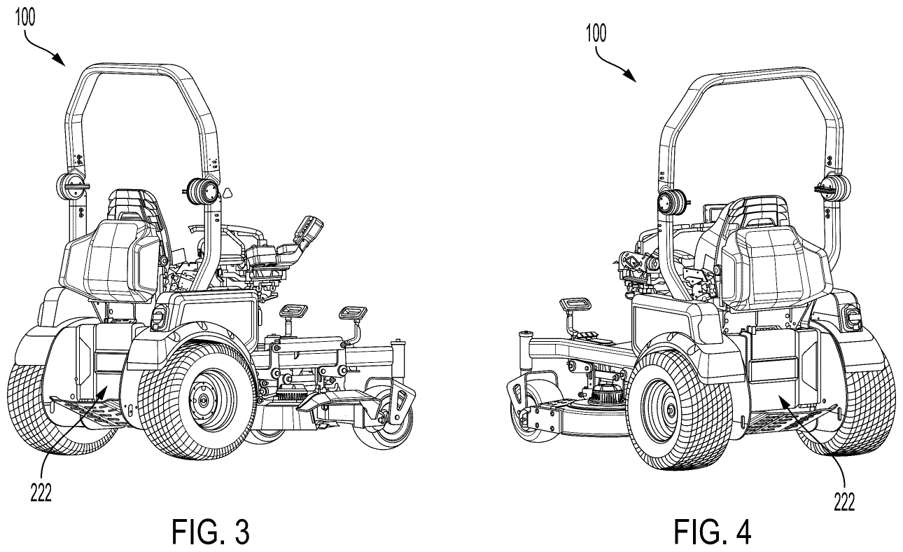

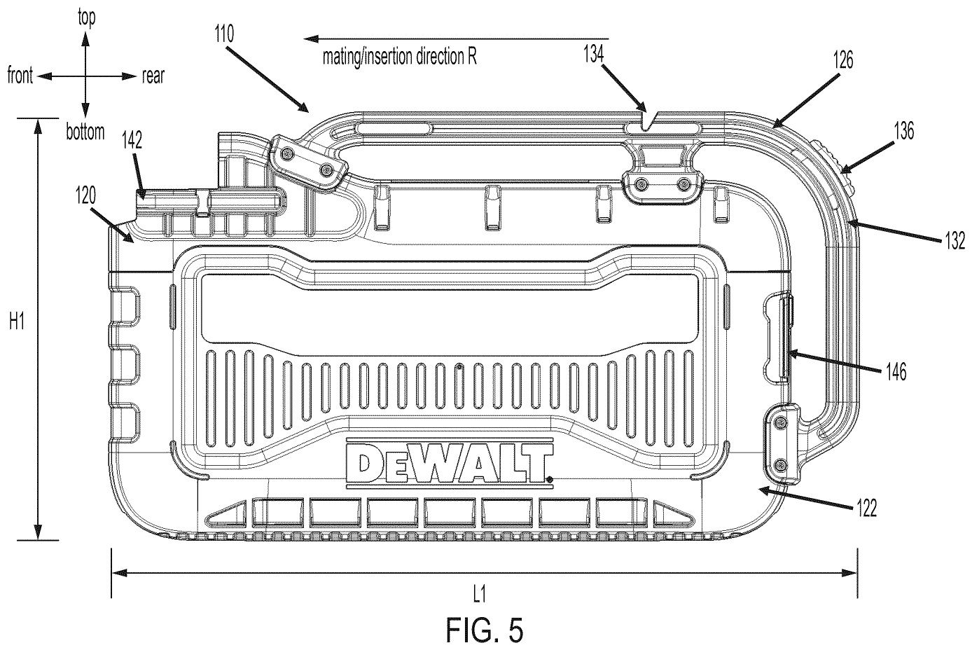

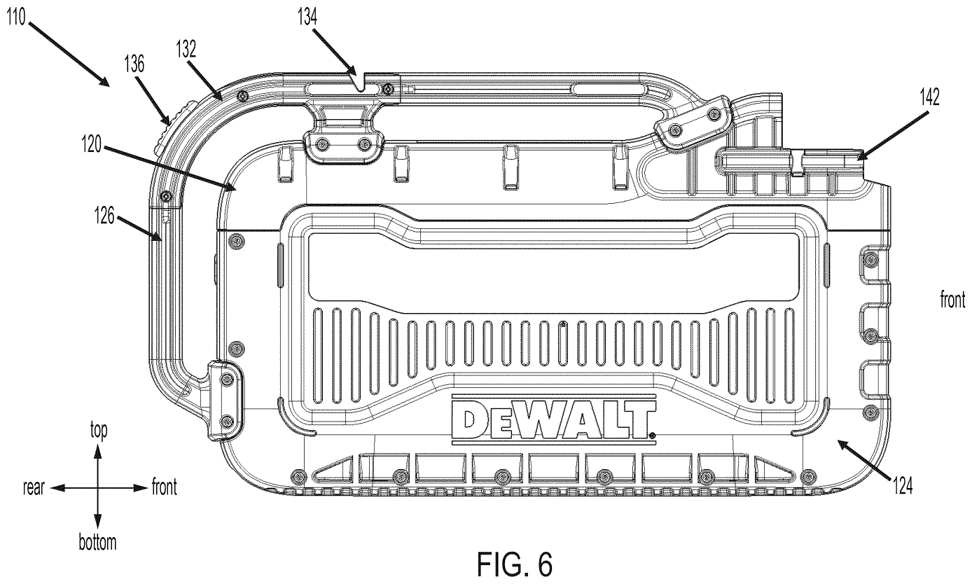

Referring to FIGS. 1-4 , there is disclosed an example electric riding lawn mower 100. The lawn mower 100 includes a front pair of wheels 102a and a rear pair of wheels 102b. The rear wheels 102b may include an electric hub motor 104 for driving the rear wheels 102b. The lawn mower 100 may include a plurality of cutting blades (not shown). The lawn mower 100 may also include an electric motor associated with and coupled to each of the plurality of cutting blades. The lawn mower may include a motor control module (not shown) for controlling the motors. The electric hub motors 104 for driving the rear wheels 102b and the electric motors for driving cutting blades may be powered by one or more battery packs 110. The battery packs 110 may be rechargeable. The battery packs 110 may be removable. The lawn mower 100 may include a battery pack compartment 210 that receives and houses the removable battery packs 110. The lawn mower 100 may include a battery management system 250. The battery management system 250 may include a battery management/control module that monitors and controls charging and discharging of the battery packs 110.

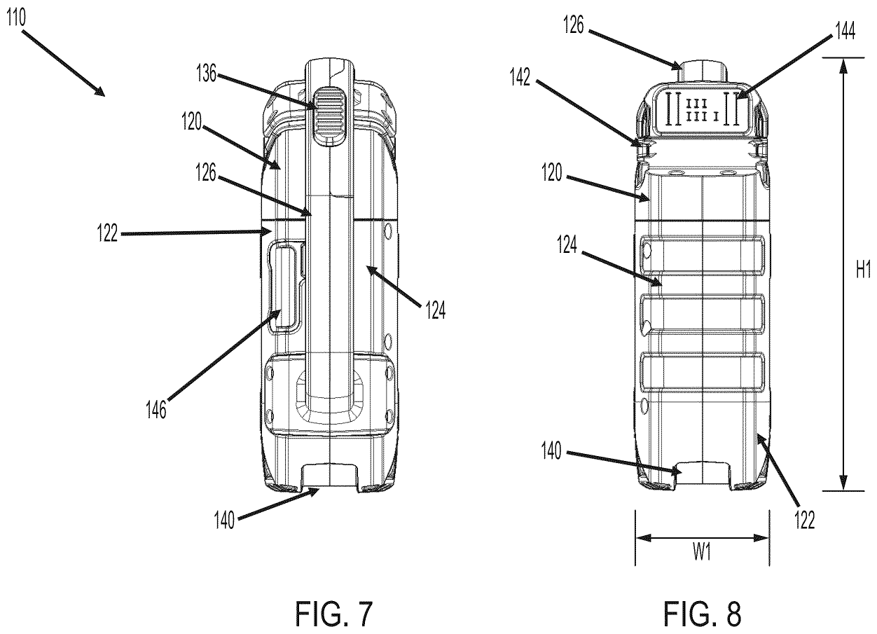

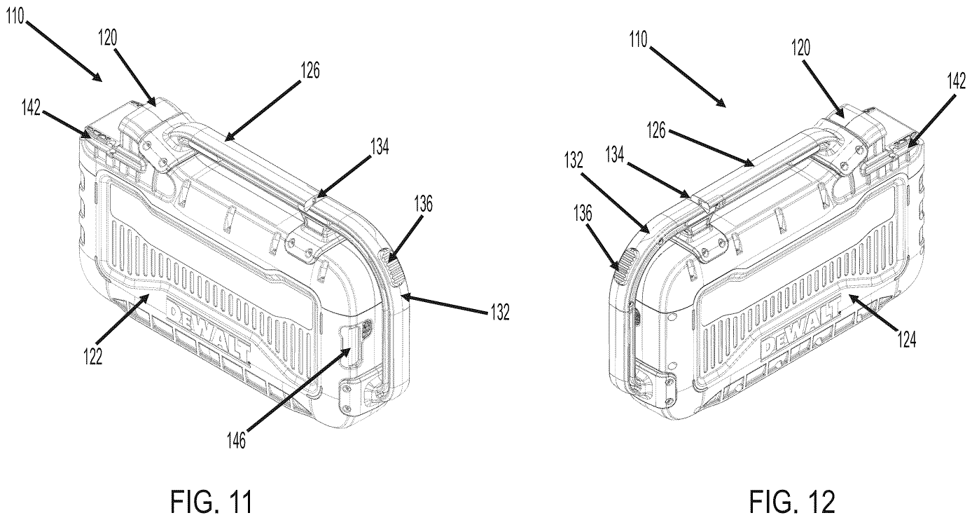

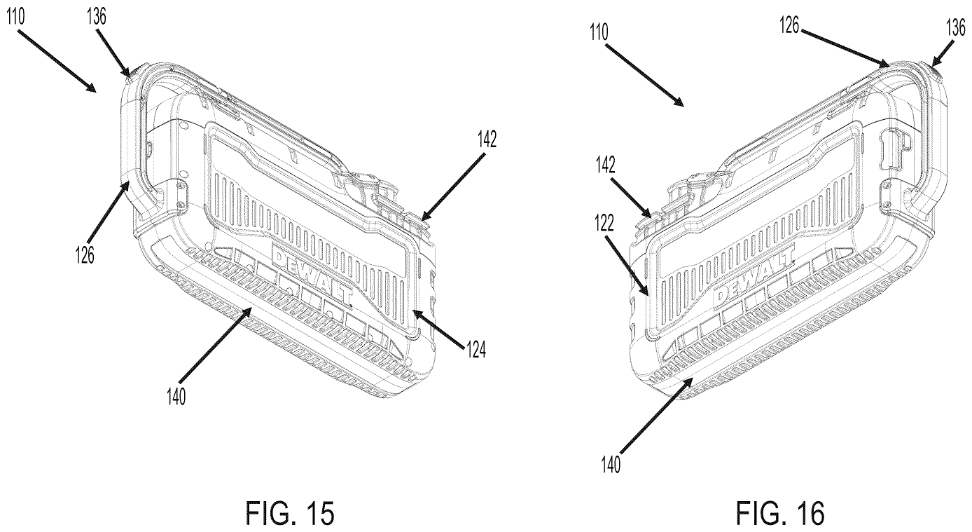

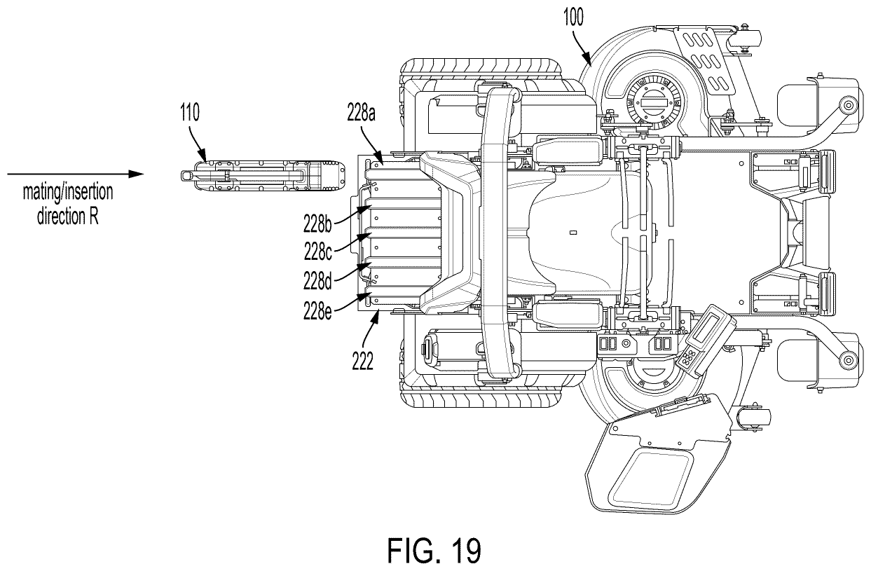

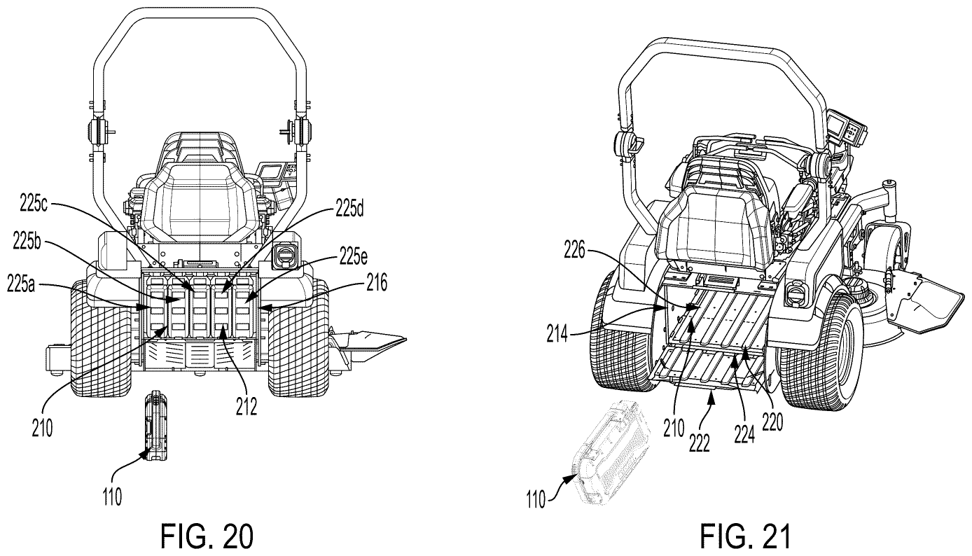

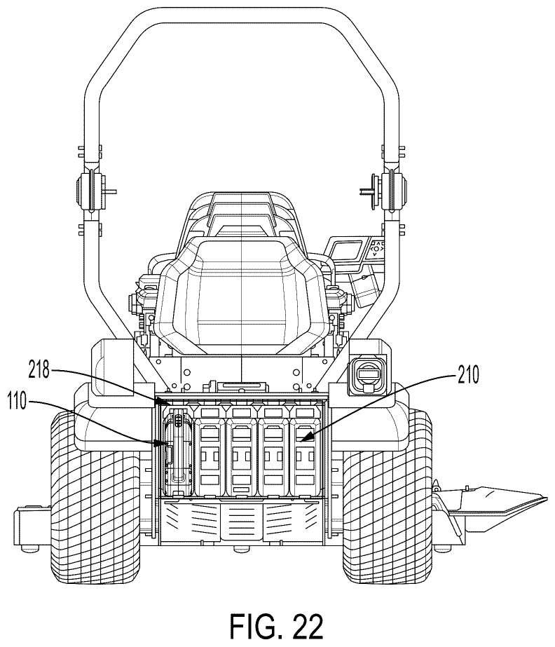

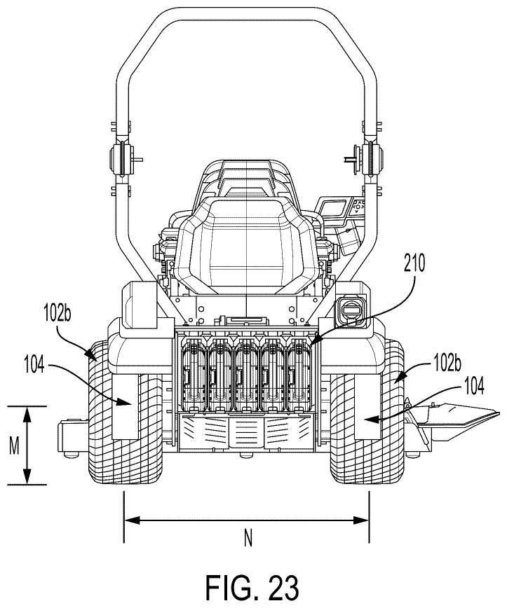

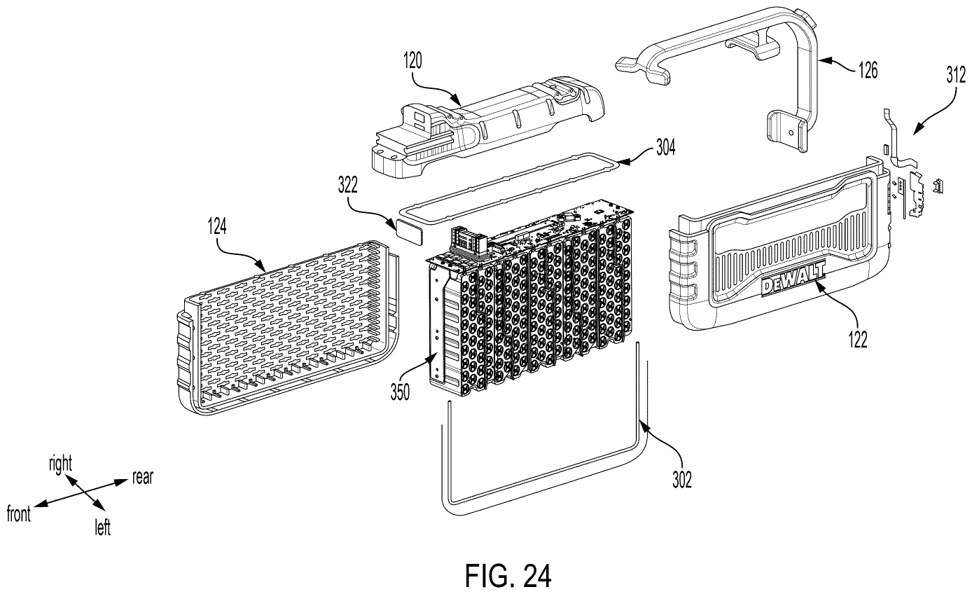

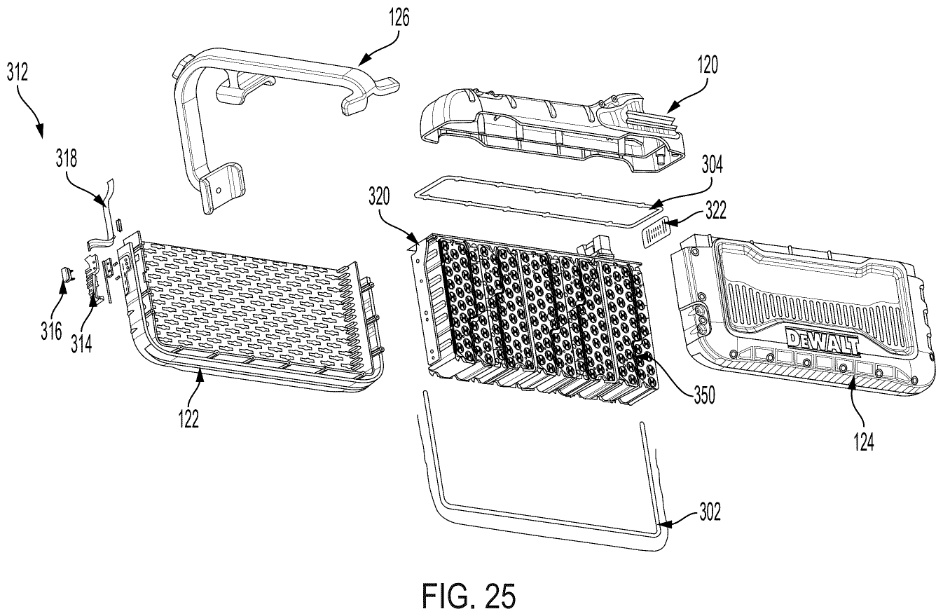

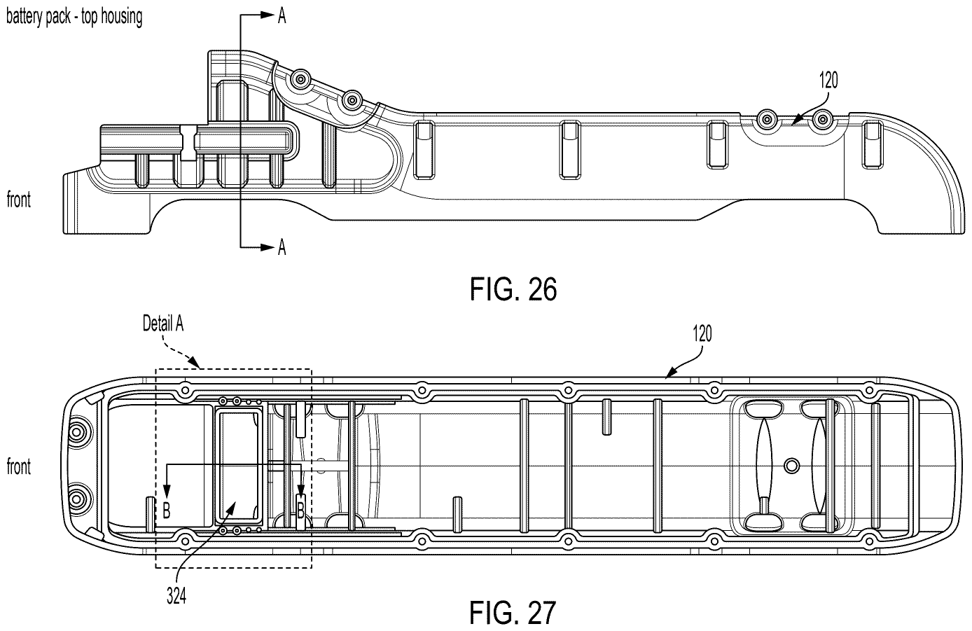

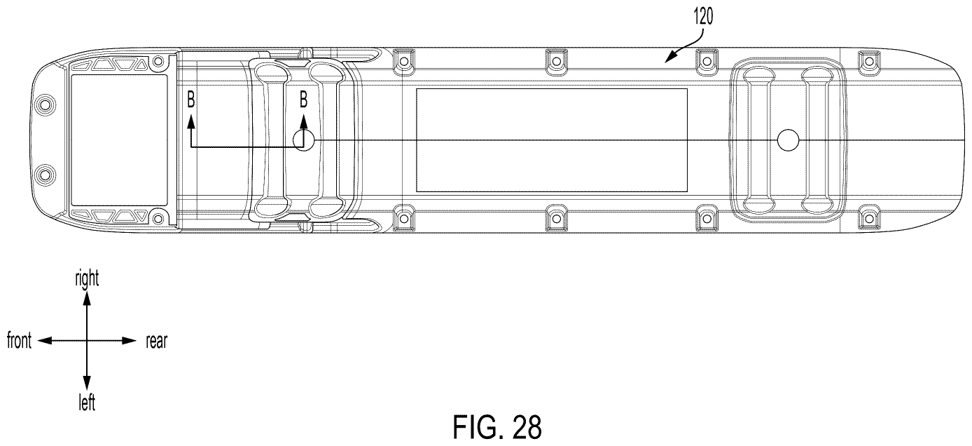

Referring to FIGS. 5-18 , there is disclosed an example battery pack 110 that may be received by the lawn mower 100 and provide power to the electric motors. FIGS. 5-18 illustrate the battery pack 100 in a first state or configuration. This first state may be referred to as a default state. In the default state, a battery pack removal system is not actuated.

As illustrated, the battery pack 110 includes a housing. The housing may include a housing top portion (sometimes simply referred to as a top housing or top side portion) 120, a housing left portion (sometimes simply referred to as a left housing or left side portion or left housing portion) 122 and a housing right portion (sometimes simply referred to as a right housing or right side portion or right housing portion) 124. The top housing 120, the left housing 122 and the right housing 124 may be assembled to form an interior cavity, discussed in more detail below.

The battery pack 110 may include an interface for mating and coupling with a tool to be powered by the battery pack, for example the mower 100. The interface configured such that the battery pack 110 moves along a mating/insertion direction R upon mating with the mower 100.

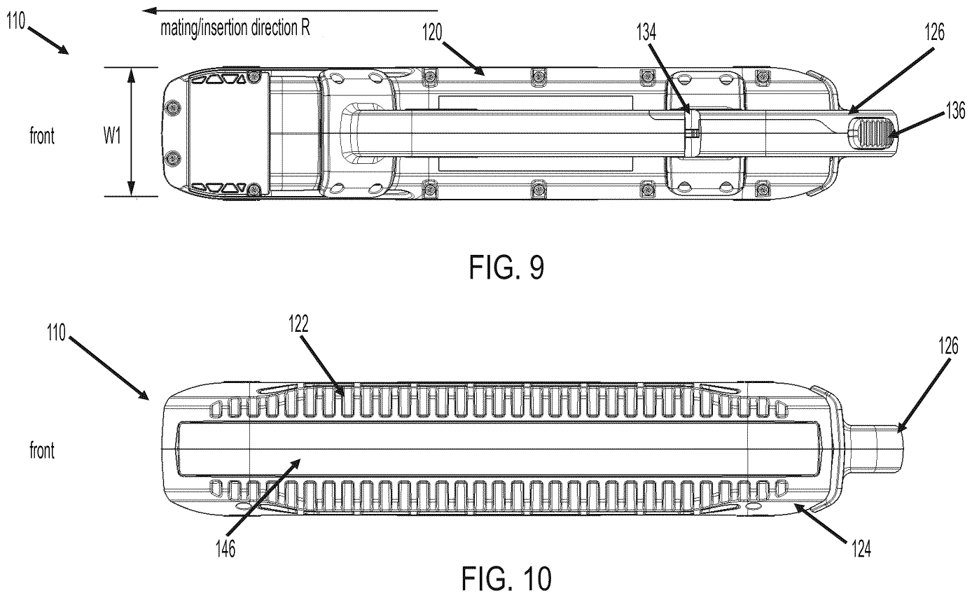

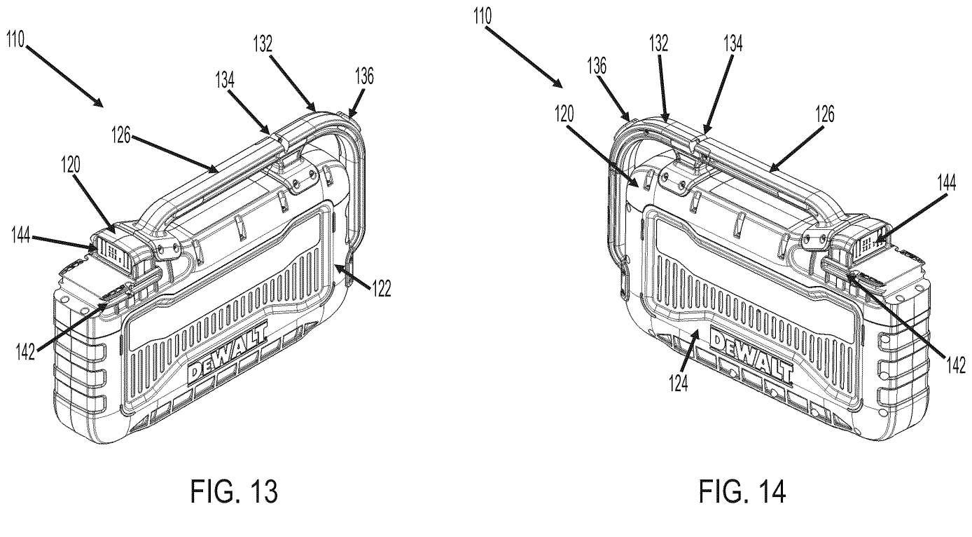

As illustrated in FIG. 5, the battery pack 110 has a length dimension L1 and a height dimension H1. The length dimension L1 is generally parallel to the insertion direction R. The height dimension H1 is generally perpendicular to the insertion direction R and generally perpendicular to the length dimension L1. As illustrated in FIG. 8, the battery pack 110 has a width dimension W1. The width dimension W1 is generally perpendicular to the mating direction and generally perpendicular to the length dimension L1 and generally perpendicular to the height dimension H1. FIGS. 5 and 6 also illustrates a context for the battery pack 110 for purposes of this patent disclosure showing a front, a rear, a top and a bottom of the battery pack 110.

The battery pack 110 may include a battery pack handle 126. The battery pack handle 126 may be integrally formed with the battery pack housing or may be a discrete element that is attached to the battery pack housing. The battery pack handle 126 may have a generally L-shaped configuration or geometry and may include a first leg 128 extending along a top side of the top housing 120 (along the length dimension L1) and a second leg 130 extending along a rear side of the top housing 120, the left housing 122 and the right housing 124 (along the height dimension H1). The handle 126 may also include a transitional portion 132 that couples the first leg 128 of the handle 126 and the second leg 130 of the handle 126.

The first leg 128 of the handle 126 may include a catch 134 that is configured to receive a corresponding latch in the lawn mower 100, as described in more detail below. The handle 126 may also include a removal system actuation button 136 that actuates a lever 138, described in more detail below, to assist in removing the battery pack 110 from the lawn mower 100. The actuation button 136 may be located in the transitional portion 132 of the handle 126.

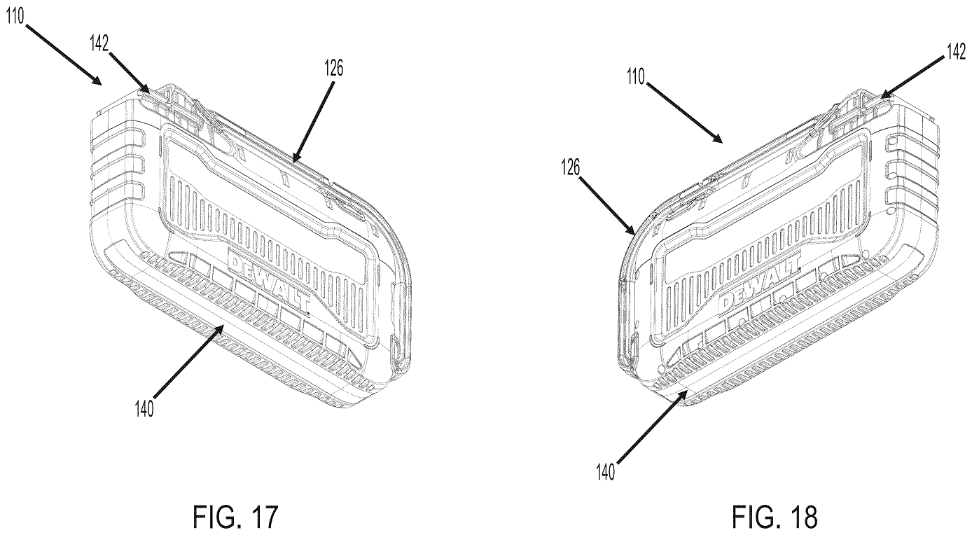

The battery pack 110 may also include a groove or slot 140 on a bottom side of the battery pack 110. As illustrated in FIGS. 10 and 15-18, the groove 140 extends along the bottom side of the battery pack 110 (along the length dimension L1).

The top housing 120 may also include a set of side grooves 142. The side grooves 142 are configured to receive corresponding rails or tongues in the lawn mower 100, as described in more detail below.

The battery pack 110 may also include a plurality of terminal slots 144 in the top housing 120. The terminal slots 144 provide openings to enable terminals of a tool to which the battery pack 110 shall provide power to enter the battery pack housing and mate with battery pack terminals (not shown).

The battery pack 110 may also include a state of charge indicator 146 to indicate the state of charge of the battery pack 110.

An example battery pack may have a width W1 from about 3.9 inches to about 4.3 inches. Another example battery pack may have a width W1 of approximately 4.1 inches.

An example battery pack may have a length L1 from about 22.7 inches to about 23.1 inches.

Another example battery pack may have a length L1 of approximately 22.9 inches. An example battery pack may have a height H1 from about 12.9 inches to about 13.3 inches. Another example battery pack may have a height H1 of approximately 13.1 inches.

An example battery pack may have a volume V1 from about 1142.0 in³ to about 1321.1 in³. Another example battery pack may have a volume V1 of approximately 1230.0 in³.

An example battery pack may have an impedance of from about 28 mOhm to about 32 mOhm. Another example battery pack may have an impedance of approximately 30 mOhm. An example battery pack may have a capacity from about 50 Ah to about 70 Ah. Another example battery pack may have a capacity of approximately 60 Ah. An example battery pack may have a nominal voltage from about 48V to about 60V. Another example battery pack may have a nominal voltage of approximately 54V. An example battery pack may have a maximum, no load voltage of about 54V to about 66V. Another example battery pack may have a maximum, no load voltage of approximately 60V.

An example battery pack may have a weight of about 40 lb to about 53 lb. Another example battery pack may have a weight of approximately 47 lb.

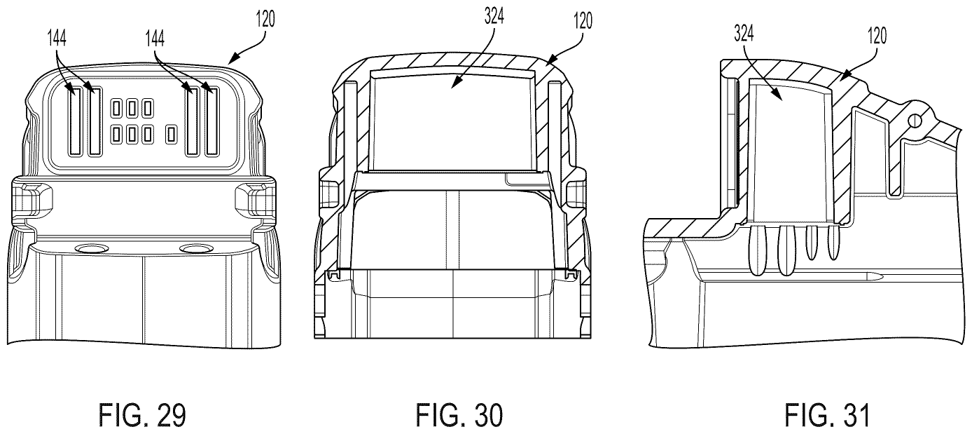

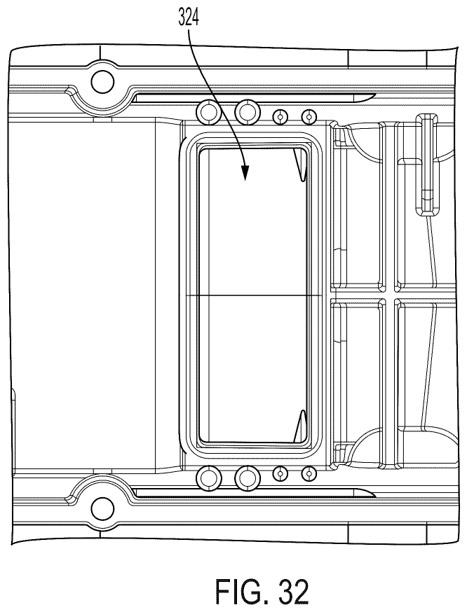

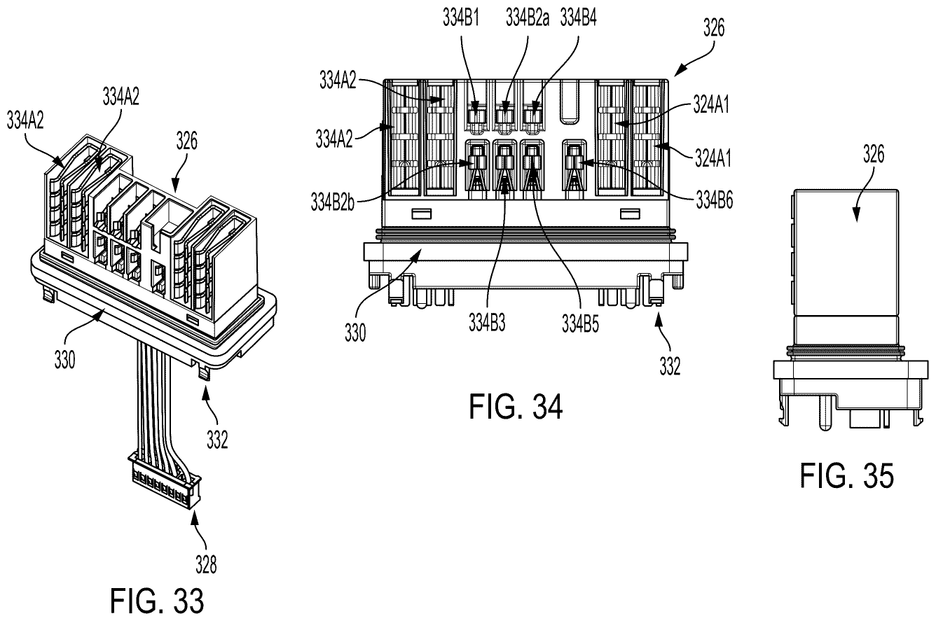

FIGS. 19-21 illustrate details regarding an example lawn mower and an example battery pack prior to inserting the battery pack into the lawn mower and the lawn mower receiving the battery pack. The example lawn mower may be lawn mower 100 described above and the example battery pack may be battery pack 110 described above. The lawn mower 100 may include a battery pack compartment 210. The battery pack compartment 210 may include a section/portion/space/place/volume/cavity to receive and hold the battery pack(s) 110.

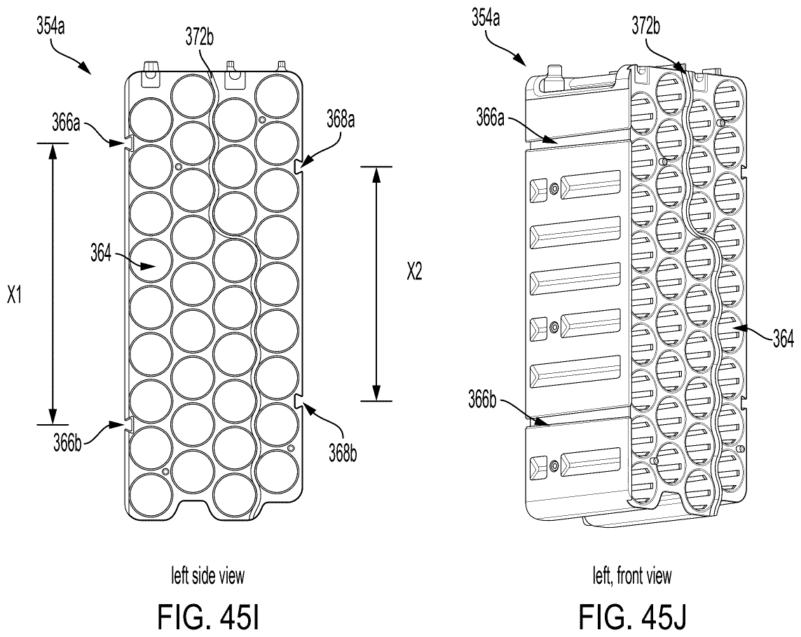

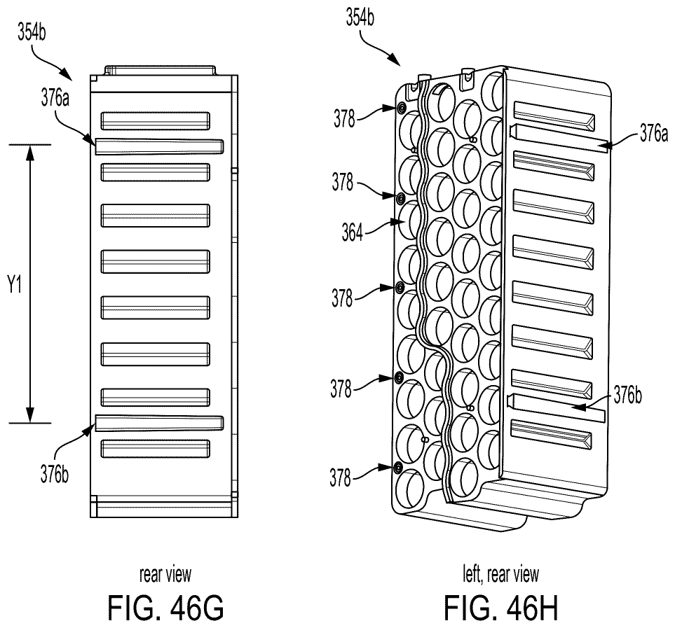

The lawn mower 100 may also include a section/portion/space/place/volume for electronics to monitor and control the battery pack(s) 110 (referred to simply as electronics space 250, infra). As illustrated in FIGS. 34 and 38, the electronics space 250 may be adjacent to the compartment 210.

There is a pack/tool interface—subsequently simply referred to as the “interface”—between the battery pack and the battery-powered tool. The interface includes a battery pack portion—sometimes referred to as a battery pack portion of the interface or a battery pack interface—and a power tool portion—sometimes referred to as a tool portion of the interface or tool interface.

The battery pack compartment 210 serves as physical location to hold the battery pack(s) 110 and make mechanical and electrical connections between the battery pack(s) 110 and the lawn mower 100. The battery pack compartment 210 may have a generally rectangular box shape. The compartment 210 may include a front wall 212, a left side wall 214, a right side wall 216, a top wall 218, a bottom wall 220 and a rear wall 222. The rear wall 222 also serves as a door to the compartment 210, as described in more detail below. The rear wall/door 222 may be connected to the compartment 210 by a hinge 224. The hinge 224 enables the rear wall/door 222 to fold down/open in a rearward direction such that the rear wall 222 may be generally in a same plane as the bottom wall 220.

The compartment 210 may have a plurality of positions, each position configured to receive an individual battery pack 110. The illustrated example battery pack compartment 210 includes five positions. Alternate battery pack configurations may include fewer or more positions.

Each position of the plurality of positions includes a discrete portion of the tool portion of the interface. In other words, in the illustrated example embodiment, the tool interface includes all five positions/receptacle 225a-e and the associated components/elements and each position/receptacle includes a discrete portion of the tool portion of the interface. In the example embodiment, there are five discrete portions of the tool portion of the interface.

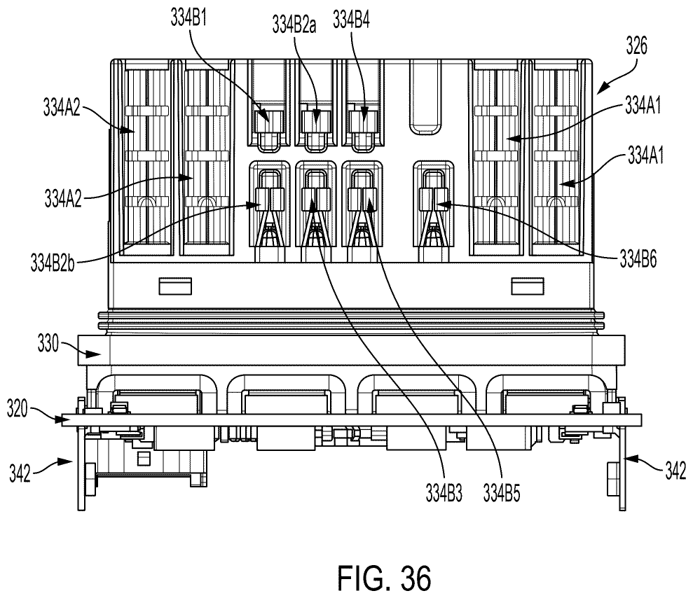

FIG. 22 illustrates a single battery pack 110 inserted into/received in the battery pack compartment 210. If only a single battery pack 110 is received in the battery pack compartment 210 and electrically coupled to the mower control systems, the mower may operate the electric hub motors to drive the wheels. However, if only a single battery pack is received in the battery pack compartment and electrically coupled to the mower control systems, the mower is not able to operate the electric motors to drive the cutting blades. If two or more battery packs are received in the battery pack compartment and electrically coupled to the mower control systems, the mower may operate the electric hub motors to drive the wheels and the electric motors to drive the cutting blades.

FIG. 22 illustrates the first battery pack 110 inserted in the lawn mower 100 and the lawn mower 100 having received the battery pack 110. As illustrated, the battery pack 110 is positioned in Position 1 or a first position of the compartment 210.

Each position of the compartment 210 includes a receptacle for a battery pack 110. Each receptacle includes the tool portion of the interface. The tool portion of the interface may include, among other elements, a rail 226 on the bottom wall—sometimes referred to as an enclosure bottom rail. Specifically, each position includes a rail 226 (for a total of five rails 226a, 226b, 226c, 226d, 226e) extending along the bottom wall 220 in a direction R in which the battery pack 110 is inserted into or removed from the compartment 210. The tool interface may also include a rail 228 on the rear wall. Specifically, each position includes a rail 228 (for a total of five rails 228a, 228b, 228c, 228d, 228e) extending along the rear wall 222 aligned with the rail 226 on the bottom wall 220 of the corresponding position. When the rear wall 222 is folded down to be in the same plane as the bottom wall 220, the rail 228 on the rear wall 222 and the rail 226 on the bottom wall 220 form an extended rail.

Each position may also include a set of tool terminals 230. The tool terminals 230 may be received in the battery pack terminal slots 144 and mate with a set of battery pack terminals. Each position may also include a pair of side rails 232. The side rails 232 are received in corresponding side grooves 142 of the battery pack 110. The side rails 232 and side grooves 142 serve to guide and align the battery pack 110 during insertion into the compartment 210 and to assist in holding the battery pack 110 in place during operation of the lawn mower 100.

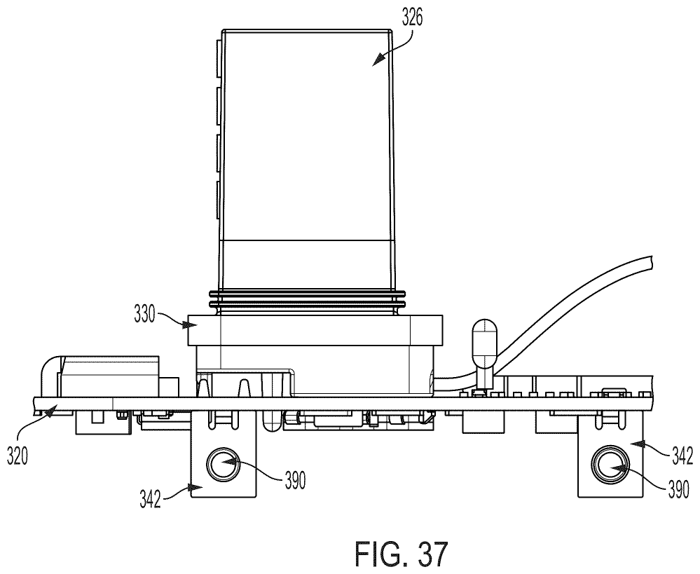

FIG. 23 illustrates a plurality of (five) battery packs inserted into/received in the battery pack compartment. An example mower may have a rear track dimension N (measured from a center of a first rear wheel/tire to a center of a second rear wheel/tire) from about 38 inches to about 42 inches. Another example mower may have a rear track dimension N of approximately 39 inches. An example mower may have a rolling radius dimension M (measure from a center of a rear wheel/tire to the bottom of the rear tire) from about 10 inches to about 13 inches. Another example mower may have a rolling radius M of approximately 12 inches.

An example mower may have a battery pack compartment from about 8500 in³ to about 8630 in³. Another example mower may have a battery pack compartment of approximately 8565 in³.

As illustrated, an example mower may accommodate up to five battery packs in the battery pack compartment. As such, an example mower may have a total battery pack volume from about 5710.0 in³ to about 6605.5 in³. Another example battery pack may have a volume V1 of approximately 6150.0 in³

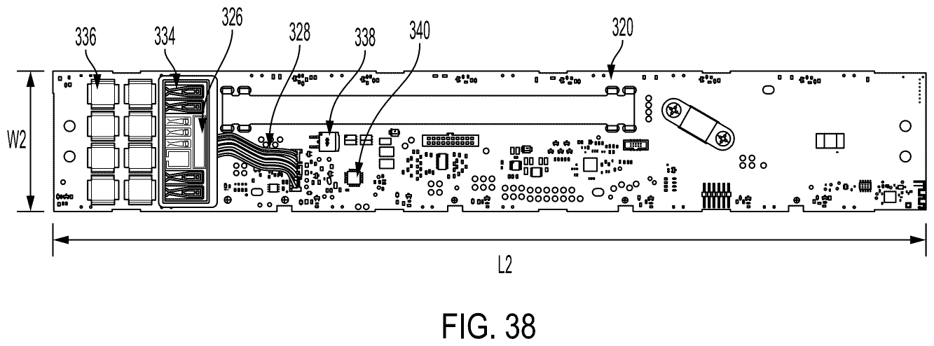

FIGS. 24 and 25 illustrate exploded views of the example battery pack 110. The illustrated example battery pack 110 may include a housing. The housing may include a top side/portion 120, a left side/portion 122 and a right side/portion 124. The battery pack 110 may also include a first gasket 302 and a second gasket 304. The first gasket 302 may be positioned between the right side housing 124 and the left side housing 122 when the housings are assembled. The second gasket 304 may be positioned between the right side housing-left side housing assembly and the top housing 120 when all three housing portions are assembled. The battery pack 110 may also include a handle 126. The handle 126 may be attached to the top housing 120 and the right side housing-left side housing assembly. The handle 126 may have a first attachment 306 that attaches to a middle portion of the top housing portion 120, a second attachment 308 that attaches to a rear portion of the top housing portion 120 and a third attachment 310 that attaches to a rear portion of the right side housing-left side housing assembly. The battery pack 110 may also include an SOC assembly 312 that is positioned within the battery pack housing. The SOC assembly 312 may include a PCB 314, indicators 316 and a connector 318 for coupling to a main PCB 320, described in more detail below. The battery pack 110 may also include a membrane/terminal guard 322. The membrane/terminal guard 322 may be attached to an outer surface of the top housing portion 120 about a set of terminal receiving slots 144 in the top housing portion 120. The battery pack 110 may also include a corepack 350, described in more detail below.

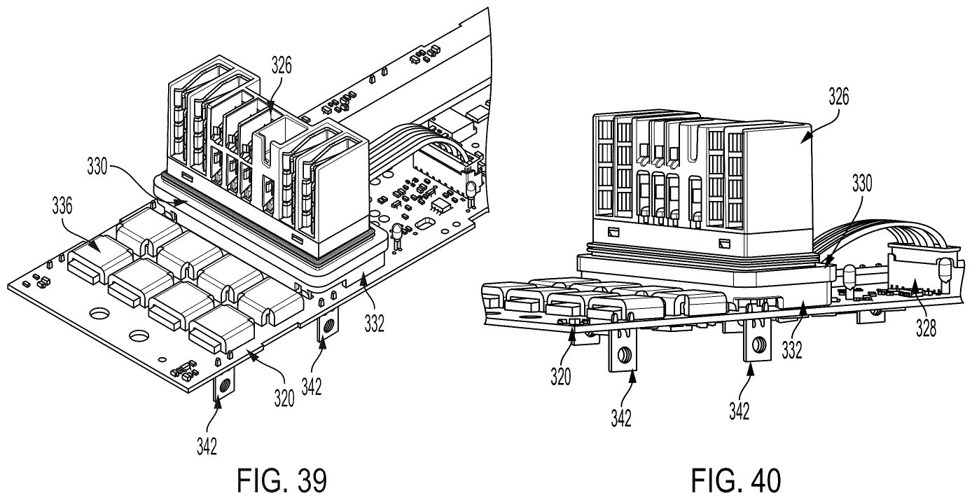

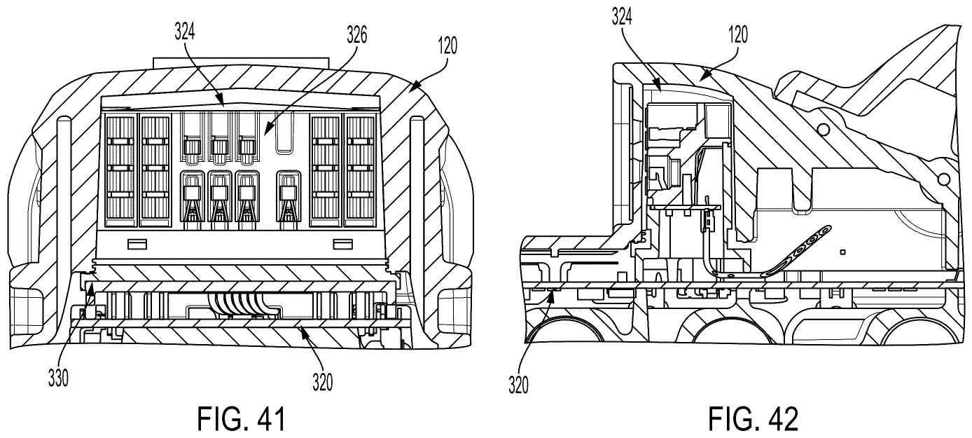

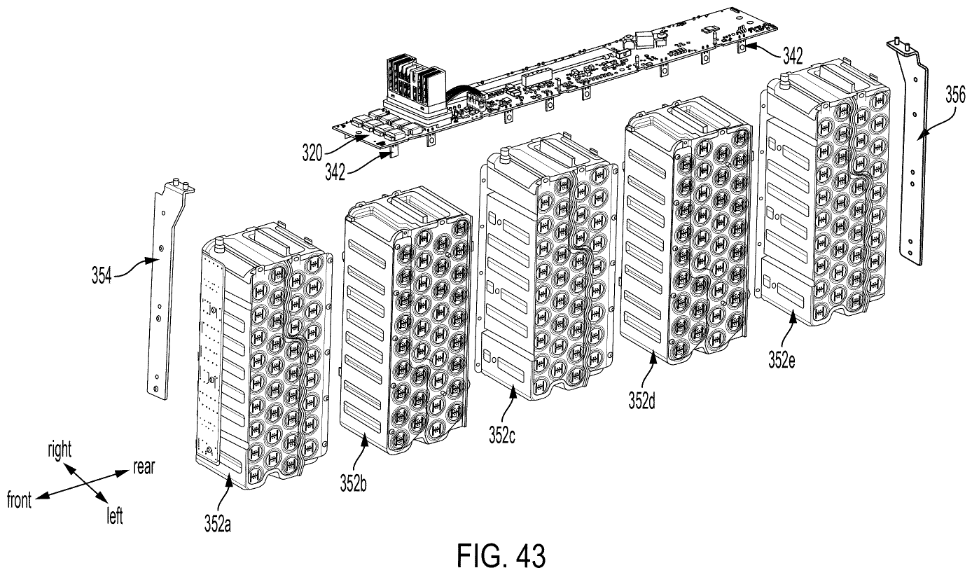

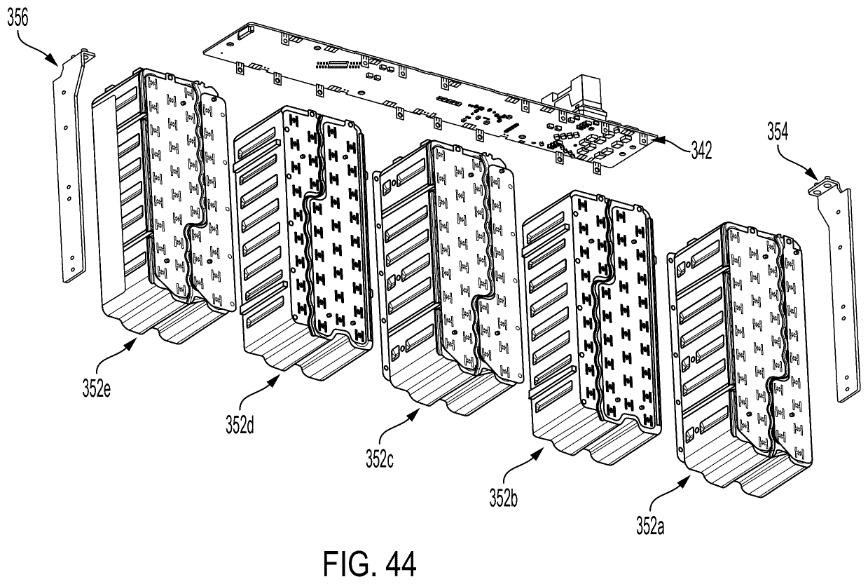

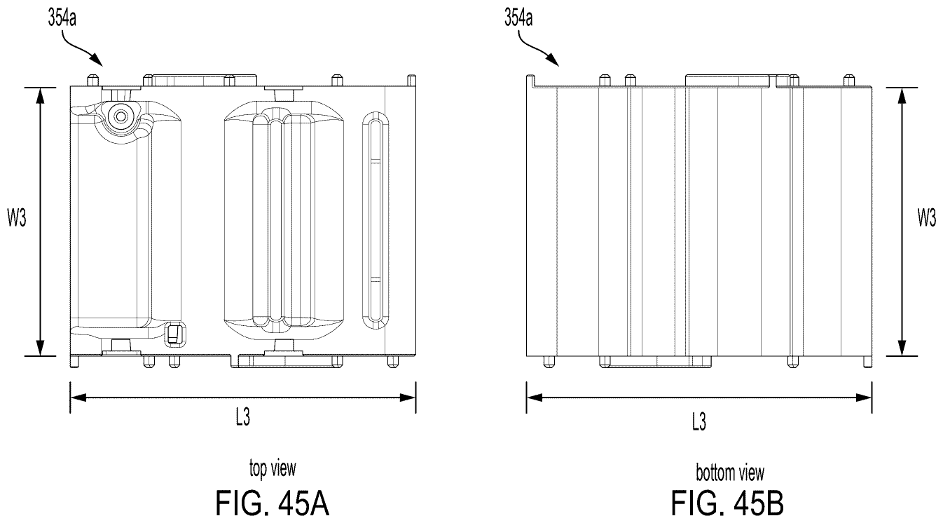

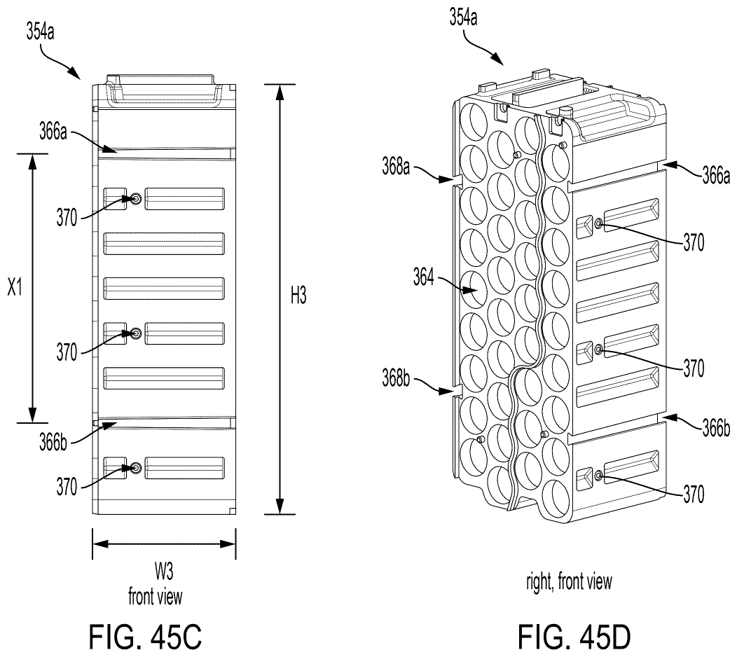

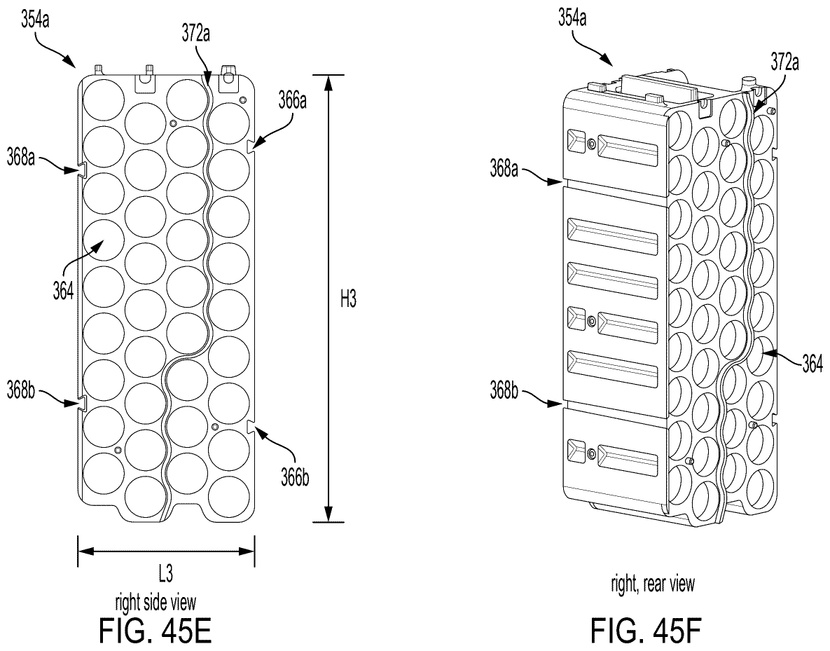

FIGS. 26-32 illustrate various views of an example top housing portion 120—sometimes simply referred to as a top housing—of the example battery pack 110. The top housing 120 may include an internal cavity 324. The cavity 324 is sized and configured to receive the battery pack terminal block 326. The top housing 120 may include a plurality of slots 144 sized and configured to receive a plurality of terminals of a tool, for example the terminals.

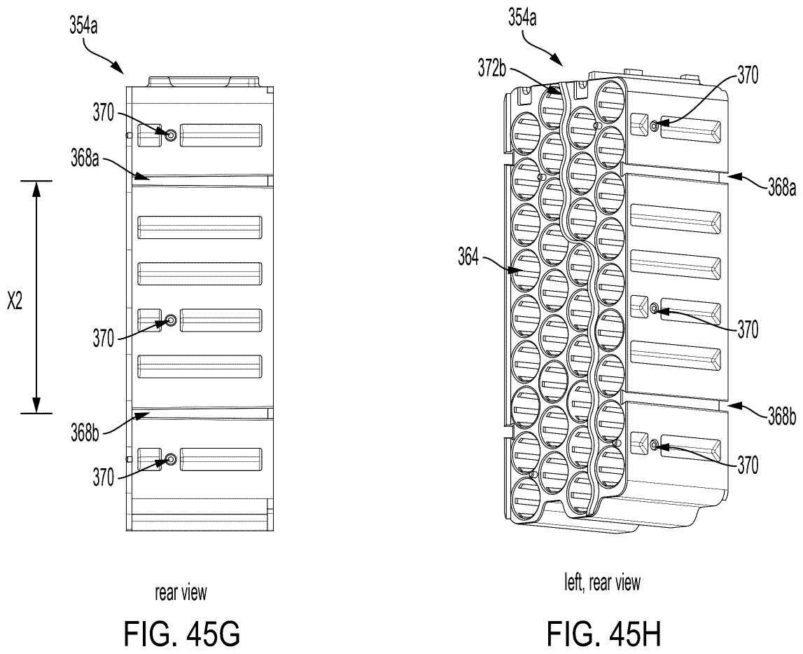

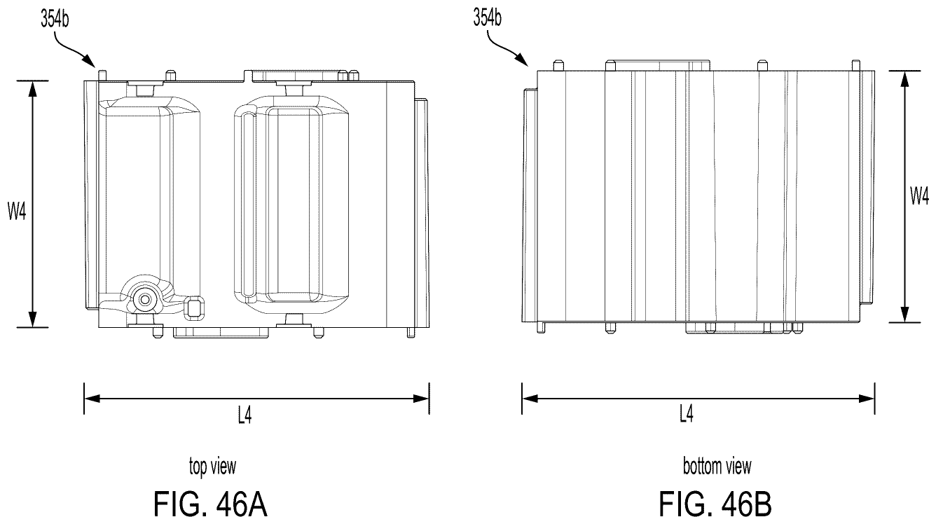

FIGS. 33-35 illustrate various views of an example terminal block assembly of the example battery pack. The terminal block assembly may include a terminal block housing 326, terminal block connector 328, a gasket 330, a plurality of standoffs 332 and a plurality of terminals 334.

The plurality of terminals may include (1) a Batt+/power terminal 334A1 and a Batt−/GND terminal 334A2 for providing charging power to the battery pack 110 from a charging system and discharging power from the battery pack 110 to a load, for example, the various electric motors of the mower, (2) a controller area network (CAN) ID terminal 334B1 to provide a 3.3V signal, (3) a CAN H terminal 334B2a terminal and a CAN L terminal 334B2b (5V signal) for communicating with the CAN, (4) a CAN TERM terminal 334B3 to provide a 5V shutdown signal to the battery pack in certain situations, (5) a CHG EN terminal 334B4 to provide a 12V signal to the pack to request a battery management system (BMS) to operate the pack in a charge mode, (6) a DIS EN terminal 334B5 to provide a 12V signal to the pack to request the BMS to operate the pack in a discharge mode, (7) Stack V/Standby/Pack+terminal 334B6 to provide voltage to various internal systems of the mower.

The terminal block connector 328 provides signals between (to/from) the plurality of battery pack terminals 334 and the main PCB 320. The terminal block gasket 330 provides a seal between the terminal block housing 326 and the top housing 120.

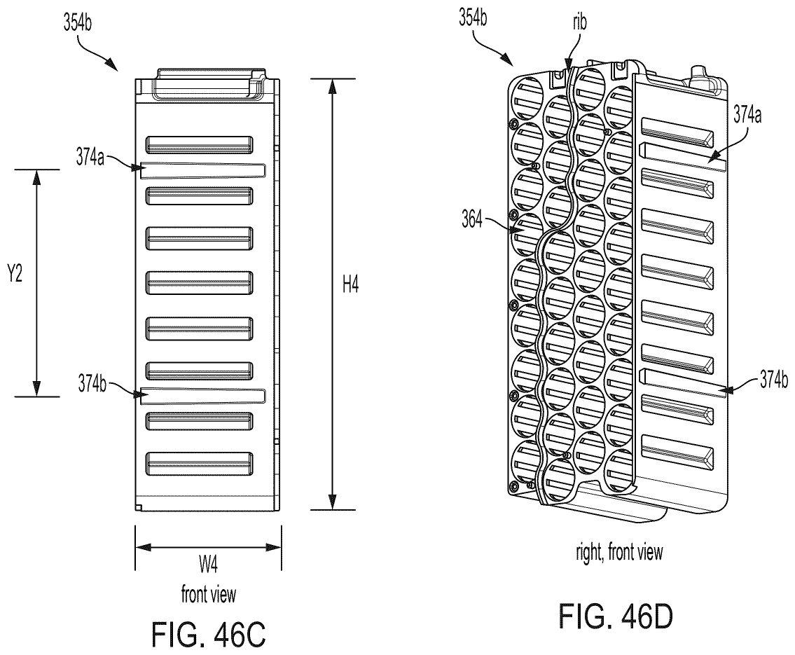

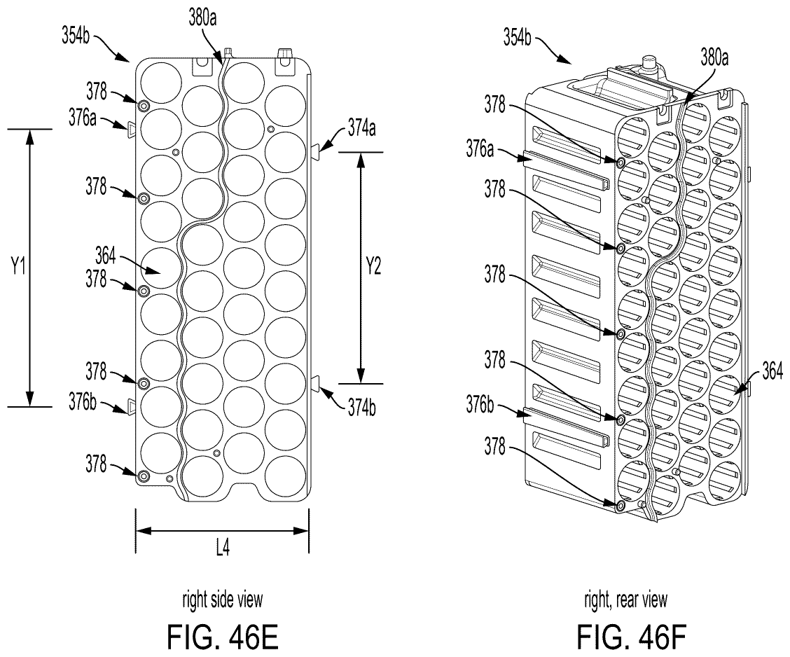

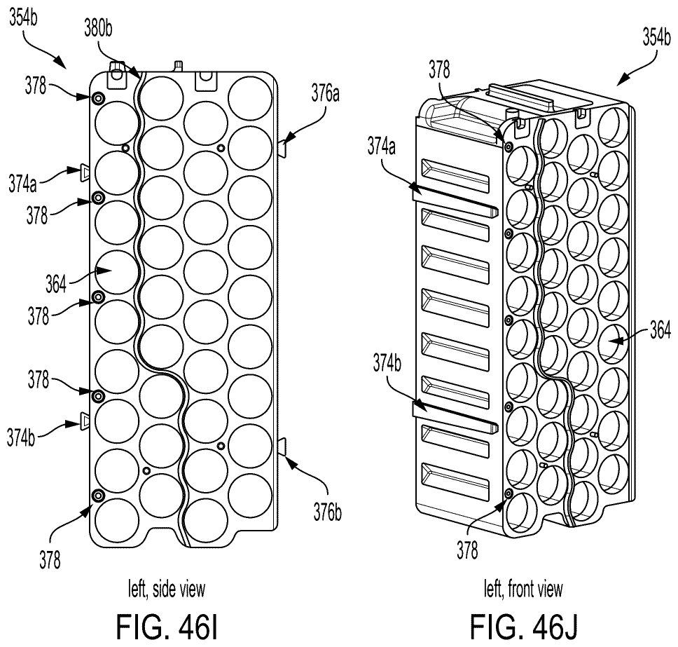

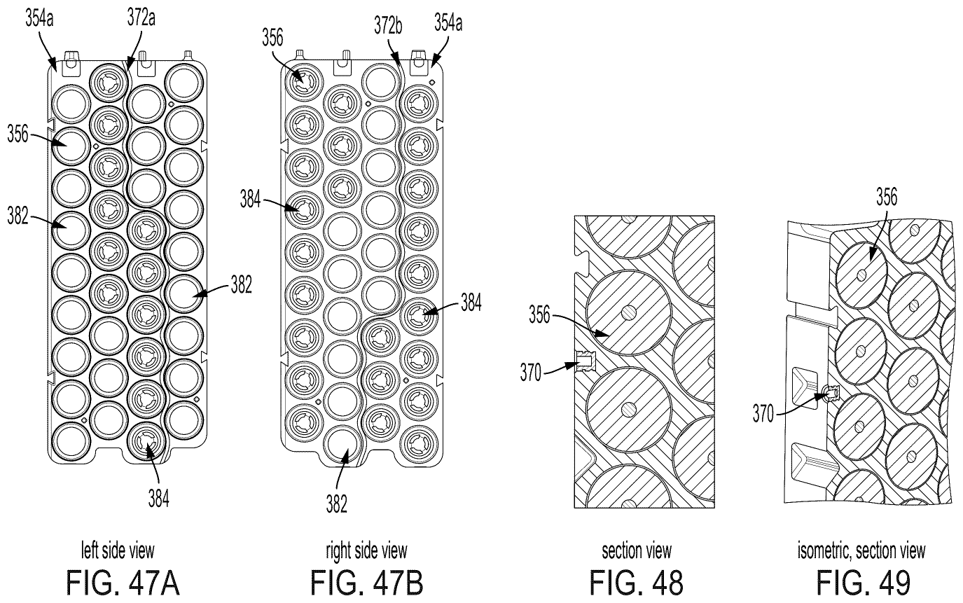

FIGS. 36-40 illustrate various views of the example terminal block assembly mounted on an example printed circuit board (PCB) 320 of the example battery pack 110. This PCB 320 is also referred to as a main PCB. The terminal block standoffs 332 are received in openings in the main PCB 320 to hold the terminal block assembly to the main PCB 320.

The main PCB 320 may have a width dimension W2 and length dimension L2. The width dimension may be approximately equal to a width dimension W3 described in more detail below. The length dimension L2 may be approximately equal to a length of the corepack and approximately equal to the length dimension L3 of a Type A cell holder (described in more detail below) multiplied by the number of Type A cell holders plus the length dimension L4 of a Type B cell holder (described in more detail below) multiplied by the number of Type B cell holders in the corepack 350. In this illustrated example corepack, there are five cell holders three Type A cell holders and two Type B cell holders. As such, the length dimension L2 of the main PCB would be approximately equal to three times the length dimension L3 plus two times the length dimension L4.

The main PCB 320 may include a plurality of electrical and electronic components 336 mounted thereon. These components 336 may include a plurality of transistors. The transistors may be used for a variety of functions including charge overvoltage and discharge undervoltage, overcurrent, and temperature protection and switching. The main PCB 320 may also include one or more microprocessors 338 and/or microcontrollers 340 for monitoring and controlling operation of the battery pack 110 including, but not limited to, charging and discharging the battery cells.

The terminal block connector 328 connects the terminal block 326 to the main PCB 320 to provide signals (potentially both power signals and data signals) from the terminals 324 to the PCB 320 and from PCB 320 to the terminals 324.

The battery pack 110 may also include a plurality of PCB-cell holder connectors 342, described in more detail below.

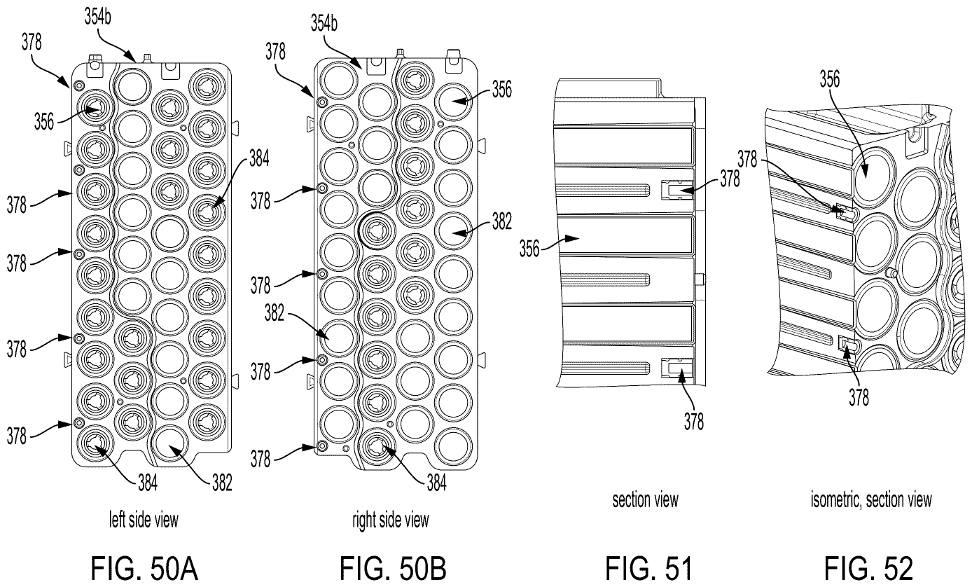

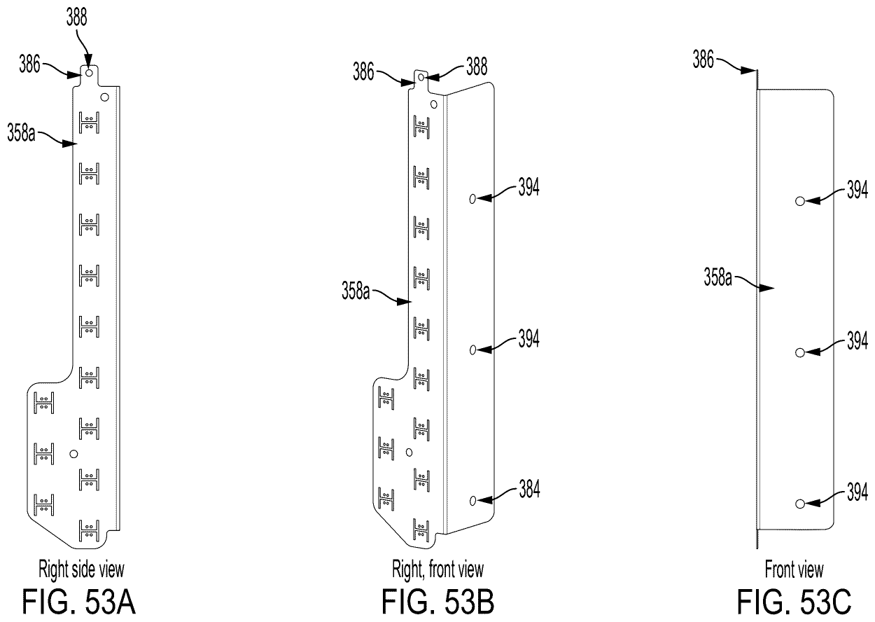

FIGS. 41 and 42 illustrate detail views of the example terminal block assembly mounted on the example PCB 320 and positioned within the top housing 120 of the battery pack 110. As illustrated, the terminal block assembly is received in the internal terminal block cavity 324 of the top housing portion 120.

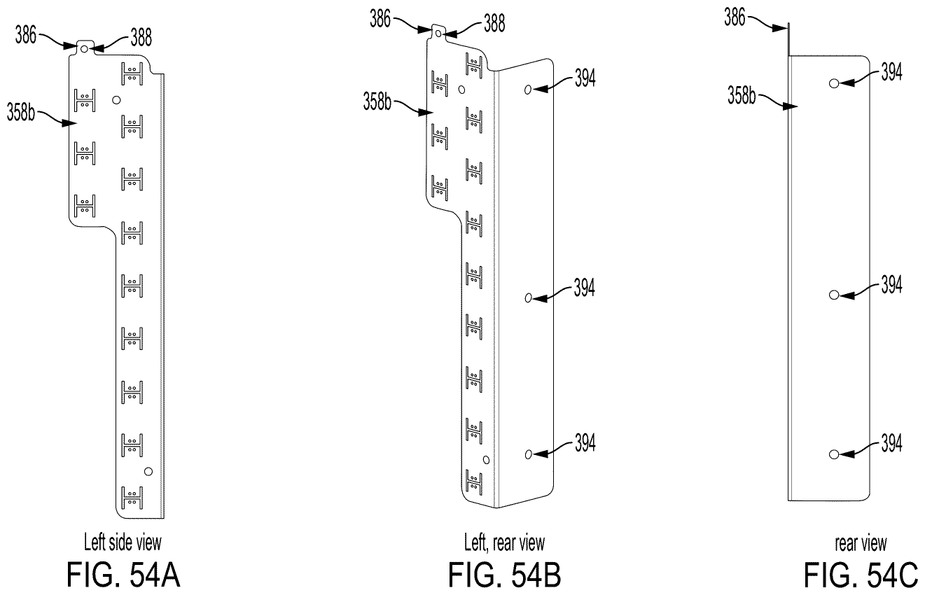

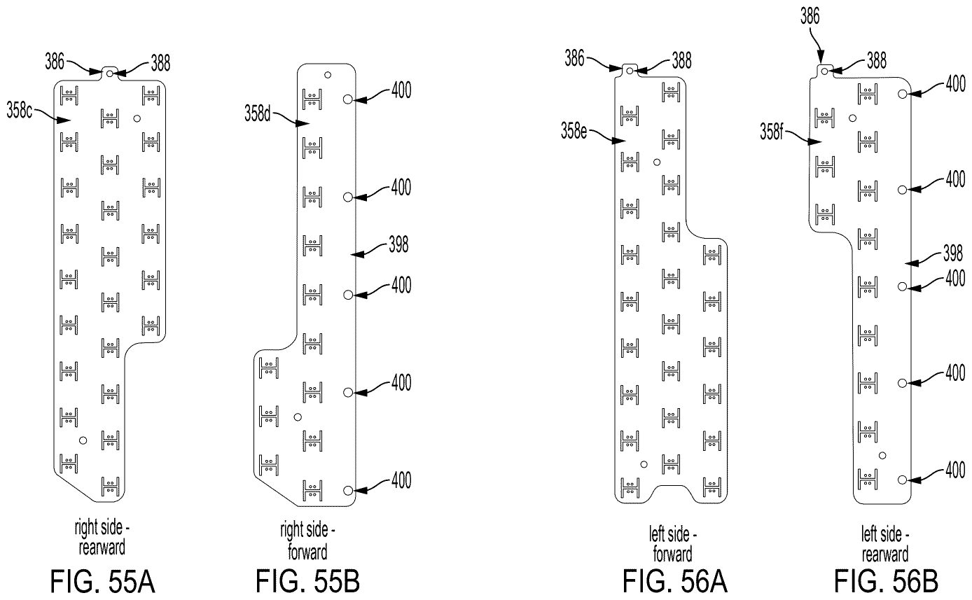

FIGS. 43 and 44 illustrate exploded views of the core pack assembly 350 of the example battery pack 110. In the illustrated example core pack 350, there are five modular cell holder assemblies 352, described in more detail below. Alternate embodiments of the core pack 350 may include more or fewer cell holder assemblies 352. In a preferred embodiment of the core pack 350, there is an odd number of cell holder assemblies 352. The cell holder assembly 352 may include a cell holder 354, a plurality of battery cells 356, and a plurality of battery straps 358 (discussed in more detail below). The core pack 350 may also include a positive busbar 360 that connects the most positive cell holder assembly 352a to the main PCB 320 and a negative busbar 362 that connects the most negative cell holder assembly 352e to the main PCB 320. The charge and the discharge current flows through the positive busbar 360 and the negative busbar 362.

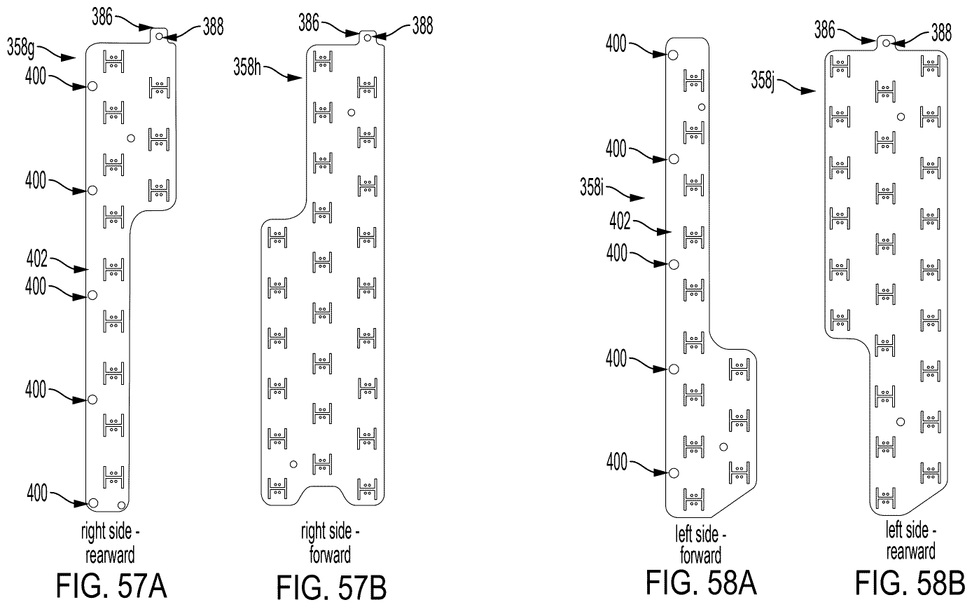

FIGS. 45A-45J illustrate various views of an example of a first type (Type A) of cell holder 354a of the example battery pack 110. The example Type A cell holder 354a may have a width dimension W3, a length dimension L3 and a height dimension H3. An example Type A cell holder 354a may have a width W3 of about 8.7 in to about 9.1 in. Another example Type A cell holder 354a may have a width W3 of approximately 8.9 in. An example Type A cell holder 354a may have a length dimension L3 of about 2.8 in to about 3.2 in. Another example Type A cell holder 354a may have a length dimension L3 of approximately 3.0 in. Another example Type A cell holder 354a may have a height dimension H3 of about 3.2 in to about 3.7 in. Another example Type A cell holder 354a may have a height dimension H3 of approximately 3.5 in. An example Type A cell holder 354a may have a volume V2 of about 77.95 in³ to about 107.74 in³. Another example Type A cell holder 354a may have a volume V2 of approximately 93.45 in³.

As illustrated, the Type A cell holder 354a includes a top side (see FIG. 45A) defined by the width dimension W3 and the length dimension L3 and a bottom side (see FIG. 45B), opposed and generally parallel to the top side, also defined by the width dimension W3 and the length dimension L3. The Type A cell holder 354a also includes a front side (see FIG. 45C) defined by the width dimension W3 and the height dimension H3 and a rear side (see FIG. 45G), opposed and generally parallel to the front side, also defined by the width dimension W3 and the height dimension H3. The Type A cell holder 354a also includes a first (right) side (see FIG. 45E) defined by the length dimension L3 and the height dimension H3 and a second (left) side (see FIG. 45I), opposed and generally parallel to the first (right) side, also defined by length dimension L3 and the height dimension H3.

The Type A cell holder 354a includes a plurality of battery cell cavities 364. The battery cell cavities 364 are generally shaped and configured to receive a cylindrical battery cell 356 in a friction fit manner. The battery cell cavity 364 extends from the first (right) side of the cell holder 354a through the cell holder to the second (left) side of the cell holder 354a. The illustrated example Type A cell holder 354a includes thirty six (36) battery cell cavities 364.

Alternate embodiments may include more or fewer battery cell cavities and are contemplated by the present disclosure. The illustrated example Type A cell holder 354a has the battery cell cavities 364 arranged in four vertical columns (from the perspective of FIGS. 45E and 45I). Alternate embodiments may include more or fewer vertical columns and are contemplated by the present disclosure. The illustrated example Type A cell holder 354a has adjacent columns of battery cell cavities 364 arranged in an offset manner from each other. Alternate embodiments may include a different arrangement of the vertical columns and is contemplated by the present disclosure.

The illustrated example Type A cell holder 354a includes a first pair of negative dovetails 366 formed in the front side (see, for example, FIG. 45C, 45D, 45E, 45I, 45J). In the illustrated example Type A cell holder 354a, the first pair of negative dovetails 366 extend from the first (right) side to the second (left) side of the cell holder 354a. The first pair of negative dovetails 366 on the front side of the Type A cell holder 354a are separated by a dimension X1 (centerline of one negative dovetail 366a to centerline of the other negative dovetail 366b) along the height dimension H3 of the cell holder 354a. The first pair of negative dovetails 366 presents a trapezoidal shape as viewed from the front side of the Type A cell holder 354a. In other words, the first pair of negative dovetails 366 narrow as they extend from the second (left) side to first (right) side (see, for example, FIG. 45C). In alternate embodiments, the first pair of negative dovetails 366 may narrow as they extend from the first (right) side to the second (left) side and are contemplated by the present disclosure.

The illustrated example Type A cell holder 354a includes a second pair of negative dovetails 368 formed in the rear side (see, for example, FIGS. 45E, 45F, 45G, 45H, 45I). In the illustrated example Type A cell holder 354a, the second pair of negative dovetails 368 extend from the first (right) side to the second (left) side of the cell holder 354a. The second pair of negative dovetails 368 on the rear side of the Type A cell holder 354a are separated by a dimension X2 (centerline of one negative dovetail 368a to centerline of the other negative dovetail 368b) along the height dimension H3 of the cell holder 354a. The second pair of negative dovetails 368 presents a trapezoidal shape as viewed from the rear side of the Type A cell holder 354a. In other words, the second pair of negative dovetails 368 narrow as they extend from the first (right) side to second (left) side (see, for example, FIG. 45G). In alternate embodiments, the second pair of negative dovetails 368 may narrow as they extend from the second (left) side to the first (right) side and are contemplated by the present disclosure.

In the illustrated example Type A cell holder 354a, the dimension X1 is greater than the dimension X2. An example Type A cell holder 354a has an X1 dimension from about 142.0 mm to about 143.5 mm. Another example Type A cell holder 354a has an X1 dimension of approximately 142.75 mm. An example Type A cell holder 354a has an X2 dimension from about 118.25 mm to about 119.75 mm. Another example Type A cell holder 354a has an X2 dimension of approximately 119.0 mm. Alternate embodiments may have larger or smaller X1 and/or X2 dimensions and are contemplated by this disclosure. Alternate embodiments may have the dimension X1 equal to the dimension X2 or the dimension X1 less than the dimension X2 and are contemplated by this disclosure.

The illustrated example Type A cell holder 354a includes three cell holder screw holes 370 on the front side and three cell holder screw holes 370 on the rear side. These screw holes 370 receive screws to attach and hold power battery straps 358 to the cell holder 354A (as described in more detail below). Alternate embodiments of the cell holder 354A may include more or few screw holes 370.

The illustrated example Type A cell holder 354a includes a first rib/wall 372a on first (right) side and a second rib/wall 372b on the second (left) side. Each of the ribs/wall 372 extends away from the respective side in a direction away from a center of the cell holder 354a. The rib 372 “snakes” along the respective side between adjacent, offset battery cell cavities 364. The rib/wall 372 will be discussed in further detail below.

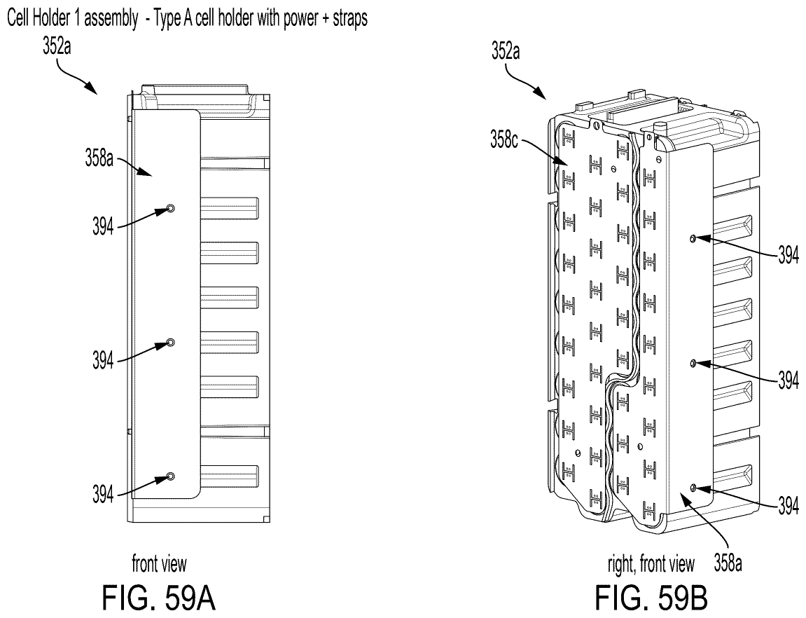

FIGS. 46A-46J illustrate various views of an example of a second type (Type B) of cell holder 354b of the example battery pack 110. The example Type B cell holder 354b may have a width dimension W4, a length dimension L4 and a height dimension H4. An example Type B cell holder 354b may have a width W4 of about 8.7 in to about 9.1 in. Another example Type B cell holder 354b may have a width W4 of approximately 8.9 in. An example Type B cell holder 354b may have a length dimension L4 of about 2.8 in to about 3.2 in. Another example Type B cell holder 354b may have a length dimension L4 of approximately 3.0 in. Another example Type B cell holder 354b may have a height dimension H4 of about 3.2 in to about 3.7 in. Another example Type B cell holder 354b may have a height dimension H4 of approximately 3.5 in. An example Type B cell holder 354b may have a volume V3 of about 77.95 in³ to about 107.74 in³. Another example Type B cell holder 354b may have a volume V3 of approximately 93.45 in³.

As illustrated, the Type B cell holder 354b includes a top side (see FIG. 46A) defined by the width dimension W4 and the length dimension L4 and a bottom side (see FIG. 46B), opposed and generally parallel to the top side, also defined by the width dimension W4 and the length dimension L4. The Type B cell holder 354b also includes a front side (see FIG. 46C) defined by the width dimension W4 and the height dimension H4 and a rear side (see FIG. 46G), opposed and generally parallel to the front side, also defined by the width dimension W4 and the height dimension H4. The Type B cell holder 354b also includes a first (right) side (see FIG. 46E) defined by the length dimension L4 and the height dimension H4 and a second (left) side (see FIG. 46I), opposed and generally parallel to the first (right) side, also defined by length dimension L4 and the height dimension H4.

The Type B cell holder 354b includes a plurality of battery cell cavities 364. The battery cell cavities 364 are generally shaped and configured to receive a cylindrical battery cell 356 in a friction fit manner. The battery cell cavity 364 extends from the first (right) side of the cell holder 354b through the cell holder to the second (left) side of the cell holder 354b. The illustrated example Type B cell holder 354b includes thirty six (36) battery cell cavities 364. Alternate embodiments may include more or fewer battery cell cavities 364 and are contemplated by the present disclosure. The illustrated example Type B cell holder 354b has the battery cell cavities 364 arranged in four vertical columns (from the perspective of FIGS. 46E and 46I). Alternate embodiments may include more or fewer vertical columns and are contemplated by the present disclosure. The illustrated example Type B cell holder 354 has adjacent columns of battery cell cavities 364 arranged in an offset manner from each other. Alternate embodiments may include a different arrangement of the vertical columns and is contemplated by the present disclosure.

The illustrated example Type B cell holder includes a first pair of positive dovetails 374 formed on the front side (see, for example, FIGS. 46C, 46D, 46E, 46I, 46J). In the illustrated example Type B cell holder 354b, while the first pair of positive dovetails 374 extend from the first (right) side to the second (left) side of the cell holder 354b they do not extend all the way to the first side and the second side. In other words, the first pair of positive dovetails 374 has a width less than the width W4 of the Type B cell holder 354b. The first pair of positive dovetails 374 on the front side of the Type B cell holder 354b are separated by a dimension Y2 (centerline of one positive dovetail 374a to centerline of the other positive dovetail 374b) along the height dimension H4 of the cell holder 354b. The first pair of positive dovetails 374 presents a trapezoidal shape as viewed from the front side of the Type B cell holder 354b. In other words, the first pair of positive dovetails 374 narrow as they extend from the first (right) side to second (left) side (see, for example, FIG. 46C). In alternate embodiments, the first pair of positive dovetails 374 may narrow as they extend from the second (left) side to the first (right) side and are contemplated by the present disclosure.

The illustrated example Type B cell holder 354b includes a second pair of positive dovetails 376 formed on the rear side (see, for example, FIGS. 46E, 46F, 46G, 46H, 46I). In the illustrated example Type B cell holder 354b, while the second pair of positive dovetails 376 extend from the second (left) side to the first (right) side of the cell holder 354b they do not extend all the way to the first side and the second side. In other words, the second pair of positive dovetails 376 has a width less than the width W4 of the Type B cell holder 354b. The second pair of positive dovetails 376 on the rear side of the Type B cell holder 354b are separated by a dimension Y1 (centerline of one positive dovetail 376a to centerline of the other positive dovetail 376b) along the height dimension H4 of the cell holder 354b. The second pair of positive dovetails 376 presents a trapezoidal shape as viewed from the rear side of the Type B cell holder 354b. In other words, the second pair of positive dovetails 376 narrow as they extend from the second (left) side to first (right) side (see, for example, FIG. 46G). In alternate embodiments, the second pair of positive dovetails 376 may narrow as they extend from the first (right) side to the second (left) side and are contemplated by the present disclosure.

In the illustrated example Type B cell holder 354b, the dimension Y1 is greater than the dimension Y2. An example Type B cell holder 354b has an Y1 dimension from about 142.0 mm to about 143.5 mm. Another example Type B cell holder 354b has an Y1 dimension of approximately 142.75 mm. An example Type B cell holder 354b has an Y2 dimension from about 118.25 mm to about 119.75 mm. Another example Type B cell holder 354b has an Y2 dimension of approximately 119.0 mm. Alternate embodiments may have larger or smaller Y1 and/or Y2 dimensions and are contemplated by this disclosure. Alternate embodiments may have the dimension Y1 equal to the dimension Y2 or the dimension Y1 less than the dimension Y2 and are contemplated by this disclosure.

The illustrated example Type B cell holder 354b includes five cell holder screw holes 378 on the first (right) side and five cell holder screw holes 378 on the second (left) side. These screw holes 378 receive screws to attach and hold power battery straps 358 to the cell holder 354b (as described in more detail below). Alternate embodiments of the cell holder 354b may include more or few screw holes 378.

The illustrated example Type B cell holder 354b includes a first rib/wall 380a on first (right) side and a second rib/wall 380b on the second (left) side. Each of the ribs/wall 380 extends away from the respective side in a direction away from a center of the cell holder 354b. The rib 380 “snakes” along the respective side between adjacent, offset battery cell cavities 364. The rib/wall 380 will be discussed in further detail below.

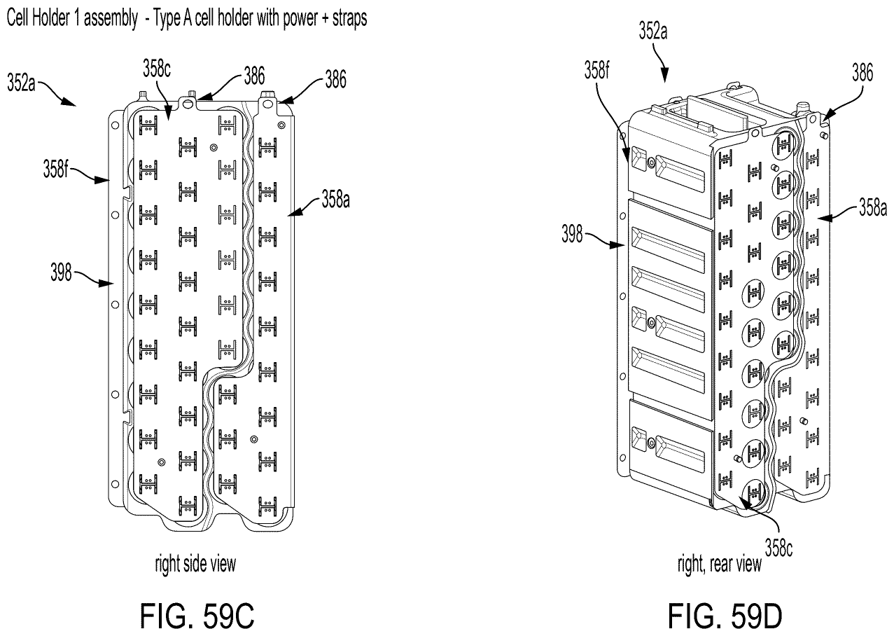

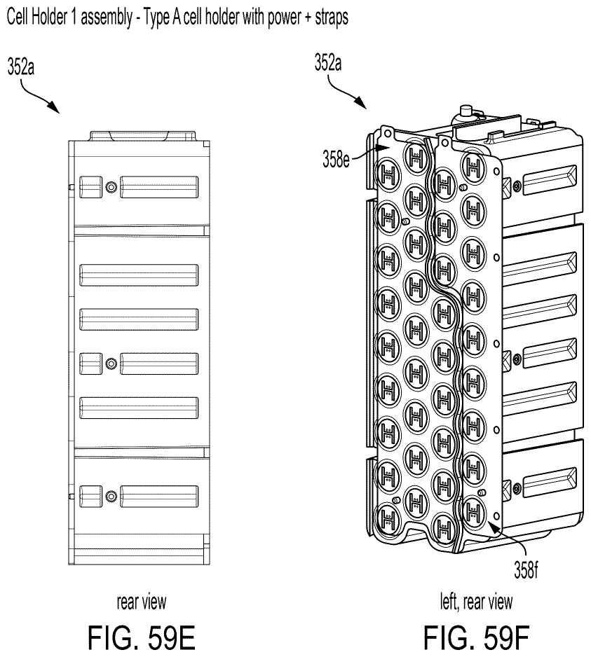

FIGS. 47A, 47B, 48 and 49 illustrate various views of the Type A cell holder 354a including a plurality (or set) of battery cells 356. As illustrated, in an example embodiment, the plurality of battery cells 356 are housed or positioned in the battery cell cavities 364. The battery cells 356 extend from a first (right) side to a second (left) side of the battery cell holder 354a. The plurality of battery cells 356 housed in the Type A cell holder 354a may include a first group (subset) of battery cells in which an anode 382 of the first group of battery cells 356 is exposed on the left side of the Type A cell holder 354a and a cathode 384 of the first group of battery cells 356 is exposed on the right side of the Type A cell holder 354a, a second group (subset) of battery cells, adjacent to the first group of battery cells, in which an anode 382 of the second group of battery cells is exposed on the right side of the Type A cell holder 354a and a cathode 384 of the second group of battery cells is exposed on the left side of the Type A cell holder 354a and a third group (subset) of battery cells, adjacent to the second group of battery cells, in which an anode 382 of the third group of battery cells is exposed on the left side of the Type A cell holder 354a and a cathode 384 of the third group of battery cells is exposed on the right side of the Type A cell holder 354a. In this example configuration, the first group of battery cells is generally positioned towards the front of the Type A cell holder 354a, the second group of battery cells is generally positioned in the middle of the Type A cell holder 35a and the third group of battery cells is generally positioned towards the rear of the Type A cell holder 354a.

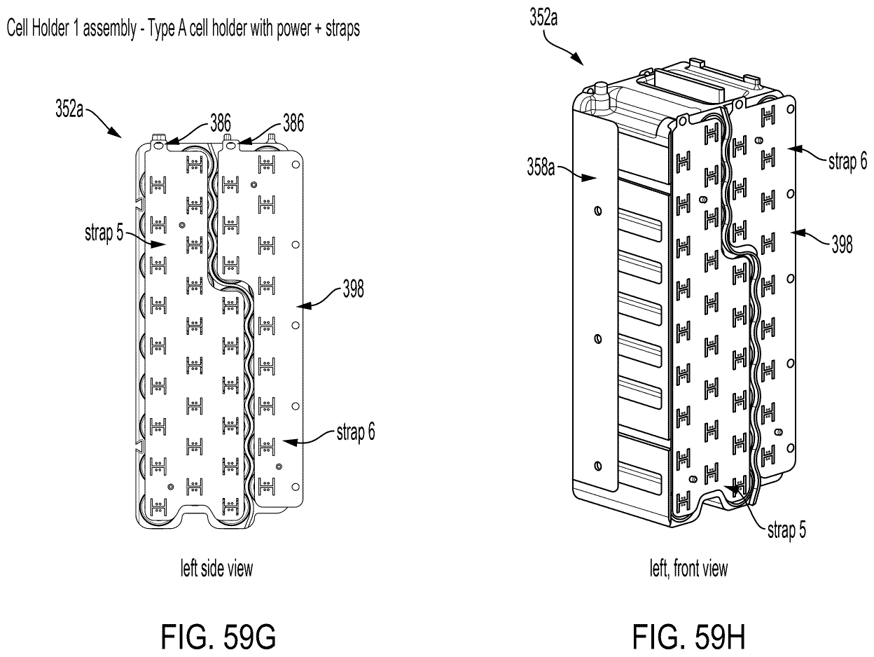

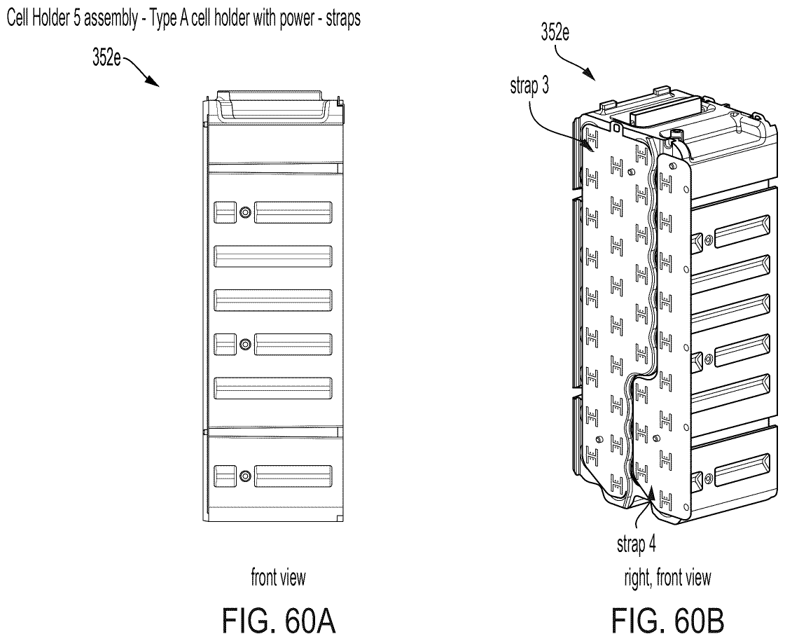

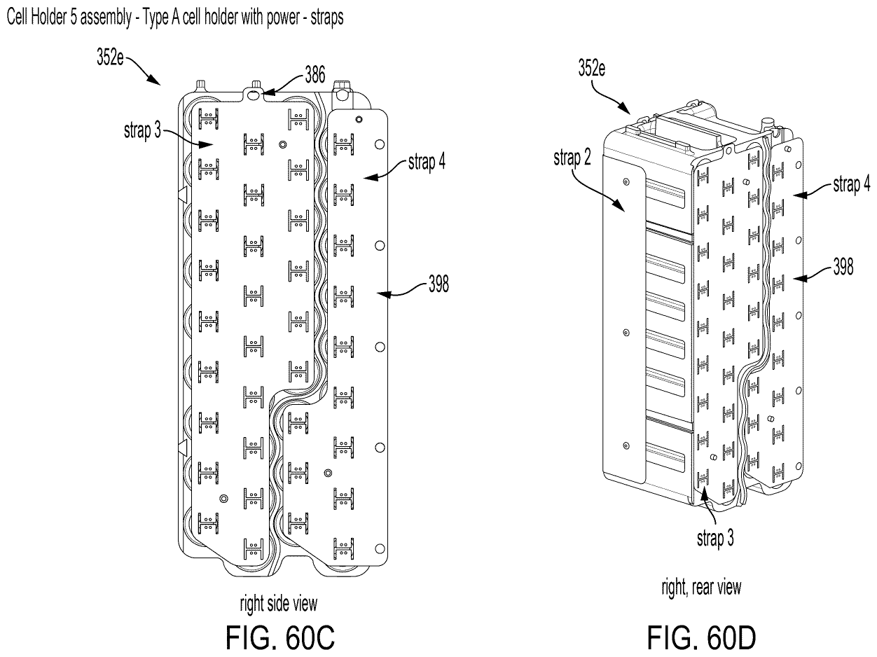

FIGS. 50A, 50B, 51 and 52 illustrate various views of the Type B cell holder 354b including a plurality of battery cells 356. As illustrated, in an example embodiment, the plurality of battery cells 356 are housed or positioned in the battery cell cavities 364. The battery cells 356 extend from a first (right) side to a second (left) side of the battery cell holder 354b. The plurality of battery cells 356 housed in the Type B cell holder 354b may include a first group (subset) of battery cells in which a cathode 384 of the battery cells 356 is exposed on the left side of the Type B cell holder 354b and an anode 382 is exposed on the right side of the Type B cell holder 354b, a second group (subset) of battery cells, adjacent to the first group of battery cells, in which a cathode 384 of the battery cells 356 is exposed on the right side of the Type B cell holder 354b and an anode 382 is exposed on the left side of the Type B cell holder 354b and a third group (subset) of battery cells, adjacent to the second group of battery cells, in which a cathode 384 of the battery cells 356 is exposed on the left side of the Type B cell holder 354b and an anode 382 is exposed on the right side of the Type B cell holder 354b. In this example configuration, the first group of battery cells is generally positioned towards the front of the Type B cell holder 354b, the second group of battery cells is generally positioned in the middle of the Type B cell holder 354b and the third group of battery cells is generally positioned towards the rear of the Type B cell holder 354b.

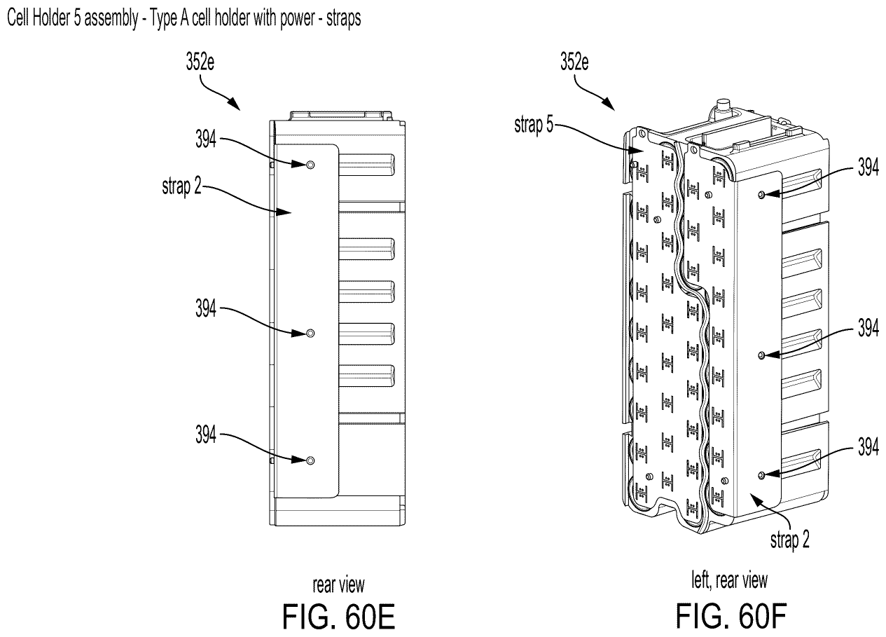

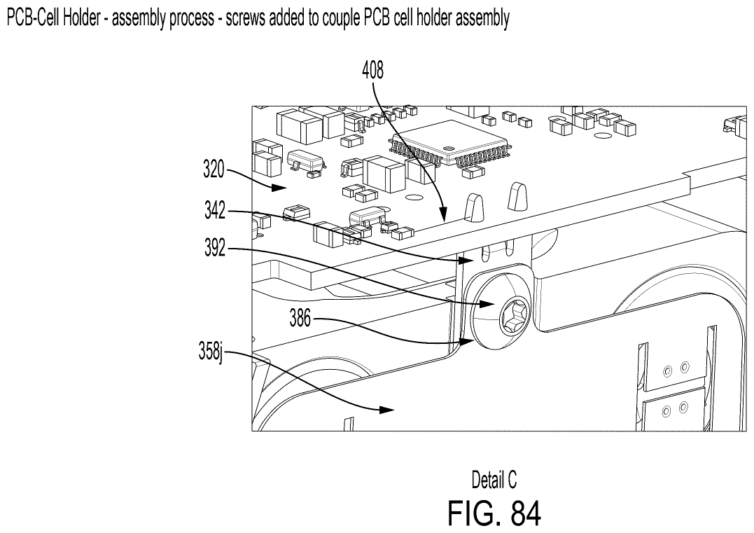

FIGS. 53-58 illustrate various example battery straps 358 of the example battery pack 110. FIGS. 53A, 53B, and 53C illustrate an example 1^{st} battery strap 358a. The example first battery strap 358a may be a positive power battery strap. The positive power battery strap 358a is coupled to the most positive battery cells of the plurality of battery cells (see FIG. 86). The first battery strap 358a may include a strap extension 386 at one end (a top end) of the battery strap 358a. The strap extension 386 may include a PCB-strap screw hole 388. The strap extension 386 is configured to align with a PCB-cell holder connector 342, described in more detail below, such that the PCB-strap screw hole 388 aligns with a PCB-cell holder connector screw hole 390, in order to receive a fastening screw 392 through both the PCB-strap screw hole 388 and the PCB-cell holder connector screw hole 390 to mechanically and electrically couple the battery strap 358 to the main PCB 320. The example first battery strap 358a may also include a plurality of strap-cell holder screw holes 394. The strap-cell holder screw holes 394 are configured to align with the plurality of respective screw holes in the Type A cell holder 370, in order to receive a fastening screw 396 to mechanically fasten the battery strap 358a to the cell holder 354a.

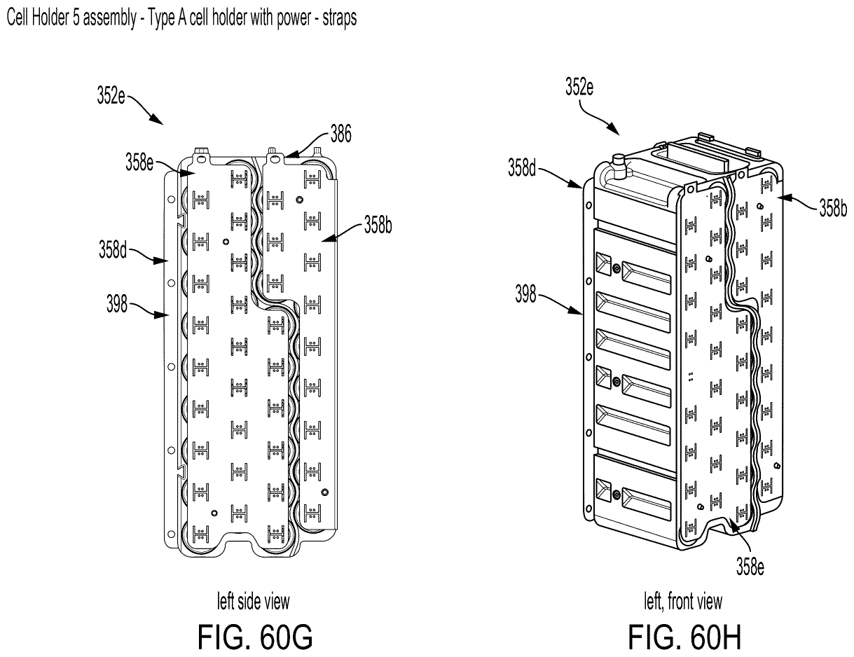

FIGS. 54A, 54B, and 54C illustrate an example 2^{nd} battery strap 358b. The example second battery strap 358b may be a negative power battery strap. The negative power battery strap 358b is coupled to the most negative battery cells of the plurality of battery cells (see FIG. 86). The second battery strap 358b may include a strap extension 386 at one end (a top end) of the battery strap 358b. The strap extension 386 may include a PCB-strap screw hole 388. The strap extension 386 is configured to align with a PCB-cell holder connector 342, described in more detail below, such that the PCB-strap screw hole 388 aligns with the PCB-cell holder connector screw hole 390, in order to receive a fastening screw 392 through both the PCB-strap screw hole 388 and the PCB-cell holder connector screw hole 390 to mechanically and electrically couple the battery strap 358b to the PCB-cell holder connector 342 and in turn electrically couple the battery strap 358b to the main PCB 320. The example second battery strap 358b may also include a plurality of strap-cell holder screw holes 394. The strap-cell holder screw holes 394 are configured to align with a plurality of respective screw holes 370 in the Type A cell holder 354a, in order to receive a fastening screw 396 to mechanically fasten the battery strap 358b to the cell holder 354a.

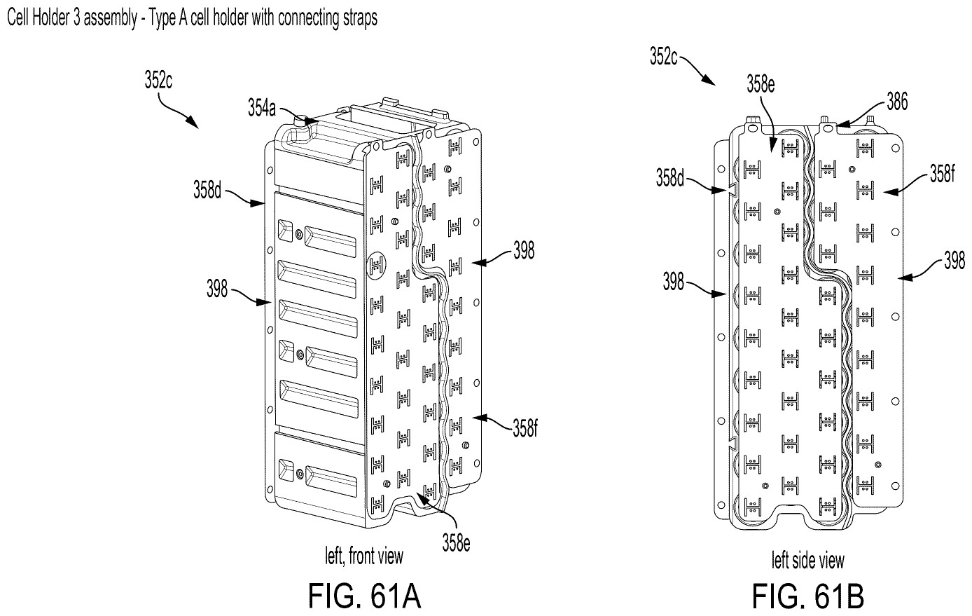

FIG. 55A illustrates an example 3^{rd} battery strap 358c. The example third battery strap 358c may be a connecting strap. The third battery strap 358c is coupled to a plurality of battery cells 356 (see FIG. 86). The third battery strap 358c may include a strap extension 386 at one end (a top end) of the battery strap 358c. The strap extension 386 may include a PCB-strap screw hole 388. The strap extension 386 is configured to align with a PCB-cell holder connector 342, described in more detail below, such that the PCB-strap screw hole 388 aligns with the PCB-cell holder connector screw hole 390, in order to receive a fastening screw 392 through both the PCB-strap screw hole 388 and the PCB-cell holder connector screw hole 390 to mechanically and electrically couple the battery strap 358c to the PCB-cell holder connector 342 and in turn electrically couple the battery strap 358c to the main PCB 320.

FIG. 55B illustrates an example 4^{th} battery strap 358d. The example fourth battery strap 358d may be a connecting strap. The fourth battery strap 358d is coupled to a plurality of battery cells 356 (see FIG. 86). The fourth battery strap 358d may include an overlapping region 398 at a front side of the battery strap 358d. The overlapping region 398 may include a plurality of strap-strap screw holes 400. The overlapping region 398 is configured to align with an overlapped region 402 of an adjacent battery strap 358g, described in more detail below, such that the strap-strap screw holes 400 of the fourth battery strap 358d align with another plurality of corresponding strap-strap screw holes 400 of the adjacent battery strap 358g, in order to receive a strap-strap fastening screw 404 through the strap-strap screw holes 400 of the fourth battery strap 358d and the strap-strap screw holes 400 of the adjacent battery strap 358g to mechanically and electrically couple the battery strap 358d to the adjacent battery strap 358g. The strap-strap fastening screws 404 are also received in corresponding cell holder screw holes 378 to affix the fourth battery strap 358d and the seventh battery strap 358g to the Type B cell holder 354b.

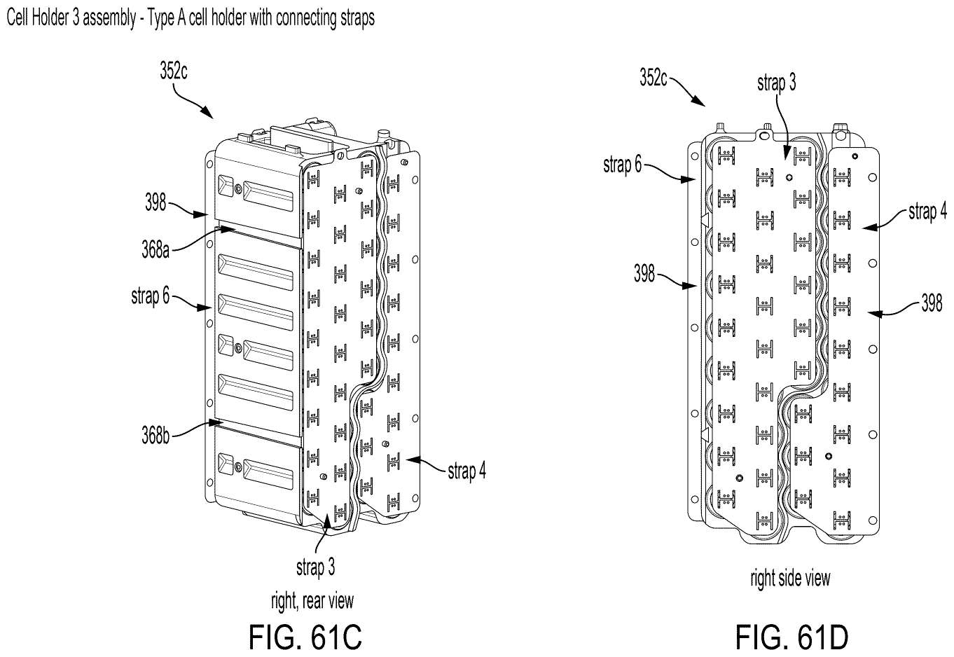

FIG. 56A illustrates an example 5^{th} battery strap 358e. The example fifth battery strap 358e may be a connecting strap. The fifth battery strap 358e is coupled to a plurality of battery cells 356 (see FIG. 86). The fifth battery strap 358e may include a strap extension 386 at one end (a top end) of the battery strap 358e. The strap extension 386 may include a PCB-strap screw hole 388. The strap extension 386 is configured to align with a PCB-cell holder connector 342, described in more detail below, such that the PCB-strap screw hole 388 aligns with the PCB-cell holder connector screw hole 390, in order to receive a fastening screw 392 through both the PCB-strap screw hole 388 and the PCB-cell holder connector screw hole 390 to mechanically and electrically couple the battery strap 358e to the PCB-cell holder connector 342 and in turn electrically couple the battery strap 358e to the main PCB 320.

FIG. 56B illustrates an example 6^{th} battery strap 358f. The example sixth battery strap 358f may be a connecting strap. The sixth battery strap 358f is coupled to a plurality of battery cells 356 (see FIG. 86). The sixth battery strap 358f may include a strap extension 386 at one end (a top end) of the battery strap 358f. The strap extension 386 may include a PCB-strap screw hole 388. The strap extension 386 is configured to align with a PCB-cell holder connector 342, described in more detail below, such that the PCB-strap screw hole 388 aligns with the PCB-cell holder connector screw hole 390, in order to receive a fastening screw 392 through both the PCB-strap screw hole 388 and the PCB-cell holder connector screw hole 390 to mechanically and electrically couple the battery strap 358f to the PCB-cell holder connector 342 and in turn electrically couple the battery strap 358f to the main PCB 320. The sixth battery strap 358f may include an overlapping region 398 at a rear side of the battery strap 358f. The overlapping region 398 may include a plurality of strap-strap screw holes 400. The overlapping region 398 is configured to align with an overlapped region 402 of an adjacent battery strap 358i, described in more detail below, such that the strap-strap screw holes 400 of the sixth battery strap 358f align with another plurality of corresponding strap-strap screw holes 400 of the adjacent battery strap 358i, in order to receive a strap-strap fastening screw 404 through both the strap-strap screw holes 400 of the sixth battery strap 358f and the strap-strap holes 400 of the ninth battery strap 358i to mechanically and electrically couple the battery strap 358f to the adjacent battery strap 358i. The strap-strap fastening screw 404 is also received in corresponding cell holder screw holes 378 to affix the sixth battery strap 358f and the ninth battery strap 358i to the Type B cell holder 354b.

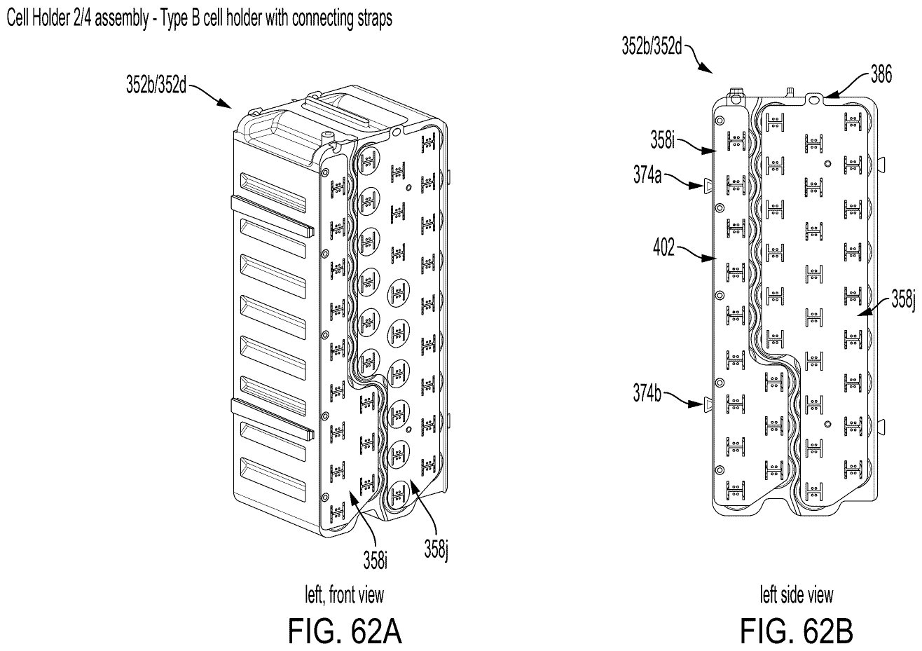

FIG. 57A illustrates an example 7^{th} battery strap 358g. The example seventh battery strap 358g may be a connecting strap. The seventh battery strap 358g is coupled to a plurality of battery cells 356 (see FIG. 86). The seventh battery strap 358g may include a strap extension 386 at one end (a top end) of the battery strap 358g. The strap extension 386 may include a PCB-strap screw hole 388. The strap extension 386 is configured to align with a PCB-cell holder connector 342, described in more detail below, such that the PCB-strap screw hole 388 aligns with the PCB-cell holder connector screw hole 390, in order to receive a fastening screw 392 through both the PCB-strap screw hole 388 and the PCB-cell holder connector screw hole 390 to mechanically and electrically couple the battery strap 358g to the PCB-cell holder connector 342 and in turn electrically couple the battery strap 358g to the main PCB 320. The seventh battery strap 358g may include an overlapped region 402 at a rear side of the battery strap 358g. The overlapped region 402 may include a plurality of strap-strap screw holes 400. The overlapped region 402 is configured to align with an overlapping region 398 of an adjacent battery strap 358d, described in more detail below, such that the strap-strap screw holes 400 of the seventh battery strap 358g align with another plurality of corresponding strap-strap screw holes 400 of the adjacent battery strap 358d, in order to receive a fastening screw 404 through both the strap-strap screw holes 400 of the seventh battery strap 358g and the strap-strap holes 400 of the fourth battery strap 358d to mechanically and electrically couple the seventh battery strap 358g to the adjacent battery strap 358d. The strap-strap fastening screws 404 are also received in corresponding cell holder screw holes 378 to affix the seventh battery strap 358g and the fourth battery strap 358d to the Type B cell holder 354b.

FIG. 57B illustrates an example 8^{th} battery strap 358h. The example eighth battery strap 358h may be a connecting strap. The eighth battery strap 358h is coupled to a plurality of battery cells 356 (see FIG. 86). The eighth battery strap 358h may include a strap extension 386 at one end (a top end) of the battery strap 358h. The strap extension 386 may include a PCB-strap screw hole 388. The strap extension 386 is configured to align with a PCB-cell holder connector 342, described in more detail below, such that the PCB-strap screw hole 388 aligns with the PCB-cell holder connector screw hole 390, in order to receive a fastening screw 392 through both the PCB-strap screw hole 388 and the PCB-cell holder connector screw hole 390 to mechanically and electrically couple the battery strap 358h to the PCB-cell holder connector 342 and in turn electrically couple the battery strap 358e to the main PCB 320.

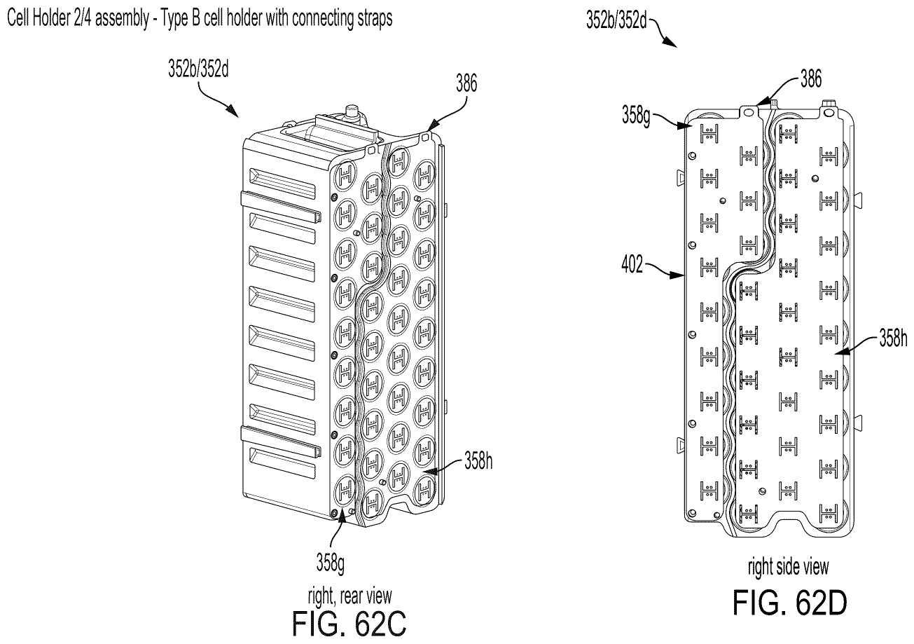

FIG. 58A illustrates an example 9^{th} battery strap 358i. The example ninth battery strap 358i may be a connecting strap. The ninth battery strap 358i is coupled to a plurality of battery cells 356 (see FIG. 86). The ninth battery strap 358i may include an overlapped region 402 at a front side of the battery strap 358i. The overlapped region 402 may include a plurality of strap-strap screw holes 400. The overlapped region 402 is configured to align with an overlapping region 398 of an adjacent battery strap 358f, described in more detail below, such that the strap-strap screw holes 400 of the ninth battery strap 358i align with another plurality of corresponding strap-strap screw holes 400 of the adjacent battery strap 358f, in order to receive a fastening screw 404 through both the strap-strap screw holes 400 of the ninth battery strap 358i and the strap-strap holes 400 of the sixth battery strap 358f to mechanically and electrically couple the ninth battery strap 358i to the adjacent battery strap 358f. The strap-strap fastening screws 404 are also received in corresponding cell holder screw holes 378 to affix the sixth battery strap 358f and the ninth battery strap 358i to the Type B cell holder 354b.

FIG. 58B illustrates an example 10^{th} battery strap 358j. The example tenth battery strap 358j may be a connecting strap. The tenth battery strap 358j is coupled to a plurality of battery cells 356 (see FIG. 86). The tenth battery strap 358j may include a strap extension 386 at one end (a top end) of the battery strap 358j. The strap extension 386 may include a PCB-strap screw hole 388. The strap extension 386 is configured to align with a PCB-cell holder connector 342, described in more detail below, such that the PCB-strap screw hole 388 aligns with the PCB-cell holder connector screw hole 390, in order to receive a fastening screw 392 through both the PCB-strap screw hole 388 and the PCB-cell holder connector screw hole 390 to mechanically and electrically couple the battery strap 358j to the PCB-cell holder connector 342 and in turn electrically couple the battery strap 358j to the main PCB 320.

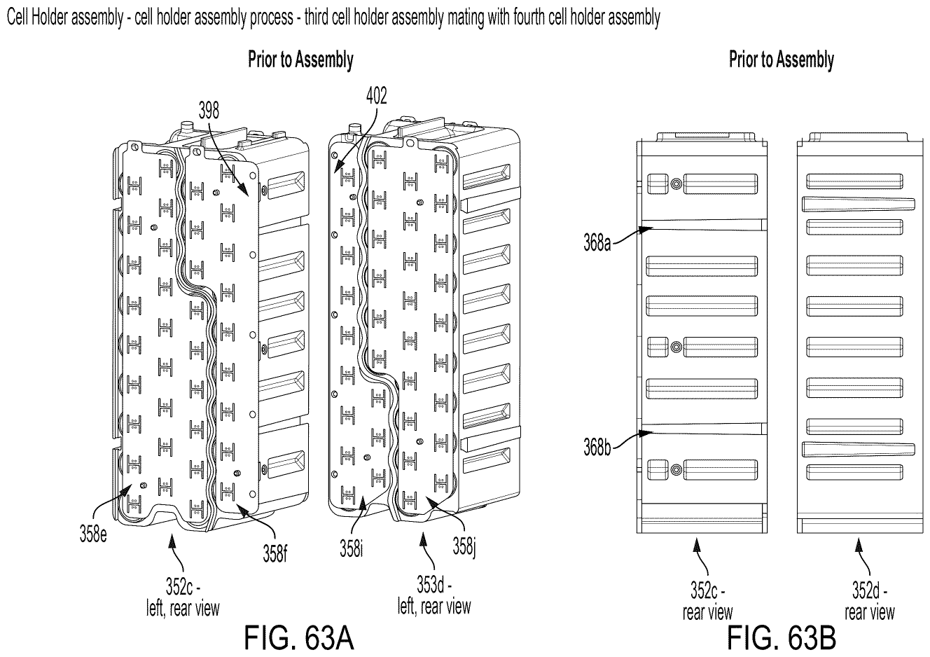

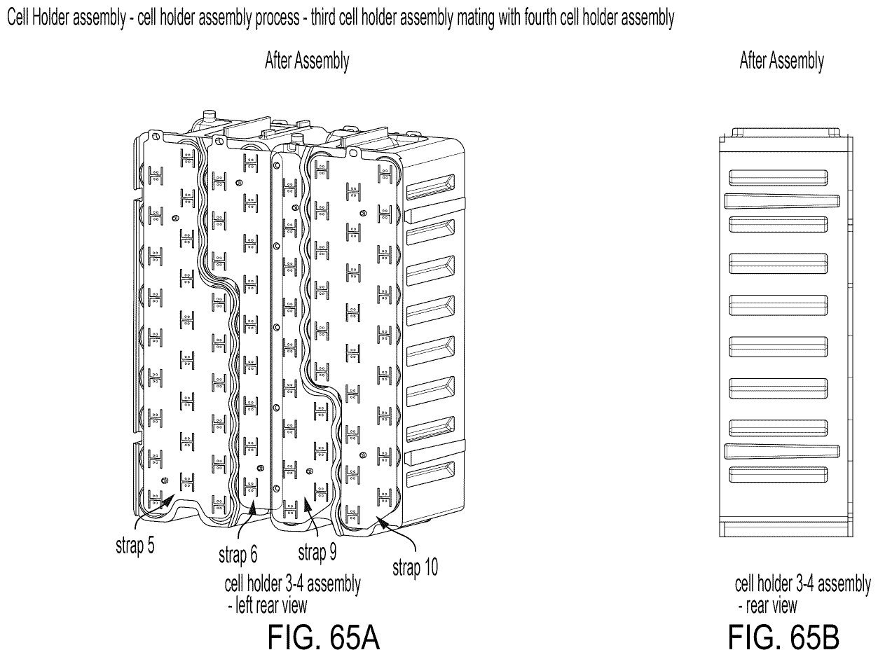

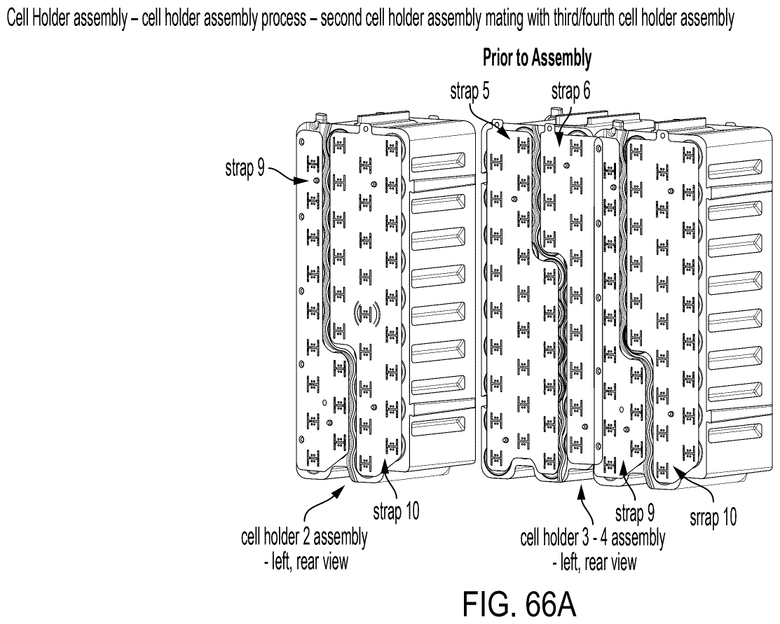

FIGS. 59-62 illustrate the example battery straps 358 assembled to the example cell holders 354 to create cell holder assemblies 352.

FIGS. 59A-59H illustrate a first cell holder assembly 352a. In the example embodiment, the first cell holder assembly 352a is configured to be the most positive cell holder assembly in the battery pack 110. As such, the first cell holder assembly 352a includes a first type (Type A) of cell holder 354a, a positive power battery strap 358a and a set of connection battery straps 358c, 358e, and 358f.

A first battery strap 358a is placed at a forward area of a right side of the first type cell holder 354a. The first battery strap 358a wraps around a front, right corner of the cell holder 354a such that the strap-cell holder screw holes 394 align with the cell holder screw holes 370. Another battery strap—the third battery strap 358c—is placed at a rearward area of the right side of the first type cell holder 354a. Another battery strap—the fifth battery strap 358e—is placed at a forward area of the left side of the first type of cell holder 354a. Another battery strap—the sixth battery strap 358f—is placed at a rearward area of the left side of the first type of cell holder 354a.

Each of the battery straps 358 are connected to a plurality of battery cells 356, thereby placing all of the cells connected to a battery strap at the same potential. As is illustrated in FIGS. 59B, 59C and 59D, a rib 380 extends along the right side (in the height dimension) and from the right side (in the width dimension) of the cell holder 354a between the first battery strap 358a and the third battery strap 358c. As such, the rib 380 provides additional physical separation between battery straps of different electrical potential. As illustrated in FIGS. 59F, 59G, 59H, a rib 380 extends along the left side (in the height dimension) and from the right side (in the width dimension) of the cell holder 354a between the fifth battery strap 358e and the sixth battery strap 358f. As such, the rib 380 provides additional physical separation between battery straps of different electrical potential. This helps to prevent electrical arcing between battery straps 358.

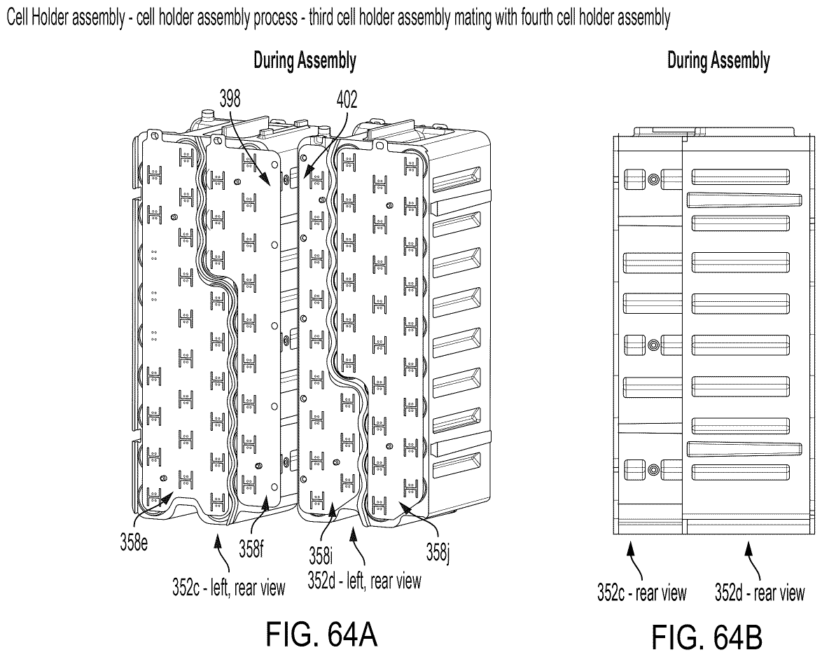

FIGS. 60A-60H illustrate a fifth cell holder assembly 352e. In the example embodiment, the fifth cell holder assembly 352e is configured to be the most negative cell holder assembly in the battery pack 110. As such, the fifth cell holder assembly 352e includes a first type (Type A) of cell holder 354a, a negative power battery strap 358b and a set of connection battery straps 358c, 358d, and 358e.

A second battery strap 358b is placed at a rearward area of a left side of the first type cell holder 354a. The second battery strap 358b wraps around a rear, left corner of the cell holder 354a such that the strap-cell holder screw holes 394 align with the cell holder screw holes 370. Another battery strap—the fifth battery strap 358e—is place at a forward area of the left side of the first type cell holder 354a. Another battery strap—the fourth battery strap 358d—is place at a forward area of the right side of the first type of cell holder 354a. Another battery strap—the third battery strap 358c—is placed at a rearward area of the right side of the first type of cell holder 354a.

Each of the battery straps 358 are connected to a plurality of battery cells 356, thereby placing all of the cells connected to a battery strap at the same potential. As is illustrated in FIGS. 60B, 60C and 60D, a rib 380 extends along the right side (in the height dimension) and from the right side (in the width dimension) of the cell holder 354a between the fourth battery strap 358d and the third battery strap 358c. As such, the rib 380 provides additional physical separation between battery straps of different electrical potential. As illustrated in FIGS. 60F, 60G, 60H, a rib 380 extends along the left side (in the height dimension) and from the right side (in the width dimension) of the cell holder 354a between the second battery strap 358b and the fourth battery strap 358d. As such, the rib 380 provides additional physical separation between battery straps of different electrical potential. This helps to prevent electrical arcing between battery straps 358.

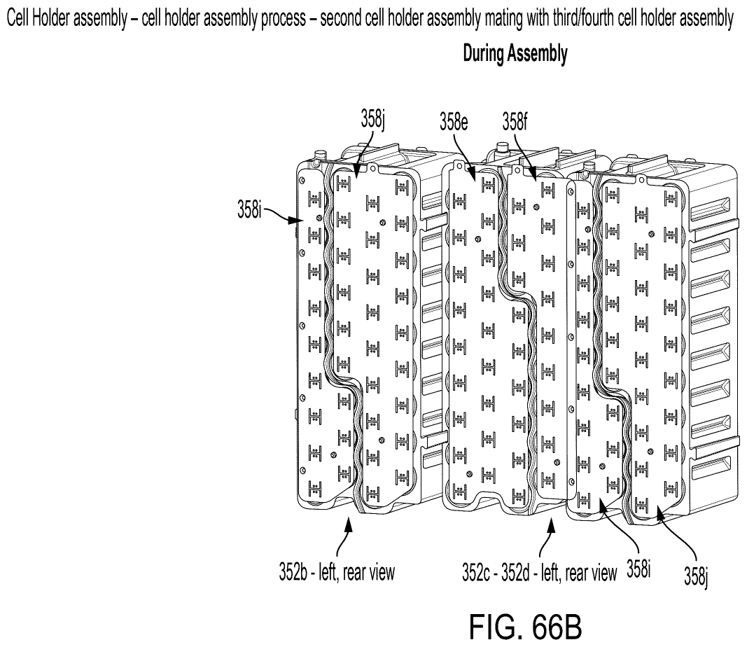

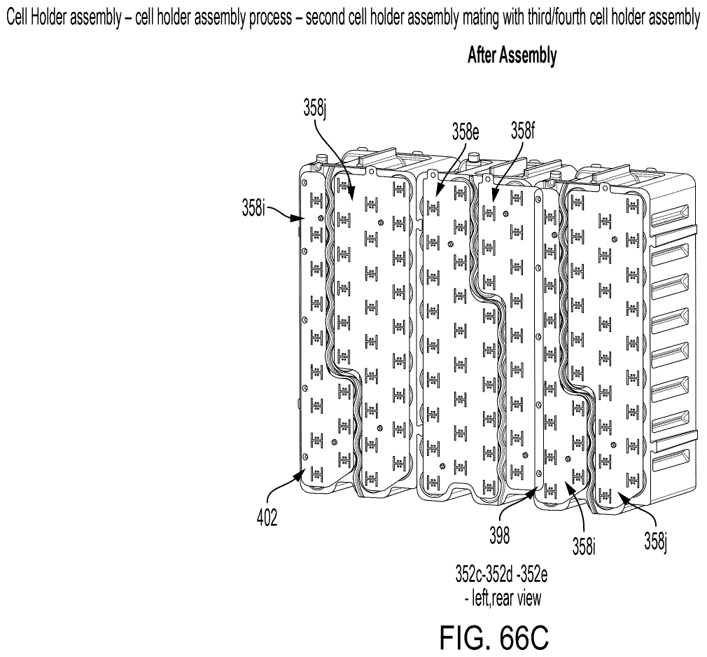

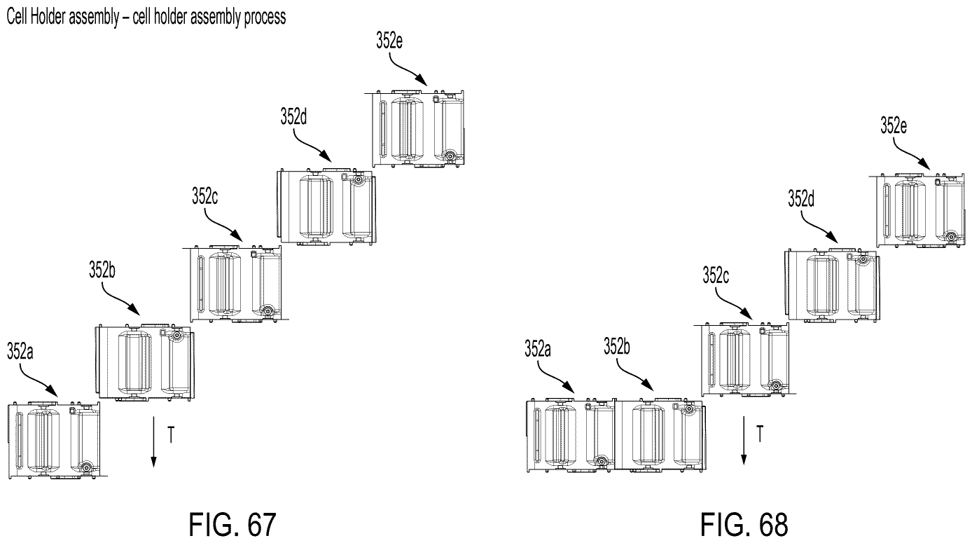

FIGS. 63-65 illustrate an example assembly process of two cell holder assemblies 352. As illustrated in the example assembly process, as the third cell holder assembly 352c and the fourth cell holder assembly 352d move towards each other, the first positive dovetails 374 of the fourth cell holder assembly 352d are received in the second negative dovetails 368 of the third cell holder assembly 352c. As illustrated in FIG. 65A, when the third cell holder assembly 352c and the fourth cell holder assembly 352d are moved into the final assembly position, the overlapping region 398 of the sixth battery strap 358f overlaps the overlapped region 402 of the ninth battery strap 358i and the strap-strap screw holes 400 of the sixth battery strap 358f are aligned with the strap-strap screw holes 400 of the ninth battery strap 358i.

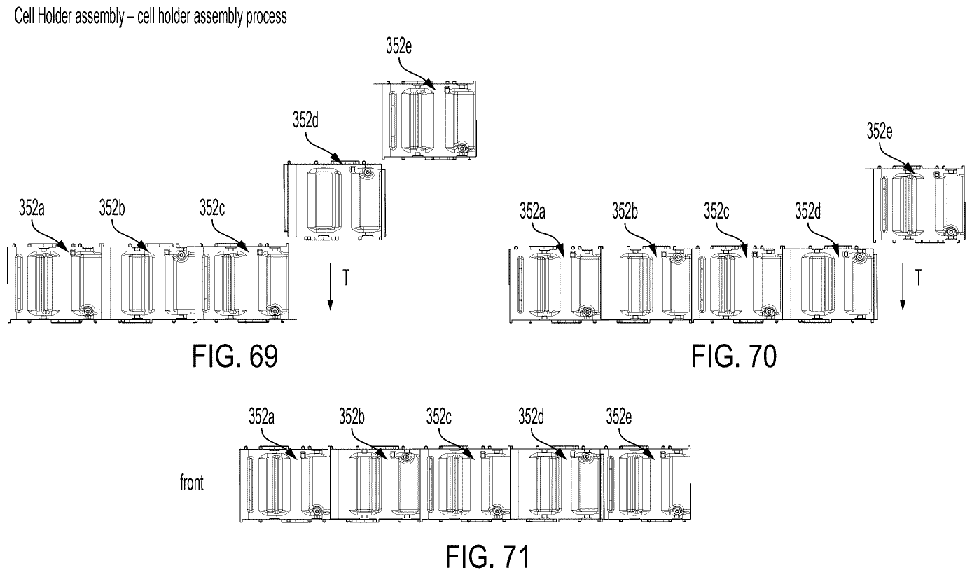

FIGS. 66A, 66B, and 66C illustrate the assembly of a cell holder and a pair of already assembly cell holders.

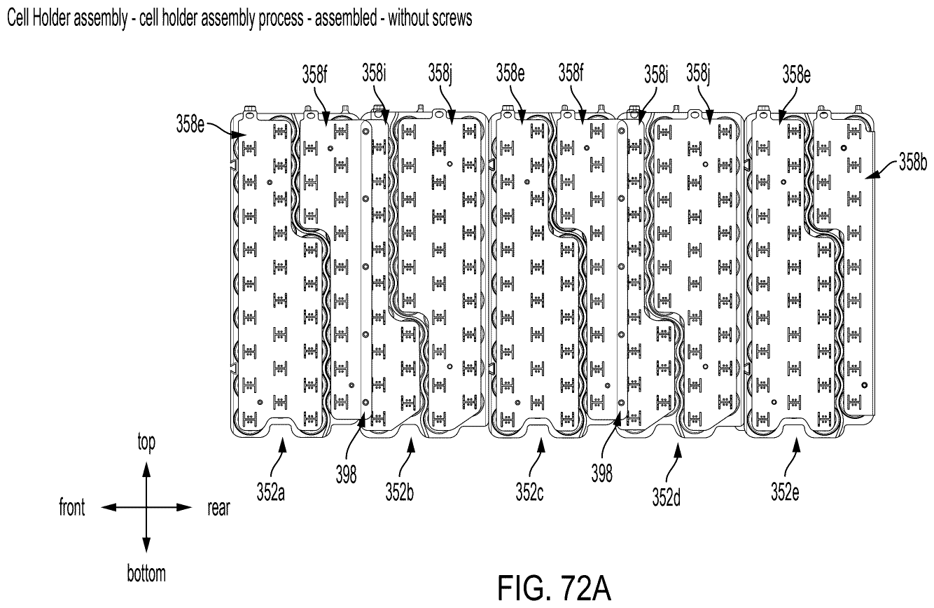

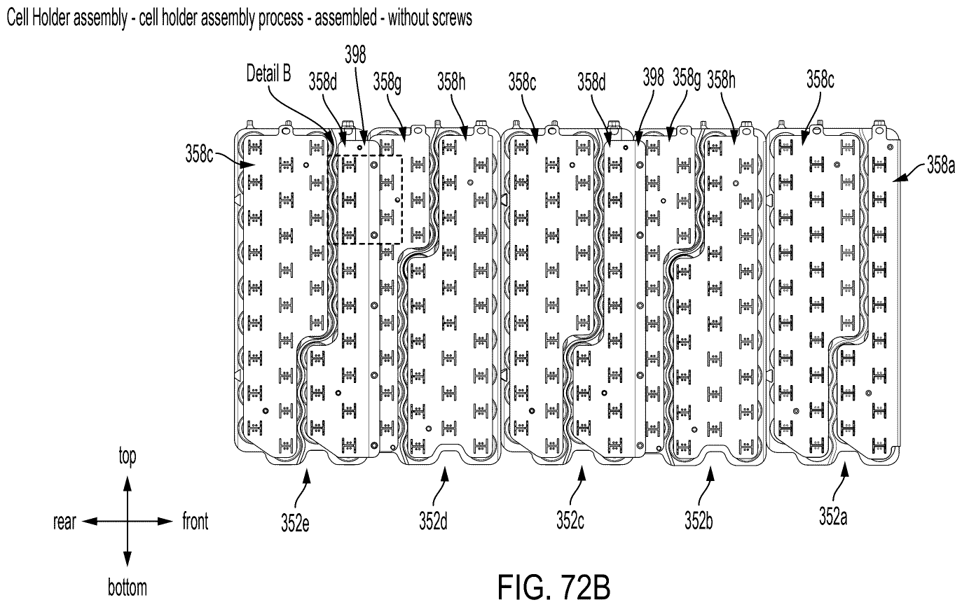

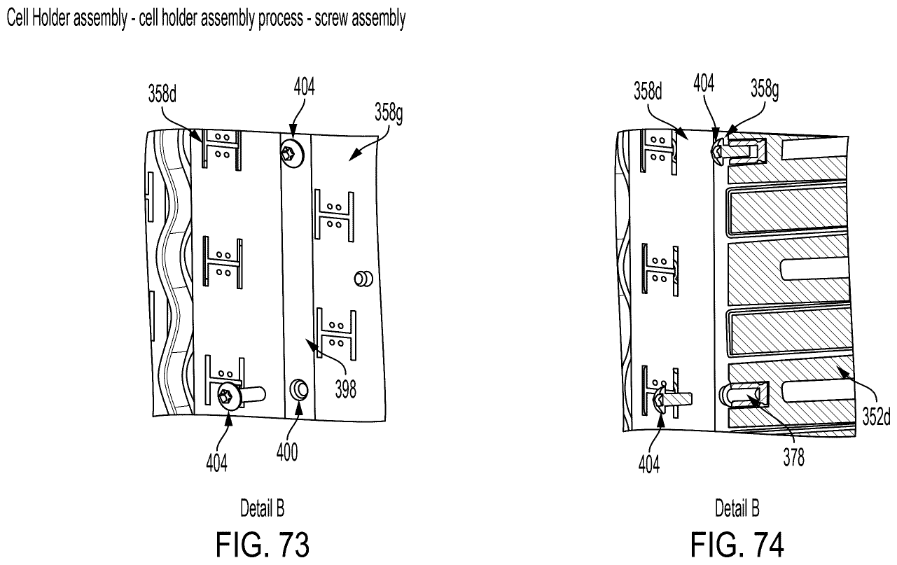

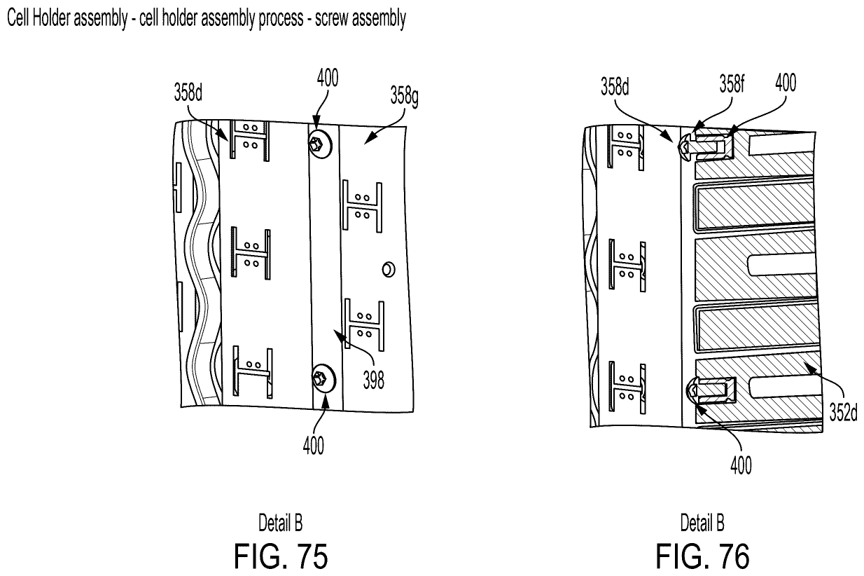

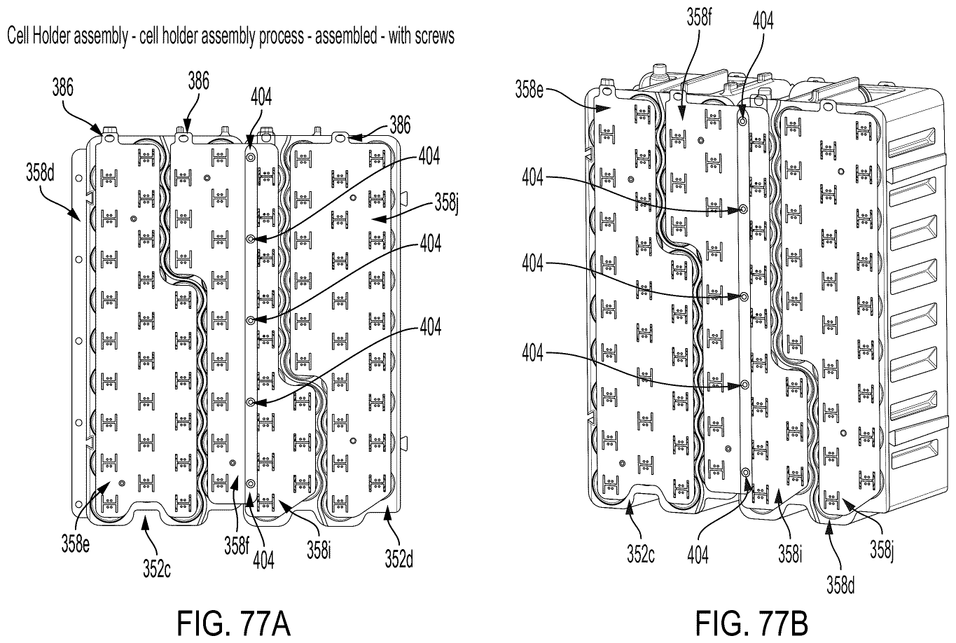

FIGS. 67-71 illustrate an example assembly process of five cell holder assemblies of the example battery pack. As illustrated in FIG. 67, the five cell holder assemblies 352a-e are aligned for assembly but separated from each other. In a first step, the second cell holder assembly 352b is moved—in the direction of arrow T—to engagement with the first cell holder assembly 352a. The positive dovetails of the second cell holder assembly 352b are received in the negative dovetails of the first cell holder assembly 352a. In a second step, the third cell holder assembly 352c is moved—in the direction of arrow T—to engagement with the second cell holder assembly 352b. The positive dovetails of the second cell holder assembly 352b are received in the negative dovetails of the third cell holder assembly 352c. In a third step, the fourth cell holder assembly 352d is moved—in the direction of arrow T—to engagement with the third cell holder assembly 352c. The positive dovetails of the fourth cell holder assembly 352d are received in the negative dovetails of the third cell holder assembly 352c. In a fourth step, the fifth cell holder assembly 352e is moved—in the direction of arrow T—to engagement with the fourth cell holder assembly 352d. The positive dovetails of the fourth cell holder assembly 352d are received in the negative dovetails of the fifth cell holder assembly 352e.

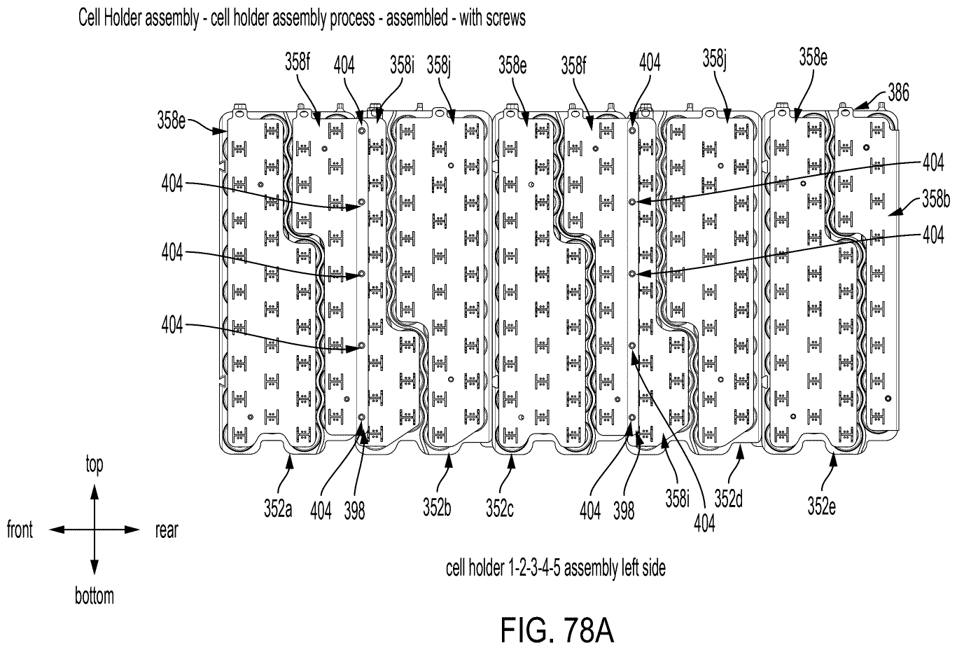

FIGS. 72A and 72B illustrate various views of the assembled five cell holder assemblies 352 of the example battery pack 110. As illustrated in FIG. 72A, when the first cell holder assembly 352a and the second cell holder assembly 352b are moved into the final assembly position, the overlapping region 398 of the sixth battery strap 358f of the first cell holder assembly 352a overlaps the overlapped region 402 of the ninth battery strap 358i of the second cell holder assembly 352b and the strap-strap screw holes 400 of the sixth battery strap 358f of the first cell holder assembly 352a are aligned with the strap-strap screw holes 400 of the ninth battery strap 358i of the second cell holder assembly 352b and when the third cell holder assembly 352c and the fourth cell holder assembly 352d are moved into the final assembly position, the overlapping region 398 of the sixth battery strap 358f of the third cell holder assembly 352c overlaps the overlapped region 402 of the ninth battery strap 358i of the fourth cell holder assembly 352d and the strap-strap screw holes 400 of the sixth battery strap 358f of the third cell holder assembly 352c are aligned with the strap-strap screw holes 400 of the ninth battery strap 358i of the fourth cell holder assembly 352d.

As illustrated in FIG. 72B, when the second cell holder assembly 352b and the third cell holder assembly 352c are moved into the final assembly position, the overlapping region 398 of the fourth battery strap 358d of the third cell holder assembly 352c overlaps the overlapped region 402 of the seventh battery strap 358g of the second cell holder assembly 352b and the strap-strap screw holes 400 of the fourth battery strap 358d of the third cell holder assembly 352c are aligned with the strap-strap screw holes 400 of the seventh battery strap 358g of the second cell holder assembly 352b. When the fourth cell holder assembly 352d and the fifth cell holder assembly 352e are moved into the final assembly position, the overlapping region 398 of the fourth battery strap 358d of the fifth cell holder assembly 352e overlaps the overlapped region 402 of the seventh battery strap 358g of the fourth cell holder assembly 352d and the strap-strap screw holes 400 of the fourth battery strap 358d of the fifth cell holder assembly 352e are aligned with the strap-strap screw holes 400 of the seventh battery strap 358g of the fourth cell holder assembly 352d.

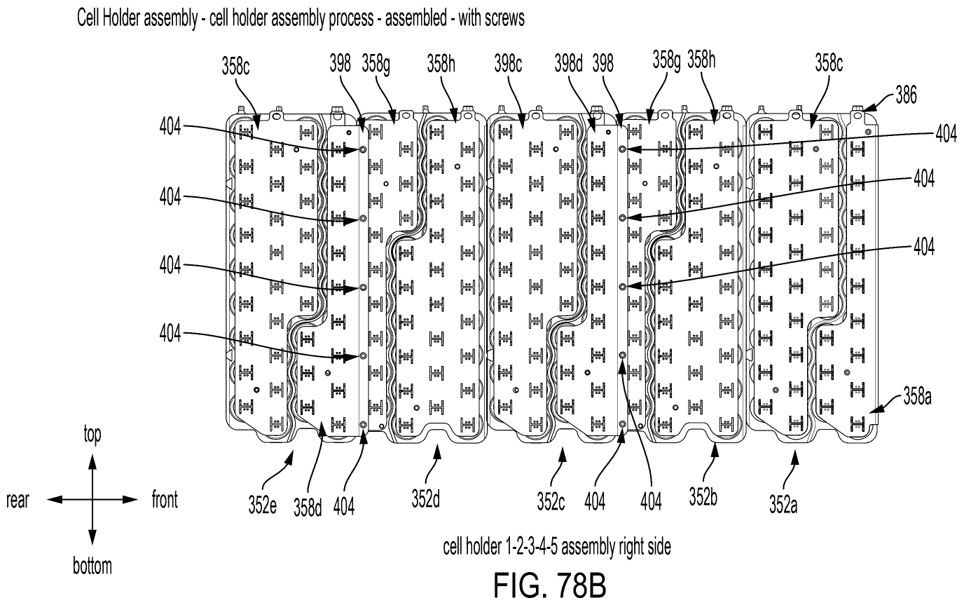

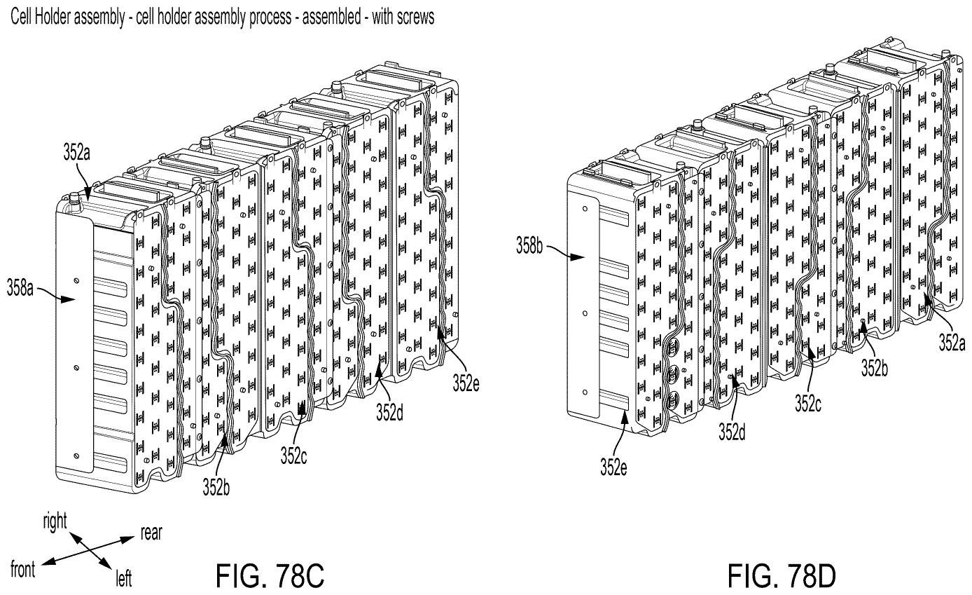

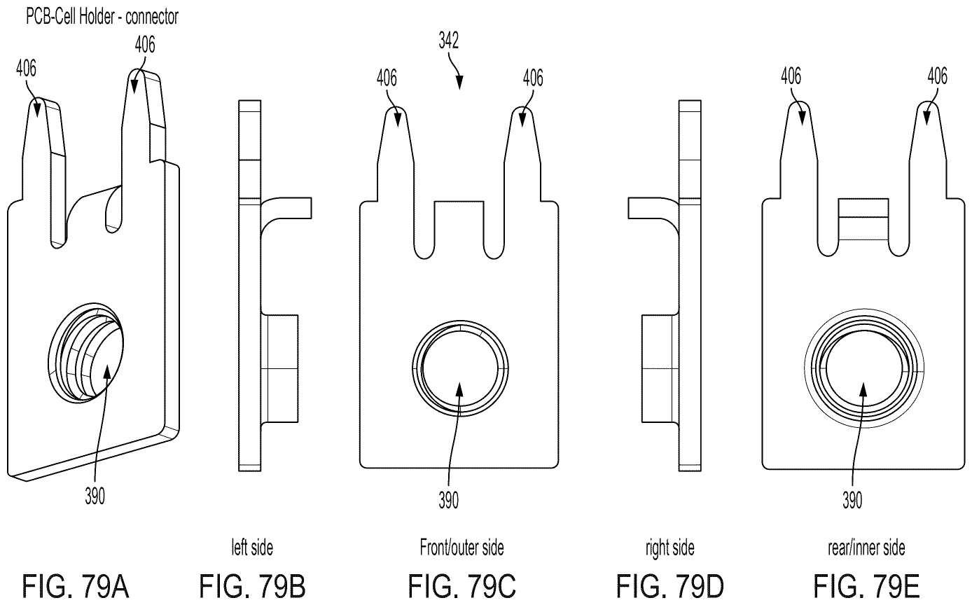

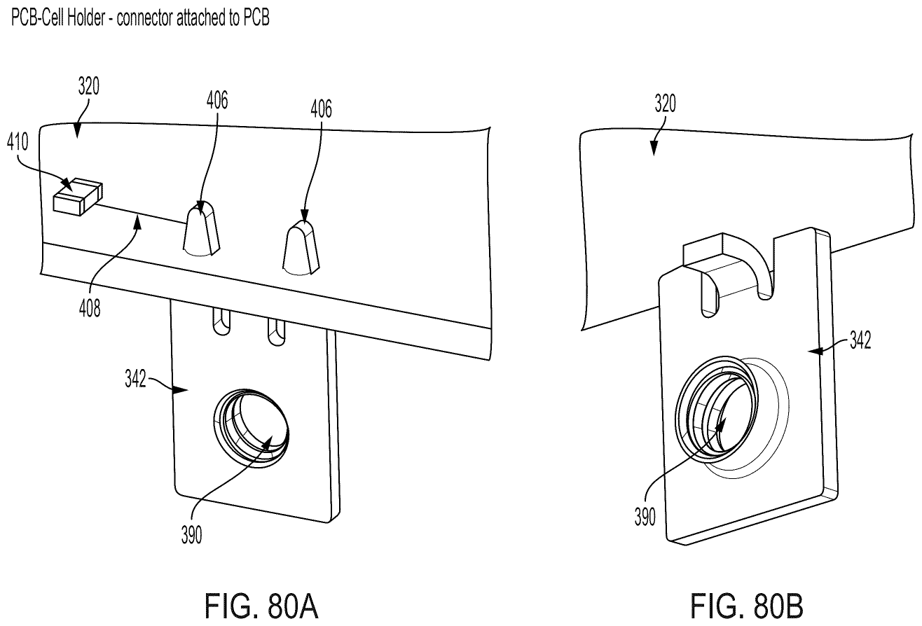

FIGS. 73-76 illustrate an example process for inserting a strap-to-scrap screw 404 for coupling adjacent battery straps 358. As illustrated in more detail, for example, when the fourth cell holder assembly 352d and the fifth cell holder assembly 352e are in the final assembly position, the overlapping region 398 of the fourth battery strap 358d overlaps the overlapped region 402 of the seventh battery strap 358g and the strap-strap screw holes 400 of fourth battery strap 358d align with the strap-strap screw holes 400 of the seventh battery strap 358g and the cell holder screw holes 378 of the fourth cell holder assembly 352d. When the strap-strap screw holes 400 of the fourth battery strap 358d, the strap-strap screw holes 400 of the seventh battery strap 358g, and the cell holder screw holes 378 are aligned, a strap-strap screw 404 is inserted into the aligned screw holes.

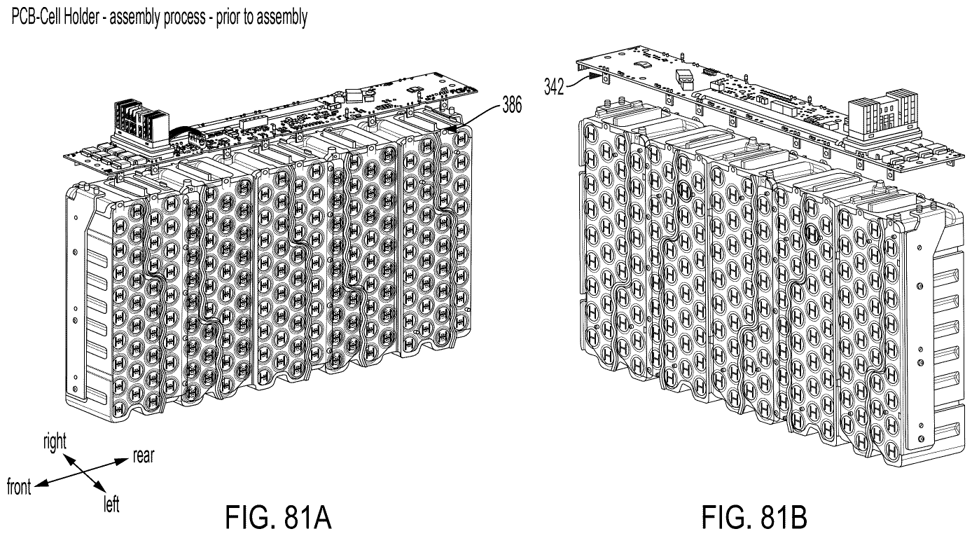

FIGS. 77A and 77B illustrate various views of a pair of cell holders assembled together with a plurality of strap-to-strap screws applied to the assembly.

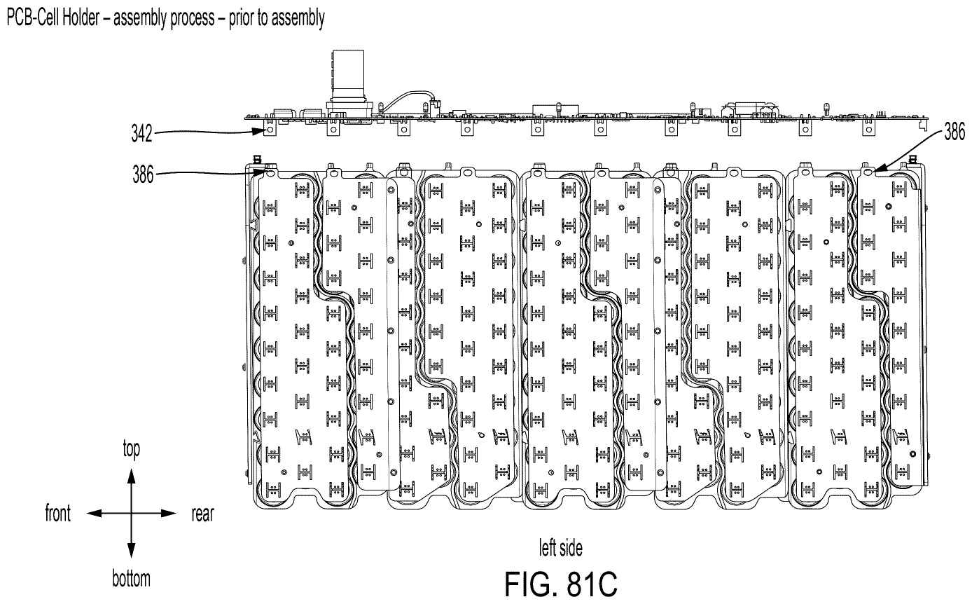

FIGS. 78A, 78B, 78C, and 78D illustrate various views of the assembled five cell holders of the example battery pack with a plurality of strap-to-strap screws applied to the assembly.

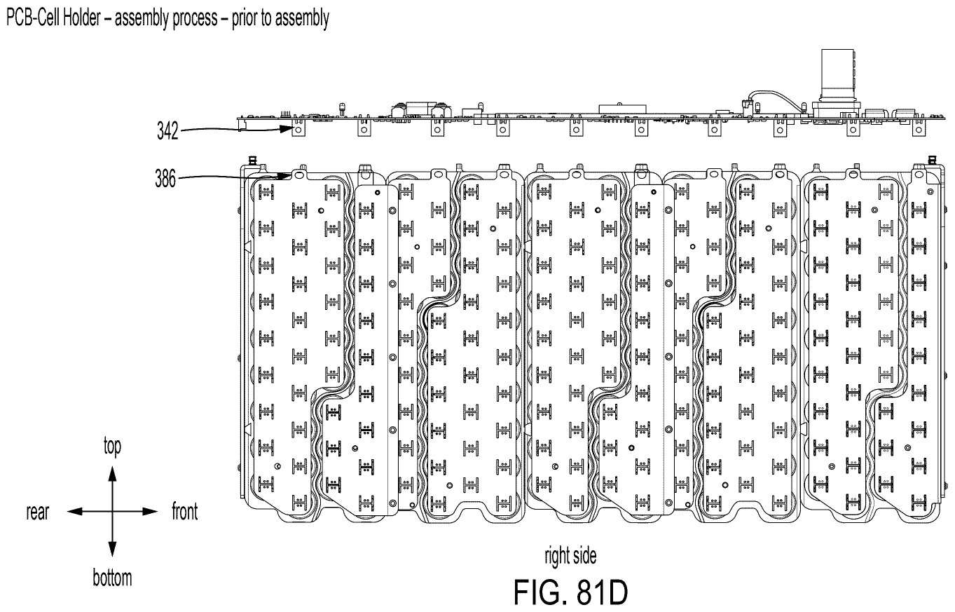

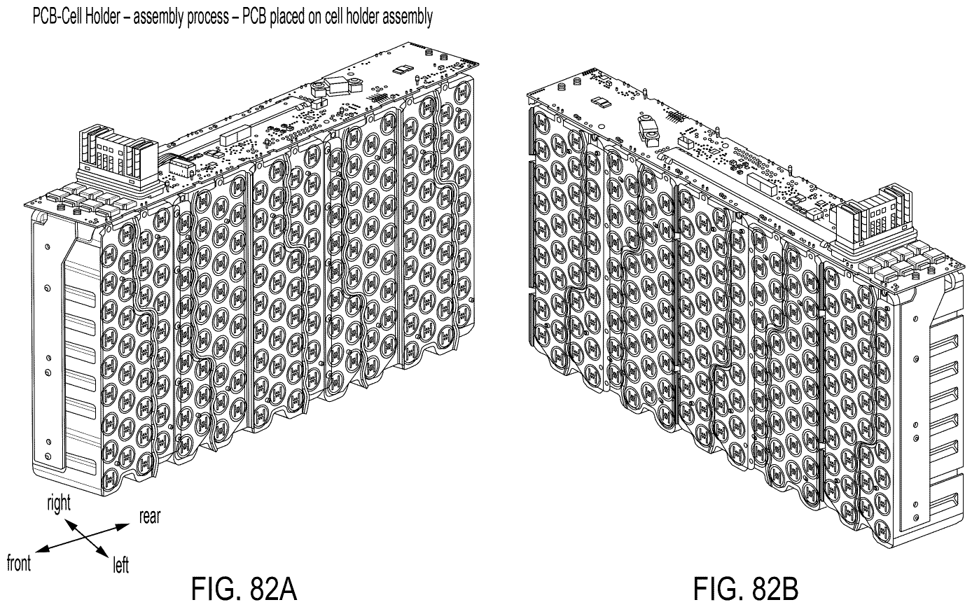

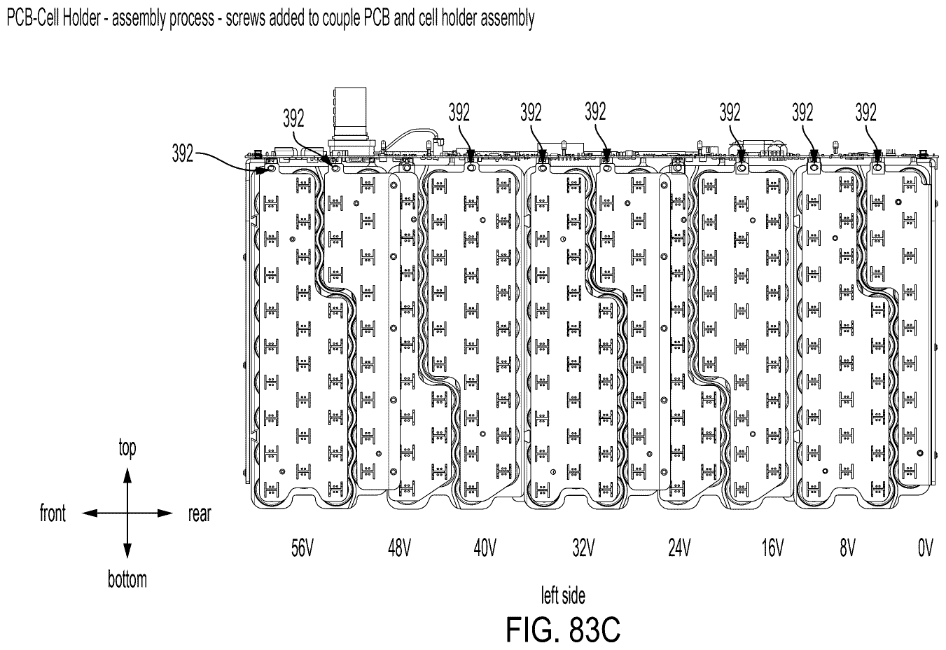

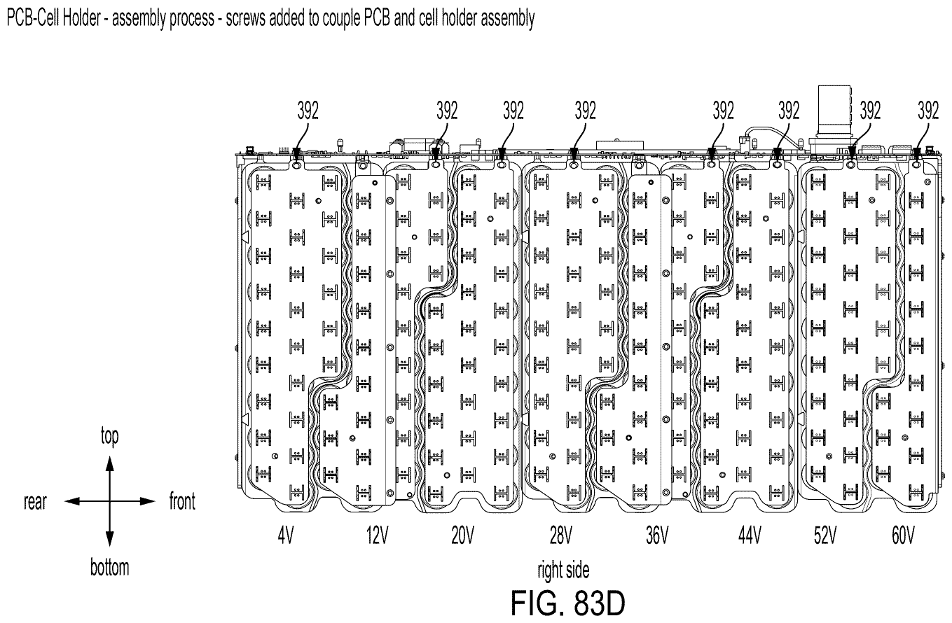

FIGS. 79A-79E illustrate various views of an example connector 342 for coupling the PCB 320 and the various cell holder assemblies 352. The example PCB-cell holder connector 342 may include a pair of connector tines 406. The tines 406 are received/positioned in holes in the main PCB 320, as illustrated in FIGS. 80A and 80B. The example PCB-cell holder connector 342 may include a screw hole 390 for receiving a fastening screw 392 mechanically and electrically connecting the PCB-cell holder connector 342 to the battery straps 358, as illustrated in FIGS. 83A, 83B, 83C, 83D, 84, and 85.

FIGS. 80A and 80B illustrate various views of the example PCB-cell holder connector 342 attached to the PCB 320. The main PCB 320 may include traces 408 that electrically connect the PCB-cell holder connector 342 to various electrical/electronic components 410, such as the microprocessor, to provide electrical signals from the corresponding battery strap to the microprocessor. As such, the microprocessor is able to monitor the battery cells of the cell holder. These signals may include, for example, the voltage of the battery cells connected to a specific battery strap.

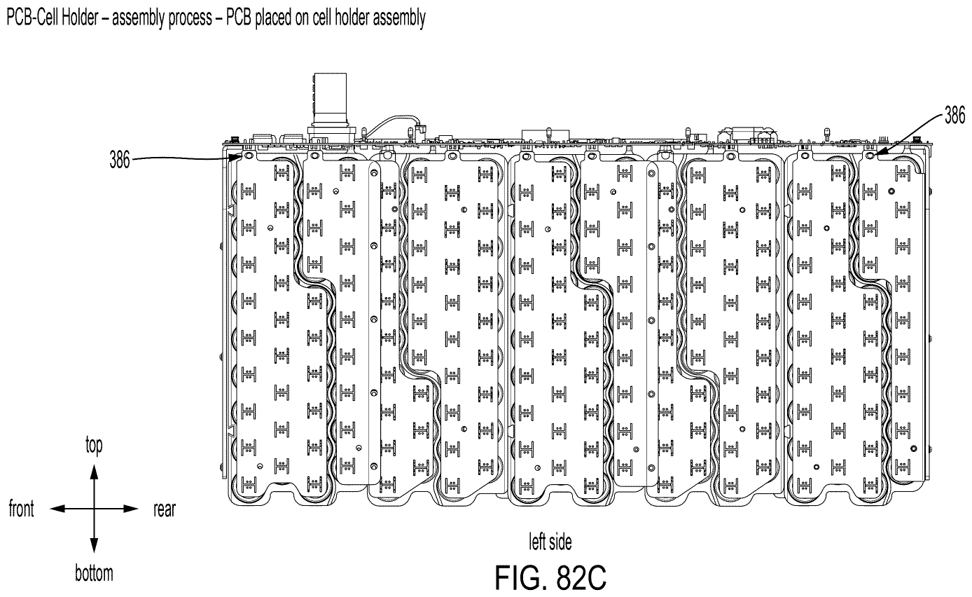

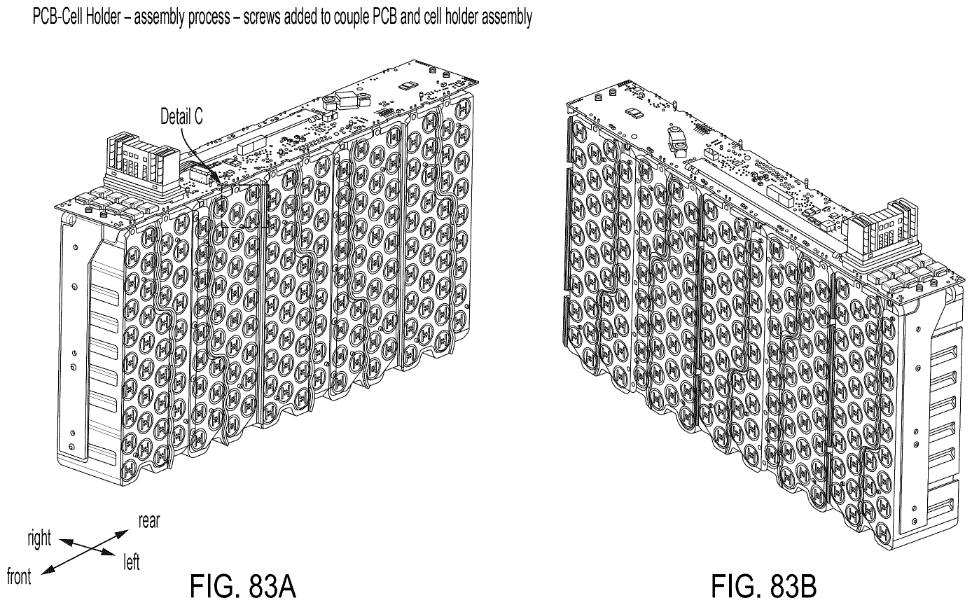

FIGS. 81-85 illustrate various views of an example assembly process of attaching the PCB 320 to the assembled cell holder assemblies 352a-e. As illustrated in FIGS. 82A, 82C, and 82C, when the main PCB 320 and the cell holder assemblies 352a-e are moved into the final assembly position, the strap extensions 386 of the first battery strap 358a, the third battery strap 358c, the fifth battery strap 358e, and the sixth battery strap 358f of the first cell holder assembly 352a; the strap extensions 386 of the seventh battery strap 358g, the eighth battery strap 358h, and the ninth battery strap 358i of the second cell holder assembly 352c; the strap extensions 386 of the third battery strap 358c, the fifth battery strap 358e, and the third battery strap 358c of the third cell holder assembly 352c; the battery strap extensions 386 of the seventh battery strap 358g, the eighth battery strap 358h and the tenth battery strap 358j of the fourth cell holder assembly 352d; and the battery strap extensions 386 of the third battery strap 358c, the fifth battery strap 358e and the second battery strap 358b of the fifth cell holder assembly 352e abut and are aligned with corresponding PCB-cell holder connectors 342 attached to the main PCB 320. And the PCB-strap screw holes 388 of the strap extensions 386 are aligned with the screw holes 390 of the corresponding PCB-cell holder connectors 342.

As illustrated in FIGS. 83A, 83B, 83C, 83D, 84 and 85, once the screw holes of the PCB-cell holder connectors and the screw holes of the battery strap extensions are aligned, PCB-cell holder fastening screws are inserted into the aligned screw holes to couple the battery straps mechanically and electrically to the main PCB.

FIG. 86 illustrates an example simple circuit diagram of the battery cells 356 and the battery straps 358 attached to the PCB 320 of the example battery pack.

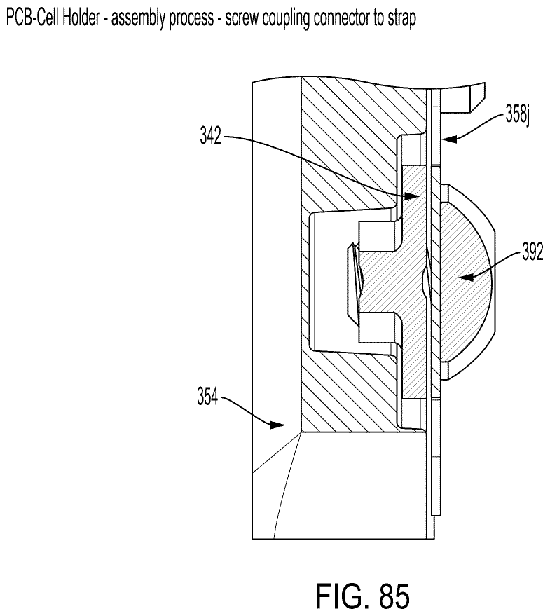

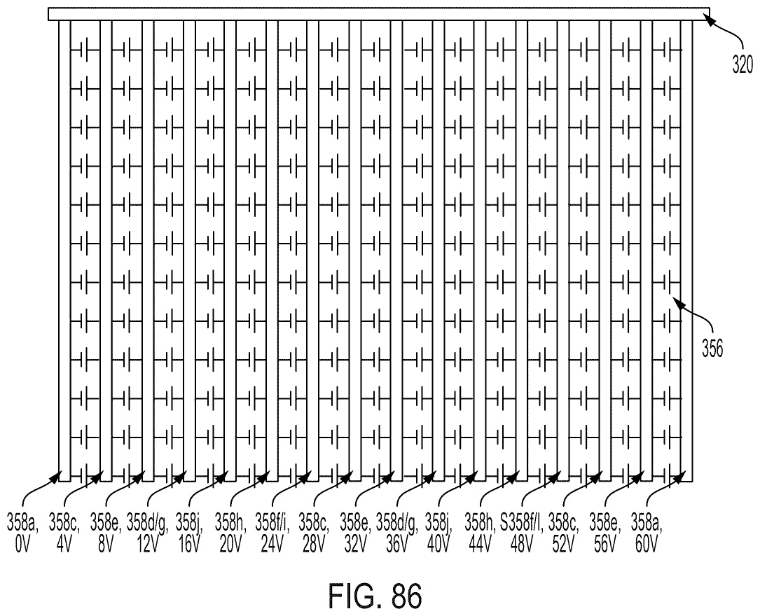

FIGS. 87 and 88 illustrate an example embodiment of a battery pack. The battery pack 110′ may include a set of pouch bags 420 containing a phase change material. The pouch bags 420 may be placed on one or both sides of the core pack 350 between the core pack 350 and the pack housing. The pouch bags 420 may be attached to the battery straps 358.

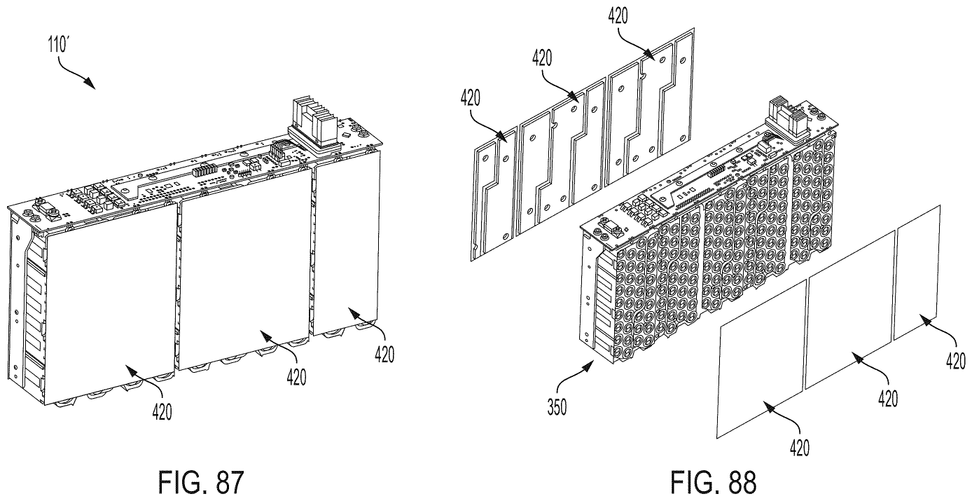

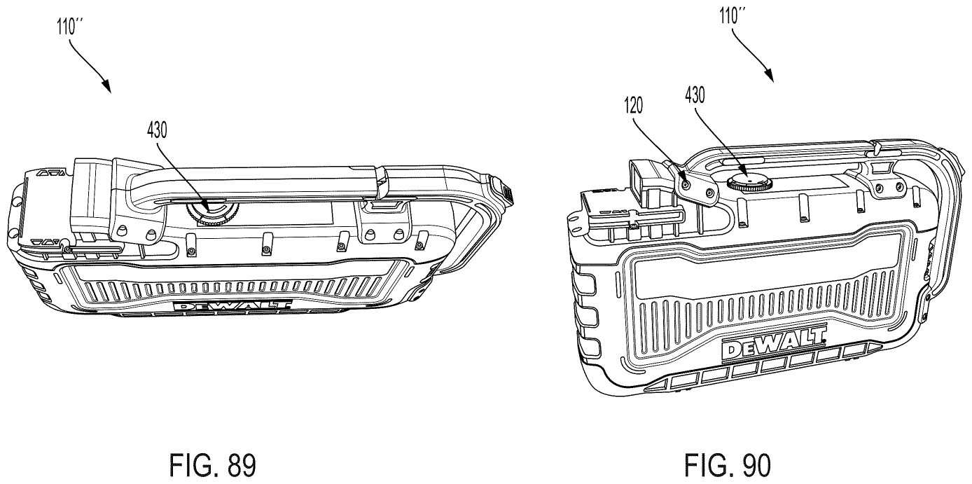

FIGS. 89 and 90 illustrate an example embodiment of a battery pack. The battery pack 110″ may include a pressure relief vent or valve 430. The pressure relief vent may be attached to the upper housing 120 of the battery pack 110″.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Terms of degree such as “generally,” “substantially,” “approximately,” and “about” may be used herein when describing the relative positions, sizes, dimensions, or values of various elements, components, regions, layers and/or sections. These terms mean that such relative positions, sizes, dimensions, or values are within the defined range or comparison (e.g., equal or close to equal) with sufficient precision as would be understood by one of ordinary skill the various elements, components, regions, layers and/or sections being described.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

Numerous modifications may be made to the example implementations described above. These and other implementations are within the scope of this application.

What is claimed is:

1. A battery pack, comprising:
a plurality of modular cell holder assemblies, each cell holder assembly comprising (a) at least one cell holder, (b) a plurality of battery cells held physically fixed relative to each other by the cell holder, (c) a plurality of battery straps, each of the plurality of battery straps electrically connecting a subset of the plurality of battery cells, a battery strap extension extending from at least one of the plurality of battery straps;
a printed circuit board (PCB) having a width; and
a plurality of PCB-cell holder connectors fixedly connected to the PCB;
each of the battery strap extensions connected to a corresponding one of the plurality of PCB-cell holder connectors.

2. The battery pack, as recited in claim 1, wherein the battery strap extension is at one end of the battery strap.

3. The battery pack, as recited in claim 1, wherein the battery strap extension comprises a PCB-strap screw hole.

4. The battery pack, as recited in claim 3, wherein the battery strap extension configured to align with the PCB-cell holder connector, such that the PCB-strap screw hole aligns with a PCB-cell holder connector screw hole, a fastening screw received through both the PCB-strap screw hole and the PCB-cell holder connector screw hole mechanically and electrically coupling the battery strap to the PCB.

5. The battery pack, as recited in claim 1, wherein the PCB and the cell holder assemblies in a final assembly position, each of the battery strap extensions abut and are aligned with corresponding PCB-cell holder connectors attached to the main PCB.

6. The battery pack, as recited in claim 4, wherein the PCB-strap screw holes of the battery strap extensions are aligned with the screw holes of the corresponding PCB-cell holder connectors.

7. The battery pack, as recited in claim 6, wherein, upon alignment of the screw holes of the PCB-cell holder connectors and the screw holes of the battery strap extensions, PCB-cell holder fastening screws inserted into the aligned screw holes mechanically and electrically couple the battery straps to the main PCB.

8. The battery pack, as recited in claim 1, wherein each of the plurality of PCB-cell holder connectors has a screw hole and each battery strap extension has a screw hole and the screw hole of each battery strap extension and the screw hole of the corresponding one of the plurality of PCB-cell holder connectors are aligned and are fastened together by a screw.

9. The battery pack, as recited in claim 1, wherein the at least one cell holder comprises a first type of cell holder and a second type of cell holder, both the first type of cell holder and the second type of cell holder comprising a plurality of battery cell cavities, the plurality of battery cells housed in the plurality of battery cell cavities, a cell holder width, the cell holder width approximately equal to the PCB width.

10. The battery pack, as recited in claim 1, wherein the plurality of battery straps includes a first type of battery strap comprising an overlapping region and a second type of battery strap comprising an overlapped region, the overlapping region overlaps the overlapped region forming an overlap region.

11. The battery pack, as recited in claim 10, wherein the first type of battery strap is electrically connected to the second type of battery strap at the overlap region.

12. The battery pack, as recited in claim 11, wherein the second type of cell holder includes a plurality of screw holes, the plurality of screw holes of the second type of cell holder align with and correspond to the strap-strap screw holes of the first type of battery strap and the strap-strap screw holes of the second type of battery strap.

13. The battery pack, as recited in claim 12, wherein the aligned screw holes of the first type of battery strap, the second type of battery strap and the second type of cell holder receive screws, mechanically fixing the first type of battery strap and the second type of battery strap to the second type of cell holder.

14. The battery pack, as recited in claim 11, wherein the electrically connected first type of battery strap and the second type of battery strap connect battery cells in the first type of cell holder to battery cells in an adjacent, second type of cell holder.

15. The battery pack, as recited in claim 1, wherein the at least one cell holder comprises a width dimension W3, a length dimension L3 and a height dimension H3.

16. The battery pack, as recited in claim 15, wherein a volume V2 is about 77.95 in³ to about 107.74 in³.

17. The battery pack, as recited in claim 16, wherein the volume V2 is approximately 93.45 in³.

18. The battery pack, as recited in claim 9, wherein the first type of cell holder further comprises a top side defined by a width dimension W3 and a length dimension L3, a bottom side, opposed and generally parallel to the top side, defined by the width dimension W3 and the length dimension L3, a front side defined by the width dimension W3 and a height dimension H3 and a rear side, opposed and generally parallel to the front side, defined by the width dimension W3 and the height dimension H3, a first side defined by the length dimension L3 and the height dimension H3 and a second side, opposed and generally parallel to the first side, defined by length dimension L3 and the height dimension H3.

19. The battery pack, as recited in claim 18, wherein the first type of cell holder further comprises a first pair of negative dovetails formed as part of the front side, the first pair of negative dovetails extending from the first side to the second side of the first type cell holder and a second pair of negative dovetails formed as part of the rear side, the second pair of negative dovetails extending from the first side to the second side of the first type cell holder.

20. The battery pack, as recited in claim 19, wherein the first pair of negative dovetails are separated by a dimension X1 along the height dimension H3 of the first type cell holder and wherein the second pair of negative dovetails are separated by a dimension X2 along the height dimension H3 of the first type cell holder.

21. The battery pack, as recited in claim 30, wherein the dimension X1 is greater than the dimension X2.

22. The battery pack, as recited in claim 9, wherein the second type of cell holder further comprises a top side defined by a width dimension W4 and a length dimension L4, a bottom side, opposed and generally parallel to the top side, defined by the width dimension W4 and the length dimension L4, a front side defined by the width dimension W4 and a height dimension H4, a rear side, opposed and generally parallel to the front side, defined by the width dimension W4 and the height dimension H4, a first side defined by the length dimension L4 and the height dimension H4 and a second side, opposed and generally parallel to the first side, defined by length dimension L4 and the height dimension H4.

23. The battery pack, as recited in claim 22, wherein the second type of cell holder further comprises a first pair of positive dovetails formed as part of the front side, the first pair of positive dovetails extending from the first side to the second side of the second type cell holder yet not extending all the way to the first side and the second side, and a second pair of positive dovetails formed on the rear side, the second pair of positive dovetails extending from the second side to the first side of the second type cell holder yet not extending all the way to the first side and the second side.

24. The battery pack, as recited in claim 23, wherein the first pair of positive dovetails formed as part of the front side of the second type cell holder are separated by a dimension Y2 along the height dimension H4 of the second type cell holder and the second pair of positive dovetails formed as part of the rear side of the second type cell holder are separated by a dimension Y1 along the height dimension H4 of the second type cell holder.

25. The battery pack, as recited in claim 24, wherein the dimension Y1 is greater than the dimension Y2.

26. The battery pack, as recited in claim 1, wherein the at least one cell holder comprises (1) a top side defined by a width dimension and a length dimension, (2) a bottom side, opposed and generally parallel to the top side, defined by the width dimension and the length dimension L3, (3) a front side defined by the width dimension and a height dimension and (4) a rear side, opposed and generally parallel to the front side, defined by the width dimension and the height dimension, (5) a first side defined by the length dimension and the height dimension and (6) a second side, opposed and generally parallel to the first side, defined by length dimension and the height dimension; and a rib extending along the first side in the height dimension and from the first side in the width dimension of the at least one cell holder between a first battery strap and an adjacent, second battery strap.

27. The battery pack, as recited in claim 26, wherein the first battery strap has a first electric potential and the second battery strap has a second electric potential, the first electric potential being greater than the second electric potential.

28. The battery pack, as recited in claim 1, wherein the plurality of battery straps comprises (1) a first subset of battery straps, each battery strap of the first subset of battery straps including an overlapping region at a forward area of the battery strap, the overlapping region including a plurality of strap-strap screw holes and (2) a second subset of battery straps, each battery strap of the second subset of battery straps including an overlapped region at a rearward area of the battery strap, the overlapped region including a plurality of strap-strap screw holes, the overlapping region of a battery strap of the first subset of battery straps overlapping the overlapped region of an adjacent battery strap of the second subset battery straps, the strap-strap screw holes of the first subset battery strap aligned with the strap-strap screw holes of the second subset battery strap; and further comprising a strap-strap fastening screw received through each of the aligned strap-strap screw holes of the first subset battery strap and strap-strap screw holes of the adjacent, second subset battery strap mechanically and electrically coupling the first subset battery strap to the adjacent, second subset battery strap.

29. The battery pack, as recited in claim 28, wherein the at least one cell holder comprises a plurality of screw holes, the at least one cell holder screw holes aligned with the strap-strap screw holes of the first subset battery strap and the strap-strap screw holes of the second subset battery strap, the strap-strap fastening screws received in corresponding screw holes of the at least one cell holder affixing the first subset battery strap and the second subset battery strap to the at least one cell holder.

30. A battery pack, comprising:
a housing;
an interface for mating with a tool to be powered by the battery pack, the interface configured such that the pack moves in along a mating direction upon mating with the tool to be powered;
a corepack, the corepack including (1) a set of cell holder assemblies, each of the cell holder assemblies having a width dimension W3, the width dimension W3 generally perpendicular to the mating direction, and (2) a main PCB having (a) a width dimension W2, the width dimension W2 generally perpendicular to the mating direction and generally parallel to the width dimension W3, W2 approximately equal to W3, and (b) a length dimension L2, the length dimension L2 equal to a length dimension L3 of a first type of cell holder of the set of cell holders multiplied by the number of the first type of cell holders (A) plus a length dimension L4 of a second type of cell holder of the set of cell holders multiplied by the number of the second type of cell holders (B) in the corepack.
